SEQUENCE LISTING (2 sequences)

SEQ ID NO: 1 - protein, 341 aa, Artificial Sequence
  Description of Artificial Sequence Synthetic polypeptide
GLVGWRGMVGSVLMQRMVEERDFDLIEPVFFSTSQIGVPAPNFGKDAGMLHDAFDIESLKQLDAVITCQGGSYTEKVYPALRQAGWKGYWIDAASTLRMDKEAIITLDPVNLKQILHGIHHGTKTFVGGNCTVSLMLMALGGLYERGLVEWMSAMTYQAASGAGAQNMRELISQMGVINDAVSSELANPASSILDIDKKVAETMRSGSFPTDNFGVPLAGSLIPWIDVKRDNGQSKEEWKAGVEANKILGLQDSPVPIDGTCVRIGAMRCHSQALTIKLKQNIPLDEIEEMIATHNDWVKVIPNERDITARELTPAKVTGTLSVPVGRLRKMAMGDDFLNA

SEQ ID NO: 2 - protein, 343 aa, Artificial Sequence
  Description of Artificial Sequence Synthetic polypeptide
GFIGWRGMVGSVLMDRMSQENDFENLNPVFFTTSQAGQKAPVFGGKDAGDLKSAFDIEELKKLDIIVTCQGGDYTNEVYPKLKATGWDGYWVDAASALRMKDDAIIVLDPVNQHVISEGLKKGIKTFVGGNCTVSLMLMAIGGLFEKDLVEWISVATYQAASGAGAKNMRELLSQMGLLEQAVSSELKDPASSILDIERKVTAKMRADNFPTDNFGAALGGSLIPWIDKLLPETGQTKEEWKGYAETNKILGLSDNPIPVDGLCVRIGALRCNSQAFTIKLKKDLPLEEIEQIIASHNEWVKVIPNDKEITLRELTPAKVTGTLSVPVGRLRKLAMGPEYLAA

(19) United States
(12) Patent Application Publication
(10) Pub. No.: US 2010/0057420 A1
(43) Pub. Date: Mar. 4, 2010

(54) APPARATUS FOR PROCESSING 3-DIMENSIONAL STRUCTURE OF PROTEIN, METHOD OF PROCESSING 3-DIMENSIONAL STRUCTURE OF PROTEIN, AND PROGRAM

(75) Inventors: Hideaki Umeyama, Chiba (JP); Mayuko Shitaka, Tokyo (JP); Genki Terashi, Tokyo (JP); Kazuhiko Kanou, Tokyo (JP); Katsuichiro Komatsu, Tokyo (JP); Mitsuo Iwadat, Tokyo (JP)

Correspondence Address: FOLEY AND LARDNER LLP;SUITE 500, 3000 K STREET NW, WASHINGTON, DC, 20007, US

(73) Assignee: In-Silico Sciences, Inc.

(21) Appl. No.: 12/312,634

(22) PCT Filed: Nov. 21, 2007
(86) PCT No.: PCT/JP2007/073005

§ 371 Date: May 20, 2009

(30) Foreign Application Priority Data
Nov. 22, 2006 (JP) 2006-316356

(51) Int. Cl. G06G 7/48

(52) U.S. Cl. 703/11

(57) ABSTRACT

An apparatus for processing 3-dimensional structure of protein includes a control unit and a storage unit, wherein the storage unit stores 3-dimensional structure information of protein, and the control unit predicts 3-dimensional structure information of protein after the mutation when an arbitrary amino acid residue A in the 3-dimensional structure information of protein stored in the storage unit is mutated into another amino acid residue a, thereof from the 3-dimensional structure information of protein before and after the mutation, collects the amino acid residue A, the amino acid residue a, environment information P, and environment information p, which are related to each other, as information on environmental change, when the environment information P around the amino acid residue A before the mutation changes to the environment information p around the amino acid residue a after the mutation, thereby storing information on the environmental change in the storage unit.

### TECHNICAL FIELD

The present invention relates to an apparatus for processing 3-dimensional structure of protein, a method of processing 3-dimensional structure of protein and a program. The invention relates in particular to the apparatus for processing 3-dimensional structure of protein, the method of processing 3-dimensional structure of protein and the program, which are capable of calculating a score matrix that is physical quantity indicating whether amino acid residues in a 3-dimensional structure of protein are energetically stable in a specific environment.

### BACKGROUND ART

A large number of methods have already been known for evaluating predicted 3-dimensional structures of proteins. Among them, methods for evaluation based on a 3D1D method represented by Verify 3D (see Nonpatent Literatures 1 and 2) are known to enable highly accurate evaluation by a simple computation method.

For example, score function (3D1D SCOREij) of Verify 3D where amino acid residue i appears in environment j is defined by Eqs. (1) and (2) below:

$$\begin{matrix}[ Eq . 1 ] & \\ 3 D 1 D score ij = ln ( \frac{P ( i \vert j )}{Pi} ) & ( 1 ) \\ \begin{matrix}P ( i \vert j ) = \frac{N ( i \vert j )}{{\sum }_{a = 1}^{20} N ( a \vert j )} & Pi = \frac{N ( i )}{{\sum }_{a = 1}^{20} N ( a )}\end{matrix} & ( 2 )\end{matrix}$$

Eq. (1) is used widely as an evaluation function by the 3D1D method. Classification of environment j in Verify 3D is shown in FIG. 1 (excerpt from Nonpatent Literature 1). FIG. 1 is a view showing category classification of environments in Verify3D. In FIG. 1, the buried area is shown on the horizontal axis and the fraction of area occupied by polar atoms (fraction polar) on the vertical axis.

In FIG. 1, it is meant that the exposed environment is classified into E and the buried environment into B. Depending on the degree to which polar atoms are occupied around a side chain, the environments P and B are subdivided. P is classified into P2 and P1 in order of polarity in the environment. The environment B is also classified into B3, B2 and B1 in the same manner. This categorized classification of environments is performed every 3 type of secondary structures, and thus there are 18 environments j in total.

In Eq. (1), P(i|j) is the ratio at which amino acid residues i (i=20 amino acids) appear in the environment j (B1 to B3, P1 to P2, and E in FIG. 1). Pi means the ratio at which the amino acid residues i are present regardless of the environment.

In Eq. (2), N(i|j) means the number at which amino acid residue i is observed in the environment j. N(i) is the number at which amino acid residue i is observed.

FIG. 2 is a distribution map of Valine amino acid residue applied to FIG. 1. In FIG. 2, the buried area is shown on the horizontal axis, and the fraction of area occupied by polar atoms (fraction polar) on the vertical axis. The red, green and blue dots show regions of α-helix, β-sheet and the other, respectively.

Nonpatent Literatures 1: Bowie J U, Luthy R, Eisenberg D. A method to identify protein sequences that fold into a known three-dimensional structure. Science. July 12; 253(5016):164-70.

Nonpatent Literatures 2: Eisenberg D, Luthy R, Bowie J U. VERIFY3D: assessment of protein models with three-dimensional profiles. Methods Enzymol. 1997; 277:396-404.

### DISCLOSURE OF INVENTION

### Problem to be Solved by the Invention

However, as is evident from FIG. 1, the method in which the environment of the amino acid residues (i) is divided into only 18 types, that is, (6 types shown in FIG. 1)×(3 types of secondary structures (helix, sheet, coil)) as shown in the conventional art can be said to be very rough in category classification. Accordingly, the 3D1D score shown in Eq. (1) in the conventional art appears as a discontinuous score function. However, the number of 3-dimensional structures of proteins that have been analyzed by experiments up to the present is finite, so it is known that there is a problem that as the categories are further subdivided, the number of statistical data (N(i|j)) for obtaining the value of P(i|j) in Eq. (1) by statistical methods is decreased. This leads to a problem that evaluation of amino acid residue i in the environment j to become short of statistical data cannot be accurately evaluated.

Accordingly, the present inventors predicted, by a homology modeling method, 3-dimensional structures of proteins to be mutated 1 amino acid residue, of which 3-dimensional structures of proteins were analyzed experimentally, thereby presuming the distribution of N(i|j) to examine the correction of statistical data. The inventors further examined whether there is a correlation of the amino acid residues with the environment j. As the result, the score function in Eq. (1) can be improved, and the inventors found that extremely highly accurate structural evaluation is made possible by the use of this score function, and the present invention was thereby arrived at.

That is, one object of the present invention is to provide an apparatus for processing 3-dimensional structure of protein, a method of processing 3-dimensional structure of protein and a program wherein how distribution of the environment j of amino acid residue i, shown in Eq. (1), changes by substitution of another amino acid residue is examined by constructing 3-dimensional modeling structures mutating one residue of an experimental structure of protein and statistically examining them, thereby solving the problem of decrease in statistical data attributable to subdivision of the environment.

Another object of the present invention is to provide an apparatus for processing 3-dimensional structure of protein, a method of processing 3-dimensional structure of protein and a program, by which the accuracy of a 3-dimensional structure of protein predicted by the homology modeling method is evaluated.

Still another object of the present invention is to provide an apparatus for processing protein 3-dimensional structure, a method of processing 3-dimensional structure of protein and a program, wherein predicted 3-dimensional structure information of protein is used to evaluate the reliability of the structure highly accurately.

Still another object of the present invention is to provide an apparatus for processing 3-dimensional structure of protein, a method of processing 3-dimensional structure of protein and a program, which prepare a score matrix used in predicting the accuracy of 3-dimensional structures of protein predicted by the homology modeling method. This score matrix is used to determine 3-dimensional structures of protein in order of stability to provide a method of highly accurately predicting 3-dimensional structures of protein. Further this score matrix is used in a means of obtaining predicted stability of interaction between/among proteins as substitution of amino acid, thereby improving protein functions for utilization in industry. Further, this score matrix is also used to extend to a score matrix including ligand molecules, thereby improving functions in enzyme reaction or in binding of a protein to a ligand. Further, this score matrix is used to obtain alignment of primary structures of a plurality of proteins similar to one another in 3-dimensional structure, thereby enabling homology modeling and increasing the industrial usefulness of modeled proteins. Further, this score matrix is used to obtain an improved score matrix which is specially applicable to proteins caused to undergo structural change, thereby predicting the stability of folding in the proteins to provide an apparatus for processing 3-dimensional structure of protein, a method of processing 3-dimensional structure of protein and a program that are industrially utilizable.

### Means for Solving Problem

First, the inventors statistically examined, from information on experimentally analyzed 3-dimensional structures of protein, how dispersion of the environment occurs as mutation in amino acid residue without changing their surrounding environment. One amino acid residue of protein is thereby substituted and information of the two environments is used, thereby replacing only the category classification of environments with the category classification of environments after the substitution without modeling 3-dimensional structure of a new protein, to enable approximate calculation.

Eq. (5) below is a score function determined using information after substitution of amino acid residue.

$$\begin{matrix}[ Eq . 2 ] & \\ w ( \begin{matrix}polar , \\ buried , \\ p , b\end{matrix} ) = exp ( \frac{- {p}^{2}}{2 \times {σ}_{polar}^{2}} ) \times exp ( \frac{- {b}^{2}}{2 \times {σ}_{buried}^{2}} ) & ( 3 ) \\ P ( \begin{matrix}AA \vert ss , \\ polar , \\ buried\end{matrix} ) = \frac{{\sum }_{m , n}^{ } w ( \begin{matrix}polar , \\ buried , \\ m , n\end{matrix} ) N ( \begin{matrix}AA \vert ss , \\ polar + m , \\ buried + n\end{matrix} )}{{\sum }_{aa}^{ } {\sum }_{m , n}^{ } w ( \begin{matrix}polar , \\ buried , \\ m , n\end{matrix} ) N ( \begin{matrix}aa \vert ss , \\ polar + m , \\ buried + n\end{matrix} )} & ( 4 ) \\ SCORE ( \begin{matrix}AA \vert ss , \\ polar , \\ buried\end{matrix} ) = log ( \frac{P ( \begin{matrix}AA \vert ss , \\ polar , \\ buried\end{matrix} )}{P ( AA )} ) & ( 5 )\end{matrix}$$

w(polar, buried, p, b) in Eq. (3) means the weighting parameter in the environment that the fraction polar (polar) is shifted by p and that the fraction buried (buried) is shifted by b in the environment defined by 3 parameters consisting of fraction of polar atoms (polar) which exposed to surface of amino acid residue, fraction of buried area (buried) which buried under that, and secondary structure information (ss). σₚₒₗₐᵣ represents the standard deviation in the fraction polar obtained from information after substitution of amino acid residue. σ_{buried} represents a standard deviation in fraction buried obtained from information after substitution of amino acid residue.

P(AA|ss, polar, buried) in Eq. (4) means the ratio which amino acid residue AA present in the environment consisting of the secondary structure information (ss), the fraction of area occupied by polar atoms (polar), and the fraction of buried area (buried), in which the weighting parameter corresponding to the environment in which amino acid residue AA in Eq. (3) is present is considered. In the present invention, Eq. (4) determined by Eq. (3) is handled as term P(i|j) in Eq. (1). P(i|j) means the ratio of which amino acid residues i appear in the environment j. Eq. (1) is thereby expressed in Eq. (5) above.

Accordingly, the present invention is achieved by an apparatus for processing 3-dimensional structure of protein, a method of processing 3-dimensional structure of protein and the program, which evaluate the accuracy of 3-dimensional structures of protein by the apparatus for processing 3-dimensional structure of protein, the method of processing 3-dimensional structure of protein and the program which calculate and prepare a score matrix defined by Eq. (5) and by the score matrix thus prepared.

That is, in the present invention, 3-dimensional structures of protein, of which one amino acid residue is mutated into another amino acid residue in experimentally determined 3-dimensional structure information of protein (PDB data, and the like), are constructed by a homology modeling method. A large number of pieces of the information are produced, whereby the distribution of changes in the environment around the amino acid residue which is mutated into the other, is obtained. Assuming that the distribution of changes in the environment follows the Gaussian distribution, the variance and standard deviation of the distribution are calculated. Using the standard deviation thus obtained, the number of data belonging to the same environment, on amino acid residues present in a certain environment, is get in consideration of the Gaussian distribution. From the obtained data, a score matrix in consideration of the expectation is prepared. The prepared score matrix and 3-dimensional structure of protein are input to evaluate the accuracy of the 3-dimensional structure of protein.

Using this score matrix, by a means of obtaining the predictive value of stability of interaction between proteins based on substitution of amino acid residue, functions of protein are improved and utilized in industry.

When one amino acid residue is substituted for other 19 amino acid residues, a parameter that determines a score matrix corresponding to the environment of the amino acid residues in sequence of the original amino acid residue is stored while numerical values in score matrixes that correspond to the environments of other 19 amino acid residues are obtained, and the proteins after substitution of amino acid are compared with the protein before the substitution to predict their stability.

Further, this score matrix is used and extended to a score matrix also including ligand molecules, thereby improving functions in enzyme reaction or in binding of a protein to a ligand. In this case, the solution procedures are the same method that used in substitution of amino acid residue except that the scored matrix is including ligand molecules.

Further, this score matrix is utilized to obtain alignment of primary structures of a plurality of proteins similar to one another's 3-dimensional structures, thereby enabling homology modeling and increasing the industrial usefulness of modeled proteins. At this time, the method of preparing the profile is the same method that used in substitution of amino acid residues.

Using this score matrix, an improved score matrix applicable especially to proteins caused to undergo structural change is obtained to predict the stable structure of folding in the proteins and utilized in industry. At this time, not only the stabilizing free energy of proteins but also the weight of amino acid residues considered useful in keeping a shape important for function of protein is reevaluated to provide methodologies and programs usable specifically in structural stability.

For solving the problems and for achieving the object, the present invention relates to an apparatus for processing 3-dimensional structure of protein, including a control unit and a storage unit, which calculates a score matrix that is physical quantity indicating whether amino acid residue in a 3-dimensional structure of protein is energetically stable in a specific environment, and a method of processing 3-dimensional structure of protein or the program which is executed by the apparatus, wherein the storage unit stores at least 3-dimensional structure information of protein that defines 3-dimensional structure coordinates of a protein composed of a plurality of the amino acid residues, and the control unit includes a mutated 3-dimensional structure-predicting unit (or step) that predicts 3-dimensional structure information of protein after an arbitrary amino acid residue A in the 3-dimensional structure information of protein, stored in the storage unit is mutated into another amino acid residue a, an environmental change information-collecting unit (or step) that from the 3-dimensional structure information of protein after a mutation predicted with the mutated 3-dimensional structure-predicting unit (or step), collects the amino acid residue A, the amino acid residue a, environment information P, and environment information p, which are related to each other, as information on environmental change, when the environment information P around the amino acid residue A before the mutation changes to the environment information p around the amino acid residue a after the mutation, thereby storing environmental change information in the storage unit, a standard deviation-calculating unit (or step) that while assuming that a plural pieces of the environment information p after the mutation relative to the environment information P before the mutation in the information on environmental change collected by the environmental change information-collecting unit (or step) follow normal distribution, calculates standard deviation σ(P) for the environment information P and relates the environment information P to the standard deviation σ(P) to store the environment information and the standard deviation σ(P) in the storage unit, and a score matrix-calculating unit (or step) that when a number (N(i|j)) of amino acid residues i present in a specific environment information j are obtained as calculation of the score matrix, corrects the N(i|j) to calculate the score matrix using a weighting parameter considering standard deviation σ(J) for environment information J after the mutation corresponding to the environment information j stored in the standard deviation-calculating unit (or step), and considering the standard deviation and an absolute value in difference between the environment information other than the environment information j and the environment information j.

The present invention is characterized in that the environment information is defined by the fraction of area occupied by polar atoms (fraction polar) that is the ratio of polar atoms occupying the surface of the amino acid residue, the fraction of buried area of the surface of the amino acid residue (fraction buried), and secondary structure information.

The present invention is characterized in that the score matrix-calculating unit (or step) uses the following equation as the weighting parameter:

$$\begin{matrix}[ Eq . 3 ] & \\ w ( \begin{matrix}polar , \\ buried , \\ p , b\end{matrix} ) = exp ( \frac{- {p}^{2}}{2 \times {σ}_{polar}^{2}} ) \times exp ( \frac{- {b}^{2}}{2 \times {σ}_{buried}^{2}} ) & \end{matrix}$$

wherein w(polar, buried, p, b) is the weighting parameter in the environment that the fraction of area occupied by polar atoms (polar) is shifted by p and the fraction of buried area (buried) is shifted by b in the environment information defined by 3 parameters consisting of fraction of area occupied by polar atoms (polar), fraction of buried area (buried), and secondary structure information (ss). p is the absolute value in difference between the fraction of area occupied by polar atoms (polar) before and after the mutation, b is the absolute value in difference between the fraction of buried area (buried) before and after the mutation, σₚₒₗₐᵣ is the standard deviation in the fraction of area occupied by polar atoms (polar) obtained from information on the amino acid residues after the mutation, and σ_{buried} is the standard deviation in fraction of buried area (buried) obtained from information on the amino acid residues after the mutation.

The present invention is characterized in that the score matrix-calculating unit (or step) calculates, as the score matrix, SCORE(AA|ss, polar, buried) using the following equation:

$$\begin{matrix}[ Eq . 4 ] & \\ \begin{matrix}P ( \begin{matrix}AA \vert ss , \\ polar , \\ buried\end{matrix} ) = \frac{{\sum }_{m , n}^{ } w ( \begin{matrix}polar , \\ buried , \\ m , n\end{matrix} ) N ( \begin{matrix}AA \vert ss , \\ polar + m , \\ buried + n\end{matrix} )}{{\sum }_{aa}^{ } {\sum }_{m , n}^{ } w ( \begin{matrix}polar , \\ buried , \\ m , n\end{matrix} ) N ( \begin{matrix}aa \vert ss , \\ polar + m , \\ buried + n\end{matrix} )} \\ SCORE ( \begin{matrix}AA \vert ss , \\ polar , \\ buried\end{matrix} ) = log ( \frac{P ( \begin{matrix}AA \vert ss , \\ polar , \\ buried\end{matrix} )}{P ( AA )} )\end{matrix} & \end{matrix}$$

wherein P(AA|ss, polar, buried) is the ratio of amino acid residue AA present in the environment information consisting of the secondary structure information (ss), the fraction of area occupied by polar atoms (polar), and the fraction of buried area (buried).

The present invention is characterized by further including an accuracy-evaluating unit (or step) that calculates the score matrix for each of amino acid residues, and thereof obtains the summation, thereby evaluating the accuracy of the 3-dimensional structure information of protein.

The present invention is characterized in that the 3-dimensional structure information of protein includes 3-dimensional structure information on a complex of ligand and a protein with which the ligand interacts or a complex of ligand and a protein into which the ligand has been inserted with a docking program, and amino acid residues around the ligand are changed thereby calculating the score matrix, to search for the state of mutation in amino acid residue where the highest score matrix is calculated.

The present invention is characterized in that the environmental change information on the amino acid residues is used, and the score matrix is used to search for folding state of 3-dimensional structures of protein similar to one another by dynamic programming (DP).

The present invention is characterized in that the score matrix-calculating unit (or step) calculates, 3D1Dscoreij shown in the following equation including, as correction term k(i), the strength of influence of the amino acid residue i on folding structure of protein as the score matrix:

$$\begin{matrix}[ Eq . 5 ] & \\ 3 D 1 D score ij = k ( i ) \cdot ln ( \frac{P ( i \vert j )}{Pi} ) \\ P ( i \vert j ) = \frac{N ( i \vert j )}{{\sum }_{a = 1}^{20} N ( a \vert j )} \\ Pi = \frac{N ( i )}{{\sum }_{a = 1}^{20} N ( a )} & \end{matrix}$$

wherein P(i|j) is the frequency of the amino acid residue i appearing in the environment information j, Pi is the ratio of the amino acid residue i present regardless of the environment, N(i|j) is the number of the amino acid residue observed in the environment information j, and N(i) is the number of the amino acid residue i observed.

Also, the present invention is characterized in that the numerical values calculated by the score matrix for amino acid residues around a specific amino acid residue of a protein is summed up to evaluate the modification of functions of the protein and the degree of contribution of the specific amino acid residue to functions of the protein.

### EFFECT OF THE INVENTION

According to the present invention, the category classification of environments in the score function by the 3D1D method can be virtually subdivided infinitely, and the evaluation of the environment around amino acid residues can be performed accurately. That is, there is brought about an effect of providing apparatus for processing 3-dimensional structure of protein, a method of processing 3-dimensional structure of protein and the program, wherein even if the category classification of environments is subdivided, the number of N(i|j) can be corrected so as to serve as the quantity of statistically sufficient data while the score matrix, that is, the physical quantity indicating whether the amino acid residue i present in the environment j are energetically stable can be prepared.

### BRIEF DESCRIPTION OF DRAWINGS

FIG. 1 is a view showing category classification of environments in conventional Verify3D.

FIG. 2 is a distribution map of amino acid residue Valine applied to FIG. 1.

FIG. 3 is a block diagram showing an example of a configuration of a system to which the present invention is applied.

FIG. 4 is a scatter plot of change of fraction of buried area (fraction buried) after mutation in amino acid residue.

FIG. 5 is a scatter plot of change of fraction of area occupied by polar atoms (fraction polar) after mutation in amino acid residue.

FIG. 6 is a frequency distribution map (frequency) in each fraction buried after mutation drawn with red line and a Gaussian distribution map obtained from the calculated standard deviation drawn with green line in a category 0 of the fraction buried of amino acid residue divided into 25.

FIG. 7 is a frequency distribution map (frequency) in each fraction buried after mutation drawn with red line and a Gaussian distribution map obtained from the calculated standard deviation drawn with green line in a category 1 of the fraction buried of amino acid residue divided into 25.

FIG. 8 is a frequency distribution map (frequency) in each fraction buried after mutation drawn with red line and a Gaussian distribution map obtained from the calculated standard deviation drawn with green line in a category 2 of the fraction buried of amino acid residue divided into 25.

FIG. 9 is a frequency distribution map (frequency) in each fraction buried after mutation drawn with red line and a Gaussian distribution map obtained from the calculated standard deviation drawn with green line in a category 3 of the fraction buried of amino acid residue divided into 25.

FIG. 10 is, a frequency distribution map (frequency) in each fraction buried after mutation drawn with red line and a Gaussian distribution map obtained from the calculated standard deviation drawn with green line in a category 4 of the fraction buried of amino acid residue divided into 25.

FIG. 11 is a frequency distribution map (frequency) in each fraction buried after mutation drawn with red line and a Gaussian distribution map obtained from the calculated standard deviation drawn with green line in a category 5 of the fraction buried of amino acid residue divided into 25.

FIG. 12 is a frequency distribution map (frequency) in each fraction buried after mutation drawn with red line and a Gaussian distribution map obtained from the calculated standard deviation drawn with green line in a category 6 of the fraction buried of amino acid residue divided into 25.

FIG. 13 is a frequency distribution map (frequency) in each fraction buried after mutation drawn with red line and a Gaussian distribution map obtained from the calculated standard deviation drawn with green line in a category 7 of the fraction buried of amino acid residue divided into 25.

FIG. 14 is a frequency distribution map (frequency) in each fraction buried after mutation drawn with red line and a Gaussian distribution map obtained from the calculated standard deviation drawn with green line in a category 8 of the fraction buried of amino acid residue divided into 25.

FIG. 15 is a frequency distribution map (frequency) in each fraction buried after mutation drawn with red line and a Gaussian distribution map obtained from the calculated standard deviation drawn with green line in a category 9 of the fraction buried of amino acid residue divided into 25.

FIG. 16 is a frequency distribution map (frequency) in each fraction buried after mutation drawn with red line and a Gaussian distribution map obtained from the calculated standard deviation drawn with green line in a category 10 of the fraction buried of amino acid residue divided into 25.

FIG. 17 is a frequency distribution map (frequency) in each fraction buried after mutation drawn with red line and a Gaussian distribution map obtained from the calculated standard deviation drawn with green line in a category 11 of the fraction buried of amino acid residue divided into 25.

FIG. 18 is a frequency distribution map (frequency) in each fraction buried after mutation drawn with red line and a Gaussian distribution map obtained from the calculated standard deviation drawn with green line in a category 12 of the fraction buried of amino acid residue divided into 25.

FIG. 19 is a frequency distribution map (frequency) in each fraction buried after mutation drawn with red line and a Gaussian distribution map obtained from the calculated standard deviation drawn with green line in a category 13 of the fraction buried of amino acid residue divided into 25.

FIG. 20 is a frequency distribution map (frequency) in each fraction buried after mutation drawn with red line and a Gaussian distribution map obtained from the calculated standard deviation drawn with green line in a category 14 of the fraction buried of amino acid residue divided into 25.

FIG. 21 is a frequency distribution map (frequency) in each fraction buried after mutation drawn with red line and a Gaussian distribution map obtained from the calculated standard deviation drawn with green line in a category 15 of the fraction buried of amino acid residue divided into 25.

FIG. 22 is a frequency distribution map (frequency) in each fraction buried after mutation drawn with red line and a Gaussian distribution map obtained from the calculated standard deviation drawn with green line in a category 16 of the fraction buried of amino acid residue divided into 25.

FIG. 23 is a frequency distribution map (frequency) in each fraction buried after mutation drawn with red line and a Gaussian distribution map obtained from the calculated standard deviation drawn with green line in a category 17 of the fraction buried of amino acid residue divided into 25.

FIG. 24 is a frequency distribution map (frequency) in each fraction buried after mutation drawn with red line and a Gaussian distribution map obtained from the calculated standard deviation drawn with green line in a category 18 of the fraction buried of amino acid residue divided into 25.

FIG. 25 is a frequency distribution map (frequency) in each fraction buried after mutation drawn with red line and a Gaussian distribution map with green line obtained from the calculated standard deviation drawn with green line in a category 19 of the fraction buried of amino acid residue divided into 25.

FIG. 26 is a frequency distribution map (frequency) in each fraction buried after mutation drawn with red line and a Gaussian distribution map obtained from the calculated standard deviation drawn with green line in a category 20 of the fraction buried of amino acid residue divided into 25.

FIG. 27 is a frequency distribution map (frequency) in each fraction buried after mutation drawn with red line and a Gaussian distribution map obtained from the calculated standard deviation drawn with green line in a category 21 of the fraction buried of amino acid residue divided into 25.

FIG. 28 is a frequency distribution map (frequency) in each fraction buried after mutation drawn with red line and a Gaussian distribution map obtained from the calculated standard deviation drawn with green line in a category 22 of the fraction buried of amino acid residue divided into 25.

FIG. 29 is a frequency distribution map (frequency) in each fraction buried after mutation drawn with red line and a Gaussian distribution map obtained from the calculated standard deviation drawn with green line in a category 23 of the fraction buried of amino acid residue divided into 25.

FIG. 30 is a frequency distribution map (frequency) in each fraction buried after mutation drawn with red line and a Gaussian distribution map obtained from the calculated standard deviation drawn with green line in a category 24 of the fraction buried of amino acid residue divided into 25.

FIG. 31 is a frequency distribution map (frequency) with red line in each fraction polar after mutation drawn with red line and a Gaussian distribution map obtained from the calculated standard deviation drawn with green line in a category 0 of fraction polar of amino acid residue divided into 25.

FIG. 32 is a frequency distribution map (frequency) in each fraction polar after mutation drawn with red line and a Gaussian distribution map obtained from the calculated standard deviation drawn with green line in a category 1 of the fraction polar of amino acid residue divided into 25.

FIG. 33 is a frequency distribution map (frequency) in each fraction polar after mutation drawn with red line and a Gaussian distribution map obtained from the calculated standard deviation drawn with green line in a category 2 of the fraction polar of amino acid residue divided into 25.

FIG. 34 is a frequency distribution map (frequency) in each fraction polar after mutation drawn with red line and a Gaussian distribution map obtained from the calculated standard deviation drawn with green line in a category 3 of the fraction polar of amino acid residue divided into 25.

FIG. 35 is a frequency distribution map (frequency) in each fraction polar after mutation drawn with red line and a Gaussian distribution map obtained from the calculated standard deviation drawn with green line in a category 4 of the fraction polar of amino acid residue divided into 25.

FIG. 36 is a frequency distribution map (frequency) in each fraction polar after mutation drawn with red line and a Gaussian distribution map obtained from the calculated standard deviation drawn with green line in a category 5 of the fraction polar of amino acid residue divided into 25.

FIG. 37 is a frequency distribution map (frequency) in each fraction polar after mutation drawn with red line and a Gaussian distribution map obtained from the calculated standard deviation drawn with green line in a category 6 of the fraction polar of amino acid residue divided into 25.

FIG. 38 is a frequency distribution map (frequency) in each fraction polar after mutation drawn with red line and a Gaussian distribution map obtained from the calculated standard deviation drawn with green line in a category 7 of the fraction polar of amino acid residue divided into 25.

FIG. 39 is a frequency distribution map (frequency) in each fraction polar after mutation drawn with red line and a Gaussian distribution map obtained from the calculated standard deviation drawn with green line in a category 8 of the fraction polar of amino acid residue divided into 25.

FIG. 40 is a frequency distribution map (frequency) in each fraction polar after mutation drawn with red line and a Gaussian distribution map obtained from the calculated standard deviation drawn with green line in a category 9 of the fraction polar of amino acid residue divided into 25.

FIG. 41 is a frequency distribution map (frequency) in each fraction polar after mutation drawn with red line and a Gaussian distribution map obtained from the calculated standard deviation drawn with green line in a category 10 of the fraction polar of amino acid residue divided into 25.

FIG. 42 is a frequency distribution map (frequency) in each fraction polar after mutation drawn with red line and a Gaussian distribution map obtained from the calculated standard deviation drawn with green line in a category 11 of the fraction polar of amino acid residue divided into 25.

FIG. 43 is a frequency distribution map (frequency) in each fraction polar after mutation drawn with red line and a Gaussian distribution map obtained from the calculated standard deviation drawn with green line in a category 12 of the fraction polar of amino acid residue divided into 25.

FIG. 44 is a frequency distribution map (frequency) in each fraction polar after mutation drawn with red line and a Gaussian distribution map obtained from the calculated standard deviation drawn with green line in a category 13 of the fraction polar of amino acid residue divided into 25.

FIG. 45 is a frequency distribution map (frequency) in each fraction polar after mutation drawn with red line and a Gaussian distribution map obtained from the calculated standard deviation drawn with green line in a category 14 of the fraction polar of amino acid residue divided into 25.

FIG. 46 is a frequency distribution map (frequency) in each fraction polar after mutation drawn with red line and a Gaussian distribution map obtained from the calculated standard deviation drawn with green line in a category 15 of the fraction polar of amino acid residue divided into 25.

FIG. 47 is a frequency distribution map (frequency) in each fraction polar after mutation drawn with red line and a Gaussian distribution map obtained from the calculated standard deviation drawn with green line in a category 16 of the fraction polar of amino acid residue divided into 25.

FIG. 48 is a frequency distribution map (frequency) in each fraction polar after mutation drawn with red line and a Gaussian distribution map obtained from the standard deviation drawn with green line in a category 17 of the fraction polar of amino acid residue divided into 25.

FIG. 49 is a frequency distribution map (frequency) in each fraction polar after mutation drawn with red line and a Gaussian distribution map obtained from the calculated standard deviation drawn with green line in a category 18 of the fraction polar of amino acid residue divided into 25.

FIG. 50 is a frequency distribution map (frequency) in each fraction polar after mutation drawn with red line and a Gaussian distribution map obtained from the calculated standard deviation drawn with green line in a category 19 of the fraction polar of amino acid residue divided into 25.

FIG. 51 is a frequency distribution map (frequency) in each fraction polar after mutation drawn with red line and a Gaussian distribution map obtained from the calculated standard deviation drawn with green line in a category 20 of the fraction polar of amino acid residue divided into 25.

FIG. 52 is a frequency distribution map (frequency) in each fraction polar after mutation drawn with red line and a Gaussian distribution map obtained from the calculated standard deviation drawn with green line in a category 21 of the fraction polar of amino acid residue divided into 25.

FIG. 53 is a frequency distribution map (frequency) in each fraction polar after mutation drawn with red line and a Gaussian distribution map obtained from the calculated standard deviation drawn with green line in a category 22 of the fraction polar of amino acid residue divided into 25.

FIG. 54 is a frequency distribution map (frequency) in each fraction polar after mutation drawn with red line and a Gaussian distribution map obtained from the calculated standard deviation drawn with green line in a category 23 of the fraction polar of amino acid residue divided into 25.

FIG. 55 is a frequency distribution map (frequency) in each fraction polar after mutation drawn with red line and a Gaussian distribution map obtained from the calculated standard deviation drawn with green line in a category 24 of the fraction polar of amino acid residue divided into 25.

FIG. 56 is a view showing Gaussian distribution in the environment with 0 to 4% fraction of buried area (fraction buried) and 0 to 4% fraction of area occupied by polar atoms (fraction polar).

FIG. 57 is a view showing Gaussian distribution in the environment with 4.8 to 5.2% fraction buried and 4.8 to 5.2% fraction polar.

FIG. 58 is a chart showing distribution of frequency (N(i|j) in Eq. (2)) obtained from 3-dimensional structure information of protein analyzed by experiments on hydrophilic amino acid Lysine (LYS) whose secondary structure is 3 consecutive coils as CCC.

FIG. 59 is a chart showing distribution (frequency data) where the frequency distribution of each experimental structure where secondary structure of a hydrophilic amino acid Lysine is CCC (3 consecutive coils) has been smoothed by Eq. (3), in which the fraction buried (%) is shown on the horizontal axis and the fraction polar (%) on the vertical axis.

FIG. 60 is a chart showing score distribution of Eq. (5) where secondary structure of a hydrophilic amino acid Lysine is CCC (3 consecutive coils).

FIG. 61 is a chart showing frequency distribution (frequency data) calculated from a data set of experimental structures where secondary structure of a hydrophobic amino acid Leucine (LEU) is CCC (3 consecutive coils).

FIG. 62 is a chart showing distribution (frequency data) where the frequency distribution of each experimental structure where secondary structure of a hydrophobic amino acid Leucine is CCC (3 consecutive coils) has been smoothed by Eq. (3).

FIG. 63 is a chart showing score distribution of Eq. (5) where secondary structure of a hydrophobic amino acid Leucine is CCC (3 consecutive coils).

FIG. 64 is a chart showing distribution of correlation coefficient between GDT_TS score showing the accuracy of the structure by comparison with the experimental structure and Eq. (6).

FIG. 65 is a table showing effect of the invention in CASP7.

FIG. 66 is a table showing results that each domain structure of a 3-dimensional structure of protein was evaluated by MAXSUB_DOM.

FIG. 67 is a table showing results of evaluation by TM-Score.

FIG. 68 is a table showing results of all targets evaluated with the value of (MaxSub+TM-score+GDT_TS)/3

FIG. 69 is a table showing evaluation in a category in difficulty level of targets being EASY.

FIG. 70 is a table showing evaluation in a category in difficulty level of targets being HARD.

FIG. 71 is a table showing results of Robetta assessment.

FIG. 72 is a table showing results of Robetta assessment.

FIG. 73 is a view showing protein-protein interaction of a transcriptional regulator SlyA dimer.

FIG. 74 is a view showing interaction structure between a protein-protein complex of the transcriptional regulator SlyA dimer and DNA as a large ligand for the transcriptional regulator SlyA dimer.

FIG. 75 is a chart of alignment results with similar profile searched by a profile-profile alignment method.

FIG. 76 is a chart showing information on alignments plotted in about 60% homology (sequence numbers: 1 and 2).

FIG. 77 is a diagram showing coefficients optimized in correlation coefficient.

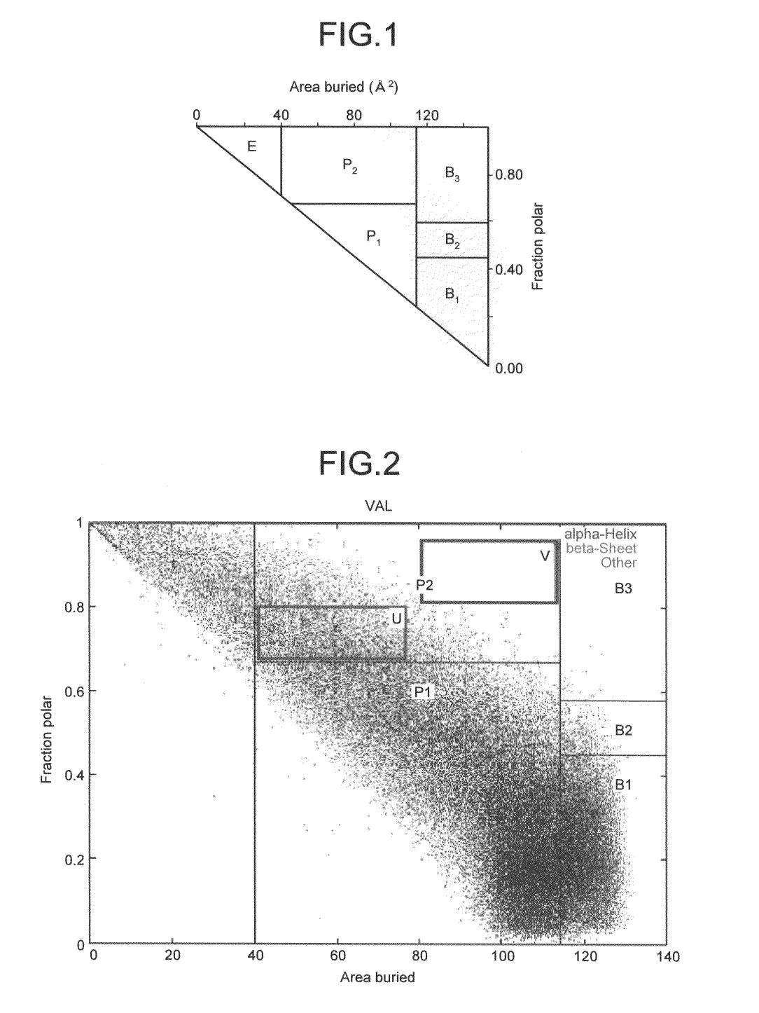

### EXPLANATIONS OF LETTERS OR NUMERALS

100 Apparatus for processing protein 3-dimensional structure of protein
102 Control unit
102a Mutated 3-dimensional structure-predicting unit
102b Environmental change information-collecting unit
102c Standard deviation-calculating unit
102d Score matrix-calculating unit
102e Accuracy-evaluating unit
102f Mutated state-searching unit
102g DP method searching unit
102h Summation-calculating unit
104 Communication control interface
106 Storage unit
106a File of 3-dimensional structure information of protein
106b File of environmental change information
106c File of standard deviation information
108 Input/output control interface
112 Input device
114 Output device
200 External system
300 Network

### BEST MODE(S) FOR CARRYING OUT THE INVENTION

The following describes an embodiment of an apparatus for processing 3-dimensional structure of protein, a method of processing 3-dimensional structure of protein and a program according to the present invention in detail with reference to the drawings. The embodiment is illustrative only, and is not intended to limit the present invention in any way.

[Overview of the System]

The following outlines the present invention, and then, a configuration and processing of the present invention are explained in detail.

In general, the invention has schematically the following basic features. That is to say, the invention relates in particular to the apparatus for processing 3-dimensional structure of protein, the method of processing 3-dimensional structure of protein and the program, which are capable of calculating a score matrix (for example, the Eq. (1) etc.) that is physical quantity indicating whether amino acid residue in a 3-dimensional structure of protein are energetically stable in a specific environment.

The storage unit in the apparatus for processing 3-dimensional structure of protein stores 3-dimensional structure information of protein that defines 3-dimensional structure coordinates of a protein composed of a plurality of the amino acid residues.

The control unit in the apparatus for processing 3-dimensional structure of protein predicts 3-dimensional structure information of protein after an arbitrary amino acid residue A in the 3-dimensional structure information of protein stored in the storage unit is mutated into another amino acid residue a.

The control unit in the apparatus for processing 3-dimensional structure of structure, from the 3-dimensional structure information of protein after a mutation predicted, collects the amino acid residue A, the amino acid residue a, environment information P, and environment information p, which are related to each other, as information on environmental change, when the environment information P around the amino acid residue A before the mutation changes to the environment information p around the amino acid residue a after the mutation, thereby storing environmental change information in the storage unit.

Herein, the environment information may be defined by the fraction of area occupied by polar atoms (fraction polar) that is the ratio of polar atoms occupying the surface of the amino acid residue, the fraction of buried area of the surface of the amino acid residue (fraction buried), and secondary structure information (ss).

The control unit in the apparatus for processing 3-dimensional structure of protein, while assuming that a plurality of pieces of the environment information p after the mutation corresponding to the environment information P in the environmental change information collected follow normal distribution, calculates standard deviation σ(P) for the environment information P and relates the environment information P to the standard deviation σ(P) to store the environment information and the standard deviation σ(P) in the storage unit.

The control unit in the apparatus for processing protein 3-dimensional structure of structure, when a number (N(i|j)) of amino acid residue i present in a specific environment information j as calculation of the score matrix, is obtained, corrects the N(i|j) to calculate the score matrix using a weighting parameter considering standard deviation σ(J) for environment information J after the mutation corresponding to the environment information j stored, and considering the standard deviation and an absolute value in difference between the environment information other than the environment information j and the environment information j.

Herein, Eq. (3) below may be used as the weighting parameter:

$$\begin{matrix}[ Eq . 6 ] & \\ w ( polar , buried , p , b ) = exp ( \frac{- {p}^{2}}{2 \times {σ}_{polar}^{2}} ) \times exp ( \frac{- {b}^{2}}{2 \times {σ}_{buried}^{2}} ) & ( 3 )\end{matrix}$$

In Eq. (3), w(polar, buried, p, b) is the weighting parameter in the environment that the fraction of area occupied by polar atoms (fraction polar) is shifted by p and the fraction of buried area (fraction buried) is shifted by b in the environment information defined by 3 parameters consisting of fraction polar (polar), fraction buried (buried), and secondary structure information (ss), and p is the absolute value in difference between the fraction polar (polar) before and after the mutation, b is the absolute value in difference between the fraction buried (buried) before and after the mutation, σₚₒₗₐᵣ is the standard deviation in the fraction polar (polar) obtained from information after the mutation in the amino acid residue, and σ_{buried} is the standard deviation in the fraction buried (buried) obtained from information after the mutation in the amino acid residue.

SCORE(AA|ss, polar, buried) may be calculated, as the score matrix, using Eqs. (4) and (5).

$$\begin{matrix}[ Eq . 7 ] & \\ P ( AA \vert ss , polar , buried ) = \frac{{\sum }_{m , n} w ( polar , buried , m , n ) N ( AA \vert ss , polar + m , buried + n )}{{\sum }_{aa} {\sum }_{m , n} w ( polar , buried , m , n ) N ( aa \vert ss , polar + m , buried + n )} & ( 4 ) \\ SCORE ( AA \vert ss , polar , buried ) = log ( \frac{P ( AA \vert ss , polar , buried )}{P ( AA )} ) & ( 5 )\end{matrix}$$

In Eqs. (4) and (5), P(AA|ss, polar, buried) is the ratio where amino acid residue AA presents in the environment information consisting of the secondary structure information (ss), the fraction of area occupied by polar atoms (polar), and the fraction of buried area (buried).

The control unit in the apparatus for processing 3-dimensional structure of protein may calculate the score matrix for each of amino acid residues, and thereof obtain the summation, thereby evaluating the accuracy of the 3-dimensional structure information of protein.

The 3-dimensional structure information of protein may include 3-dimensional structure information on a complex of ligand and a protein with which the ligand interacts or a complex of ligand and a protein into which the ligand has been inserted with a docking program, and in the control unit in the apparatus for processing 3-dimensional structure of protein, amino acid residues around the ligand may be changed thereby calculating the score matrix, to search for the state of mutation in amino acid residue where the highest score matrix is calculated.

In the control unit in the apparatus for processing 3-dimensional structure of protein, the environmental change information on the amino acid residue may be used, and the score matrix may be used, to search for 3-dimensional structures of protein similar to one another in folding state by dynamic programming (DP).

In the control unit in the apparatus for processing 3-dimensional structure of protein, Eq. (8) below using, as correction term k(i), the strength of influence of the amino acid residue i on the protein folding structure may be calculated as the score matrix.

$$\begin{matrix}[ Eq . 8 ] & \\ 3 D 1 D score ij = k ( i ) \cdot ln ( \frac{P ( i \vert j )}{Pi} ) & ( 8 )\end{matrix}$$

In Eq. 8, P(i|j) is the frequency of the amino acid residue i appearing in the environment information j and Pi is the ratio of the amino acid residue i being present regardless of the environment.

In the control unit in the apparatus for processing 3-dimensional structure of protein, the numerical values calculated by the score matrix for amino acid residues around a specific amino acid residue of a protein may be summed up to evaluate the modification of functions of the protein and the degree of contribution of the specific amino acid residue to functions of the protein.

[Configuration of the System]

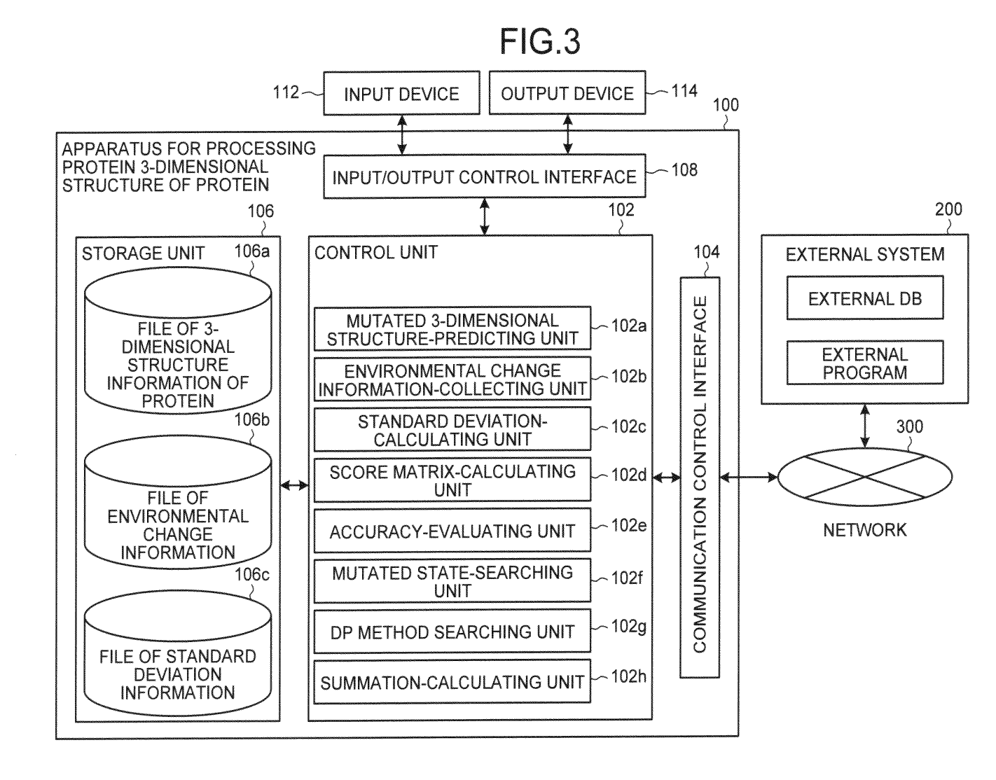

The following describes a configuration of the system. FIG. 3 is a block diagram showing an example of a configuration of a system to which the present invention is applied, and conceptually shows only parts of the configuration related to the present invention. Roughly describing, the system is composed of an apparatus for processing 3-dimensional structure of protein 100 which are capable of communicating with and of external system 200 providing external database (DB) concerning amino acid sequence and 3-dimensional structure of protein, and external program such as motif search, homology search, and the like, thorough a network 300.

In FIG. 3, the network 300 has function of mutually connecting the apparatus for processing 3-dimensional structure of protein 100 and the external system 200, and example of the network 300 is internet, and the like.

In FIG. 3, the external system 200 is mutually connected to the apparatus for processing 3-dimensional structure of protein 100 thorough a network 300, and has function of providing users with external DB concerning amino acid sequence and 3-dimensional structure of protein (PDB, and the like), and with websites executing external program such as motif search, homology search, and the like.

The external system 200 can be configured as WEB server, ASP server, and the like, and the hardware can be configured by an apparatus for processing information and the accessory devices such as personal computer, and workstation on sale anywhere. Each function of the external system 200 can be realized by a central processing unit (CPU), a disk device, a memory device, an input device, an output device, a communication control interface, and the like, and computer program controlling these devices, and so on in the external system 200.

In FIG. 3, the apparatus for processing 3-dimensional structure of protein 100 is conceptually provided against the control unit 102 such as CPU and the like, which controls the apparatus for processing 3-dimensional structure of protein 100 totally, the communication control interface 104 which connects to a communication device (not shown) such as a router connected to a communication channel or the like, the input/output control interface 108 connected to the input device 112 and the output device 114, and the storage unit 106 which stores various databases and tables, and each device (unit) are communicatably connected through an arbitrary communication channel. Further, the apparatus for processing 3-dimensional structure of protein 100 is communicatably connected to a network 300 via a communication device such as a router, and a wired or wireless communication line such as an exclusive line.

The various databases and tables (such as file 3-dimensional structure information of protein 106a, file of environmental change information 106b, and file of standard deviation information 106c) stored in the storage unit 106 are storage units such as fixed disk devices and so on. As shown in FIG. 3, the storage units store various programs, various tables, various databases, various file for web page and the like, which are used in various processes.

As shown in FIG. 3, the file of 3-dimensional structure information of protein 106a in the storage unit 106 is a storage unit for 3-dimensional structure information of protein that stores 3-dimensional structure information of protein that defines 3-dimensional structure coordinates of a protein composed of a plurality of the amino acid residues. The 3-dimensional structure information of protein may include 3-dimensional structure information on a complex of ligand and a protein with which the ligand interacts or a complex of ligand and a protein into which the ligand was inserted with a docking program.

The file of environmental change information 106b is storage unit for storing environmental change information that stores the amino acid residue A, the amino acid residue a, the environment information P, and the environment information p which are related to each other as information on environmental change, when the environment information P around the amino acid residue A before the mutation changes to the environmental information p around the amino acid residue a after the mutation.

The file of standard deviation information 106c is storage unit of standard deviation that while assuming that a plurality of pieces of the environment information p after the mutation relative to the environment information P before the mutation in the environmental change information follow normal distribution, calculates standard deviation σ(P) for the environment information P and relates the environment information P to the standard deviation σ(P) to store the environment information P and the standard deviation σ(P).

In FIG. 3, the communication control interface 104 controls communication between the apparatus for processing 3-dimensional structure of protein 100 and the network 300 (or a communication device such as a router). That is to say, the communication control interface 104 has a function to communicate data to another terminal through a communication line.

In FIG. 3, the input/output control interface 108 controls the input device 112 and the output device 114. The output device 114 corresponds to a display (monitor), a speaker, an external memory device, and the like, and the input device corresponds to a keyboard, a mouse, microphone, and the like.

In FIG. 3, the control unit 102 has an internal memory that stores a control program such as an operating system (OS), a program defining various processing procedures, and required data. The control unit 102 performs information processing for executing various processing by the programs or the like. The control unit 102 functionally conceptually has a mutated 3-dimensional structure-predicting unit 102a, an environmental change information-collecting unit 102b, a standard deviation-calculating unit 102c, a score matrix-calculating unit 102d, an accuracy-evaluating unit 102e, a mutated state-searching unit 102f, a DP method searching unit 102g, and a summation-calculating unit 102h.

The mutated 3-dimensional structure-predicting unit 102a is a mutated 3-dimensional structure-predicting unit that predicts 3-dimensional structure information of protein after an arbitrary amino acid residue A in the 3-dimensional structure information of protein is mutated into another amino acid, and that correspondingly stored 3-dimensional structure information before and after the mutation in the file of 3-dimensional structure information of protein 106a.

The environmental change information-collecting unit 102b is an environmental change information-collecting unit that from the 3-dimensional structure information of protein after the mutation predicted by the mutated 3-dimensional structure-predicting unit 102a, collects the amino acid residue A, the amino acid residue a, the environment information P, and the environment information p, which are related to each other, as information on the environmental change, when the environment information P around the amino acid residue A before the mutation changes to the environment information p around the amino acid residue a after the mutation, thereby storing the environmental change information in the file of environmental change information 106b.

The standard deviation-calculating unit 102c is a standard deviation-calculating unit that while assuming that a plurality of pieces of the environment information p after the mutation corresponding to the environment information P in the environmental change information collected by the environmental change information-collecting unit follow normal distribution, calculates standard deviation σ(P) for the environment information P and relates the environment information P to the standard deviation σ(P) to correspondingly store the environment information P and the standard deviation σ(P) in the file of standard deviation information 106c.

The score matrix-calculating unit 102d is a score matrix-calculating unit that when the number (N(i|j)) of amino acid residue i present in a specific environment information j are obtained as calculation of the score matrix, corrects the N(i|j) to calculate the score matrix using a weighting parameter considering standard deviation σ(J) for environment information J after the mutation corresponding to the environment information j stored by the standard deviation-calculating unit, and considering the standard deviation and an absolute value in difference between the environment information other than the environment information j and the environment information j.

The accuracy-evaluating unit 102e is an accuracy-evaluating unit that calculates the score matrix for each of amino acid residues, and thereof obtains the summation, thereby evaluating the accuracy of the 3-dimensional structure information of protein.

The mutated state-searching unit 102f is a mutated state-searching unit that uses 3-dimensional structure information on a complex of ligand and a protein with which the ligand interacts or a complex of ligand and a protein into which the ligand has been inserted with a docking program, changes amino acid residues around the ligand, thereby calculating the score matrix, to search for the state of mutation in amino acid residue where the highest score matrix is calculated.

The DP method searching unit 102g is DP method searching unit that uses the environmental change information on the amino acid residues, and uses the score matrix, to search for 3-dimensional structures of protein similar to one another in folding state by dynamic programming (DP).

The summation-calculating unit 102h is a summation-calculating unit that sums up the numerical values calculated by the score matrix for amino acid residues around a specific amino acid residue of a protein to evaluate the modification of functions of the protein and the degree of contribution of the specific amino acid residue to functions of the protein.

Details on the processes in the units hereinafter are described.

[Processing in the System]

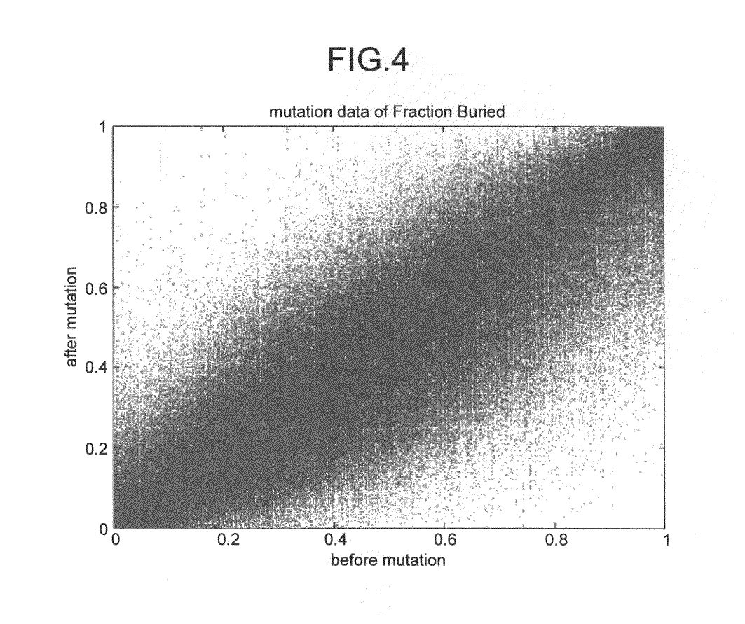

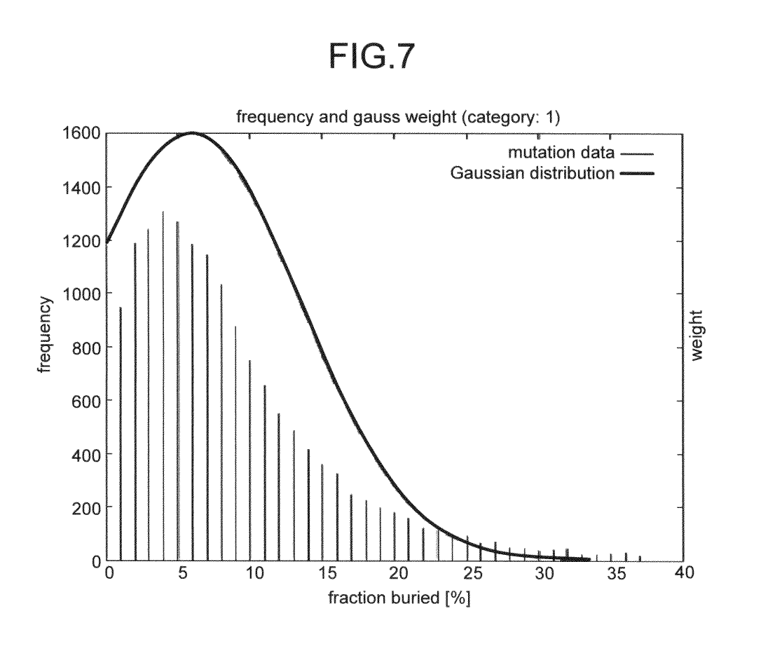

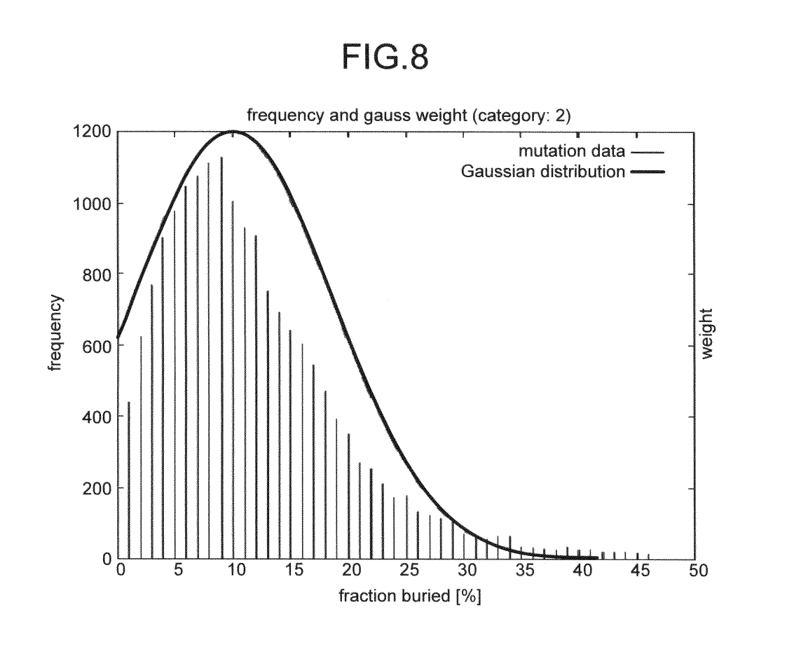

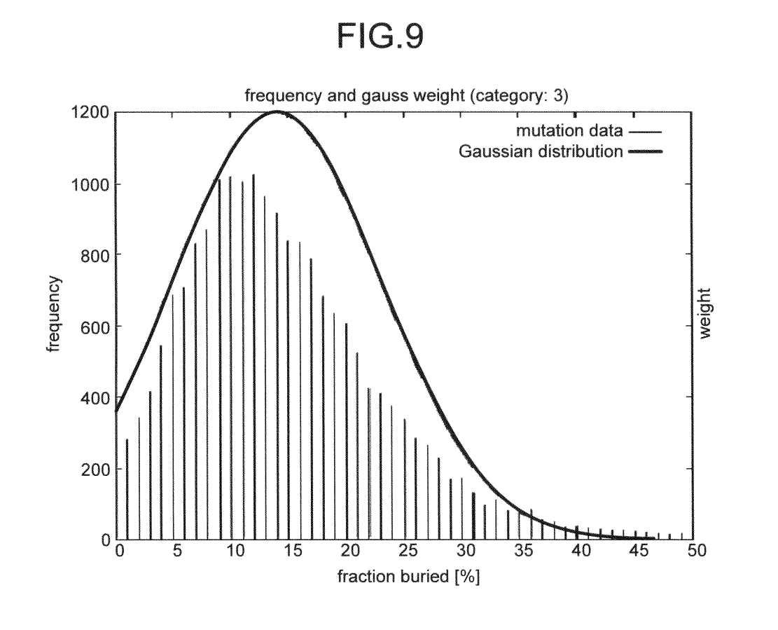

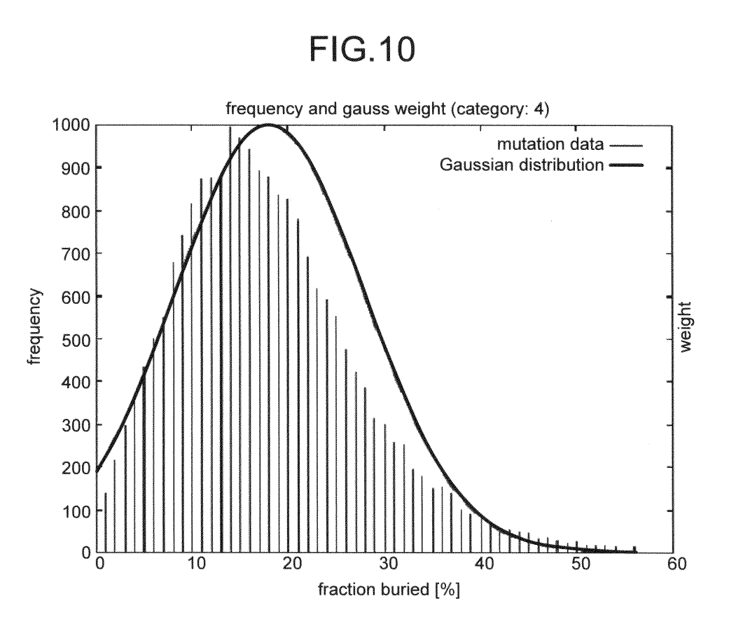

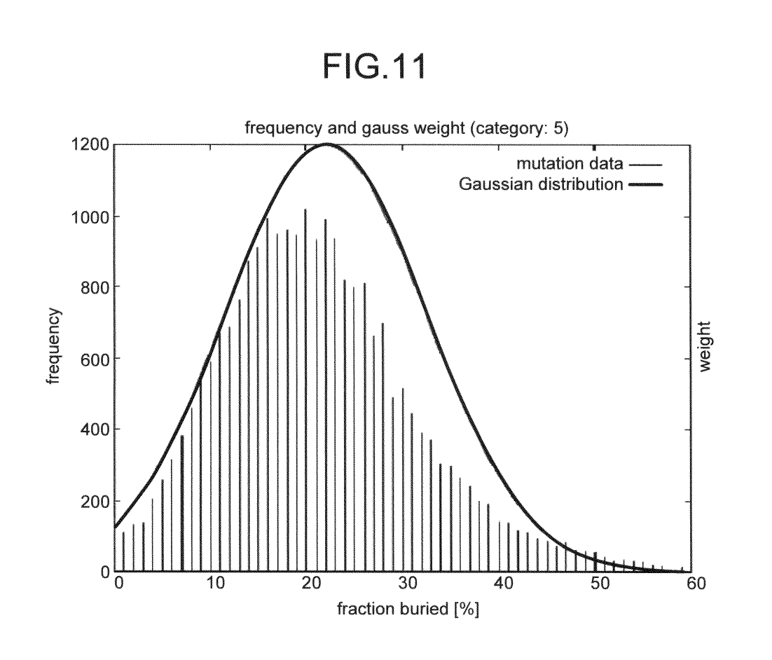

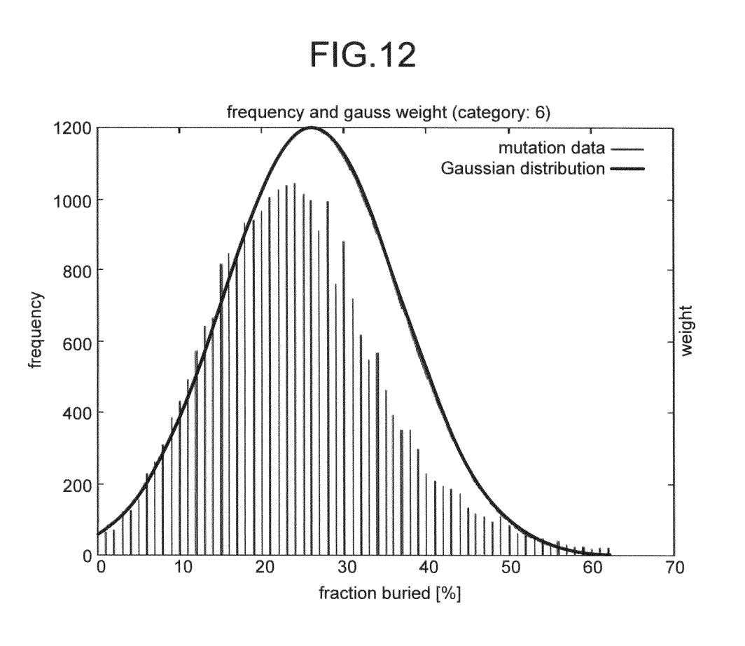

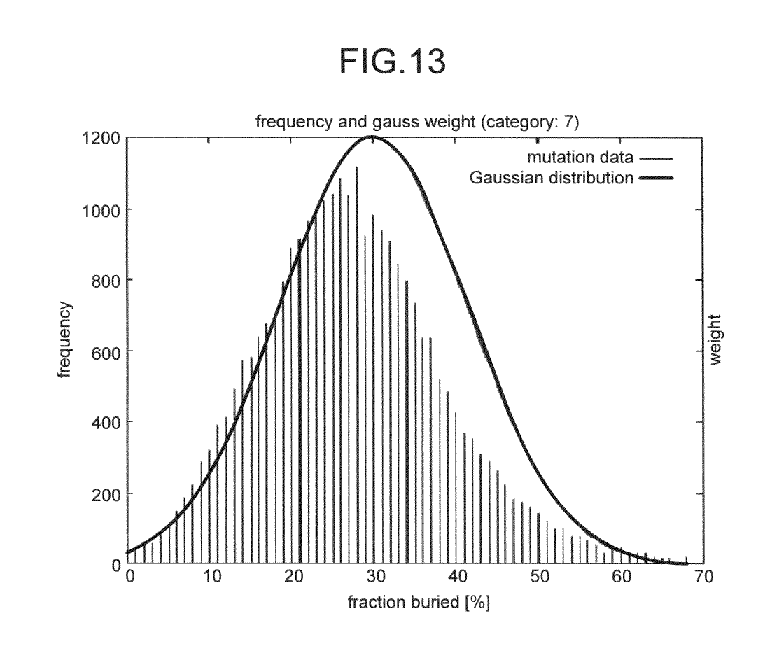

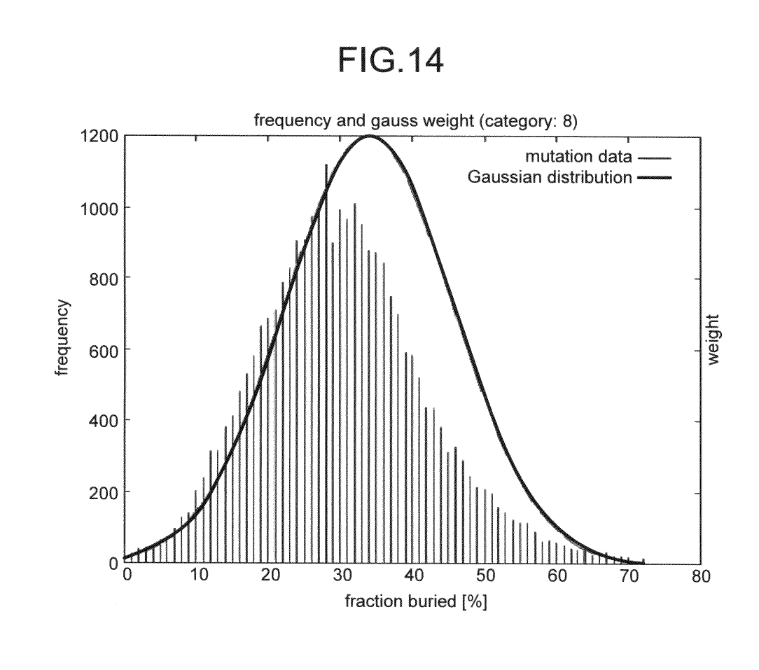

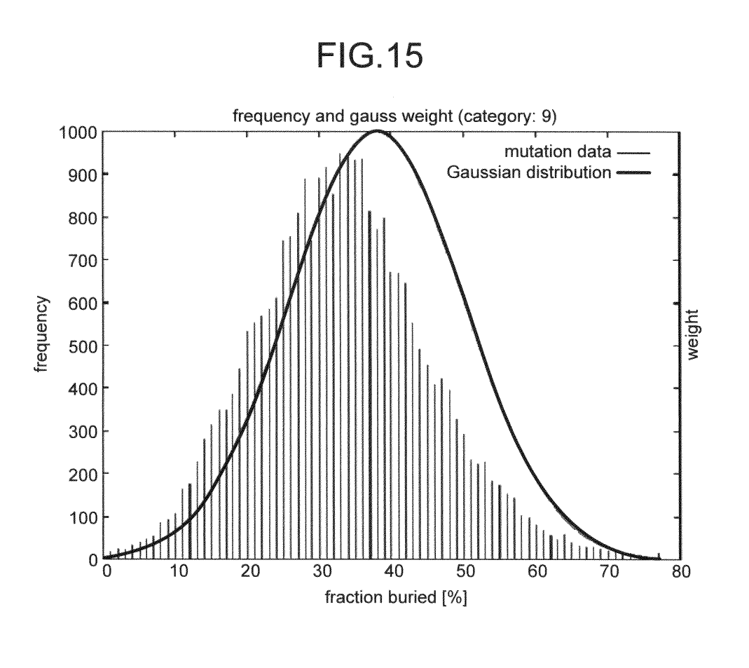

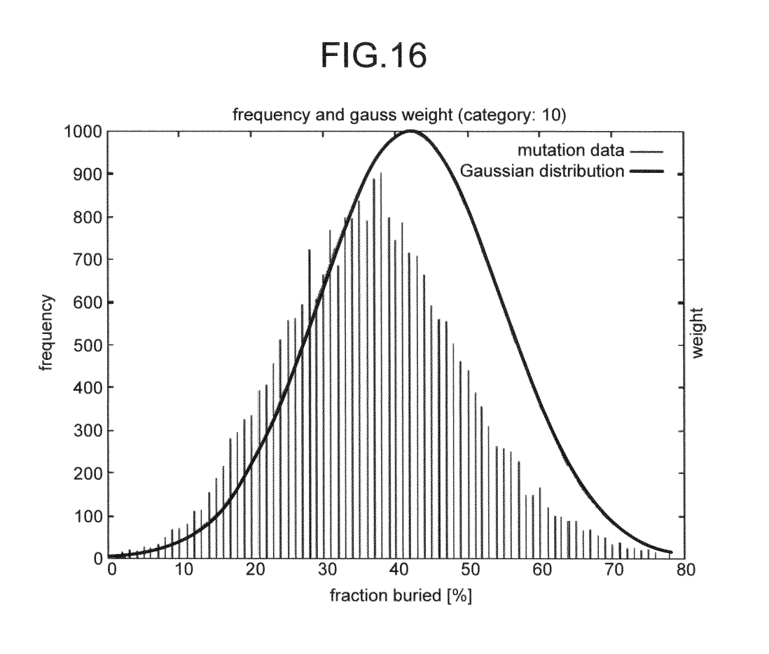

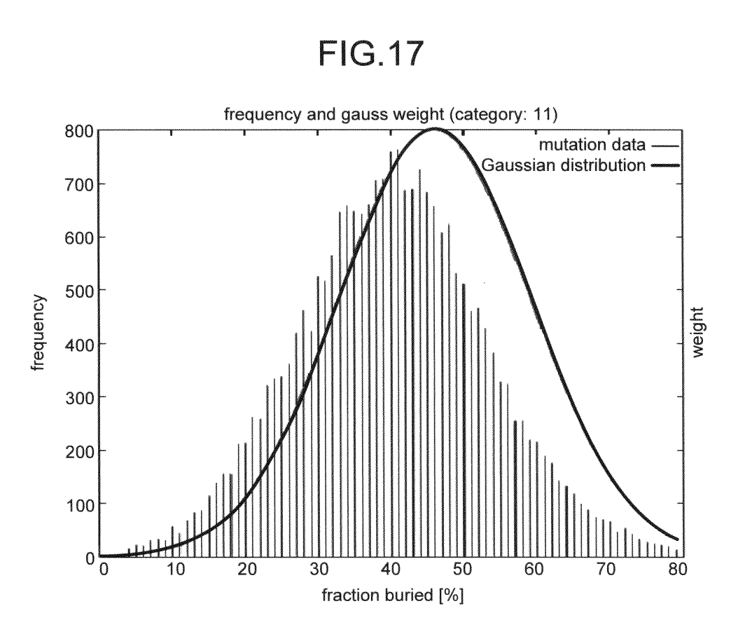

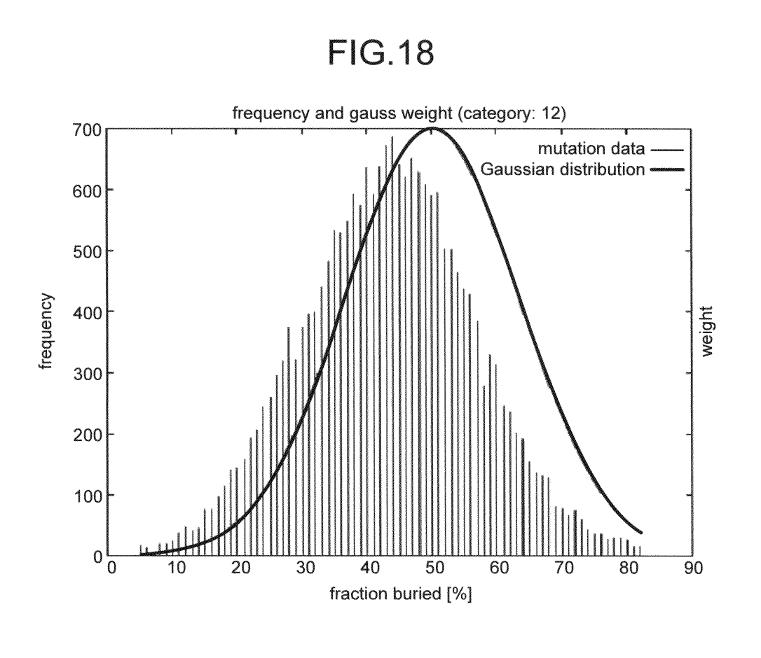

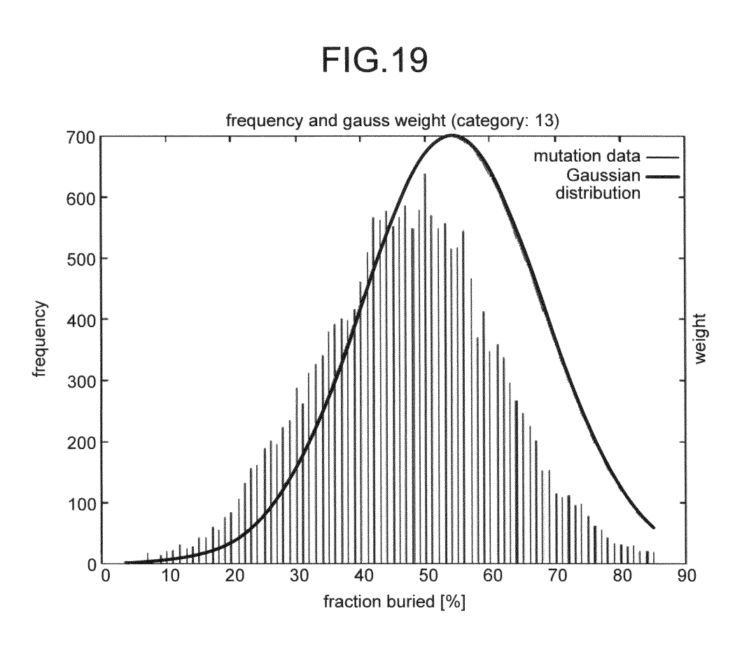

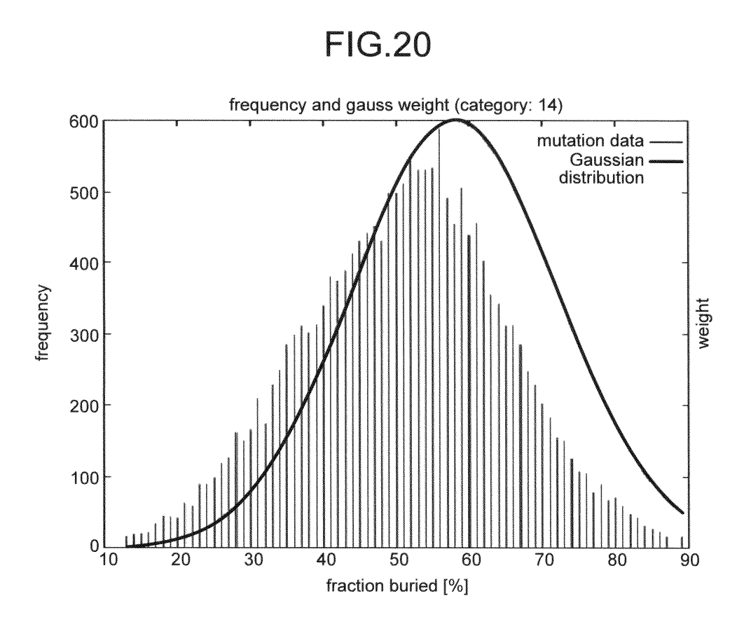

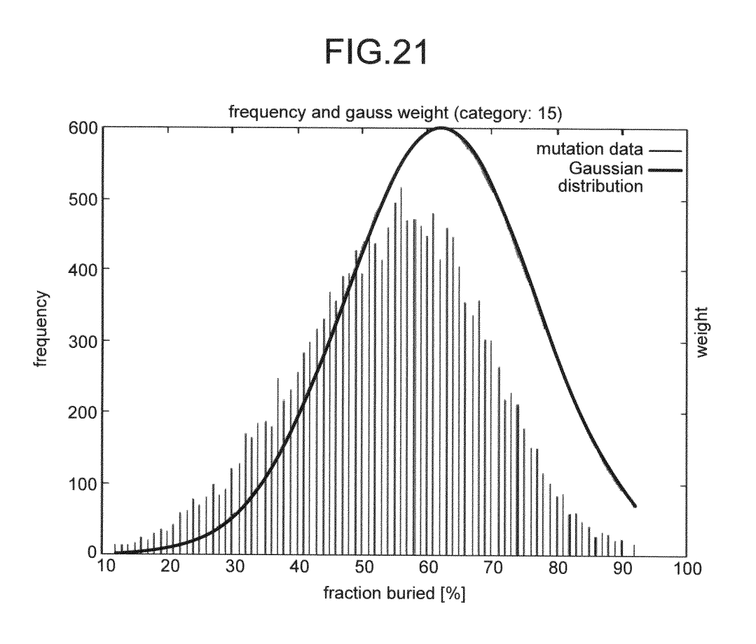

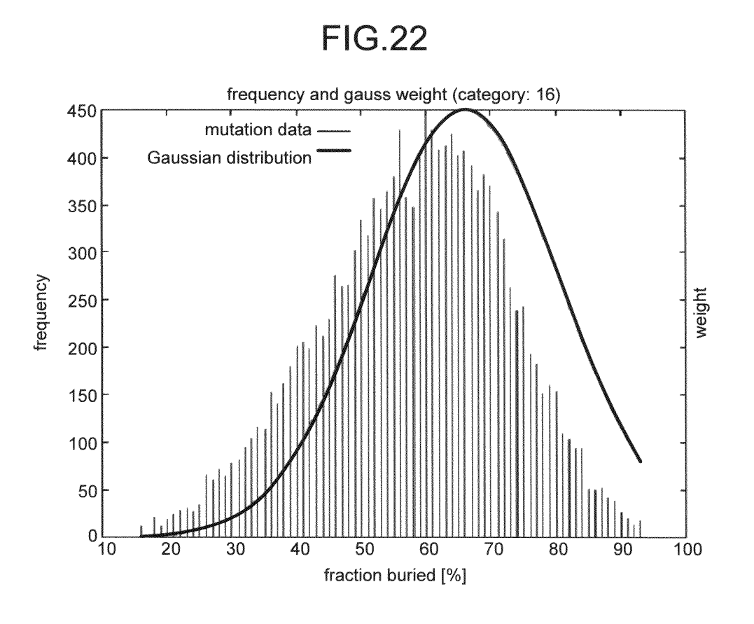

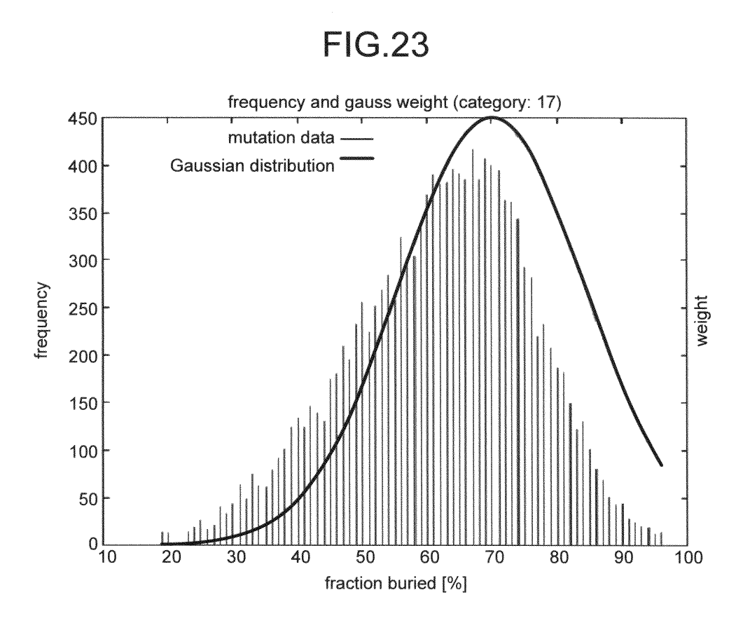

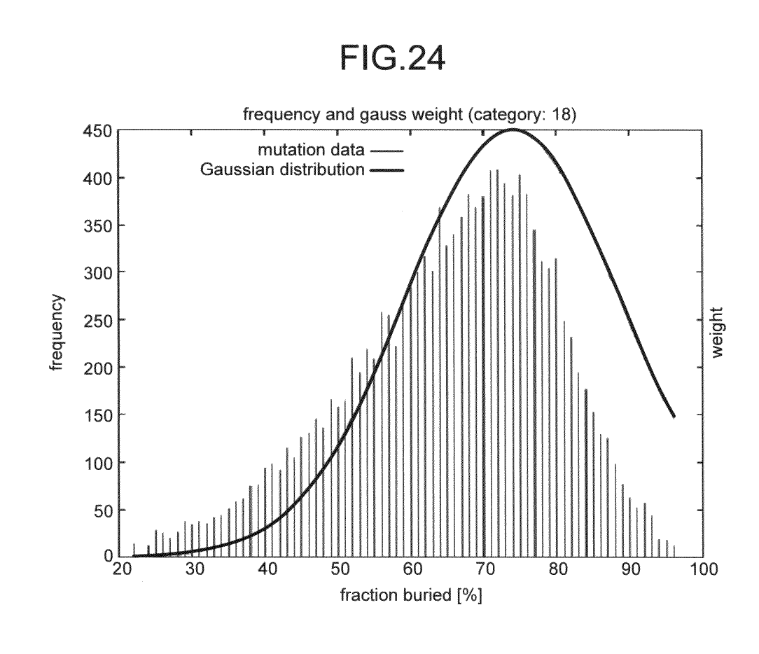

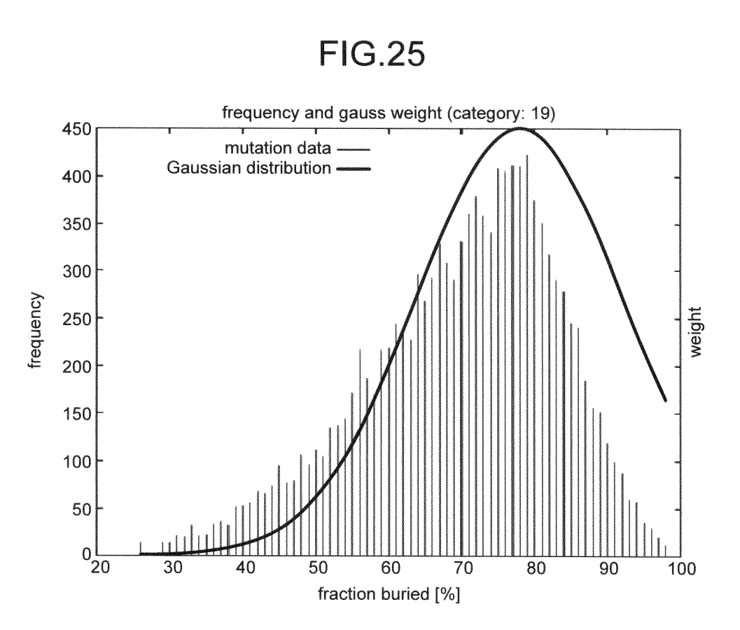

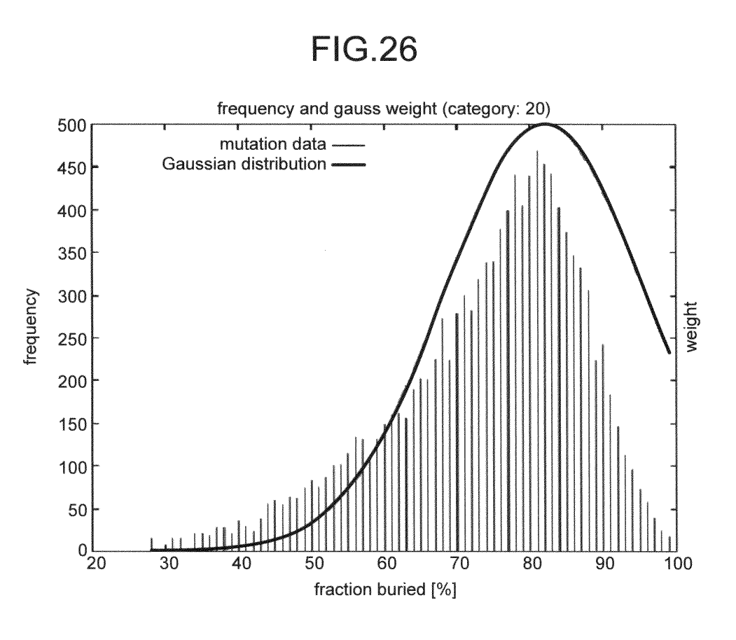

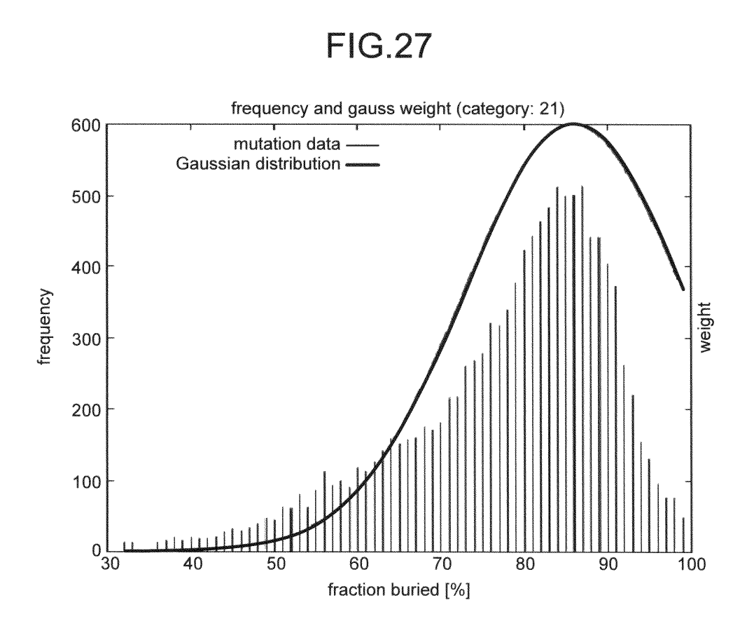

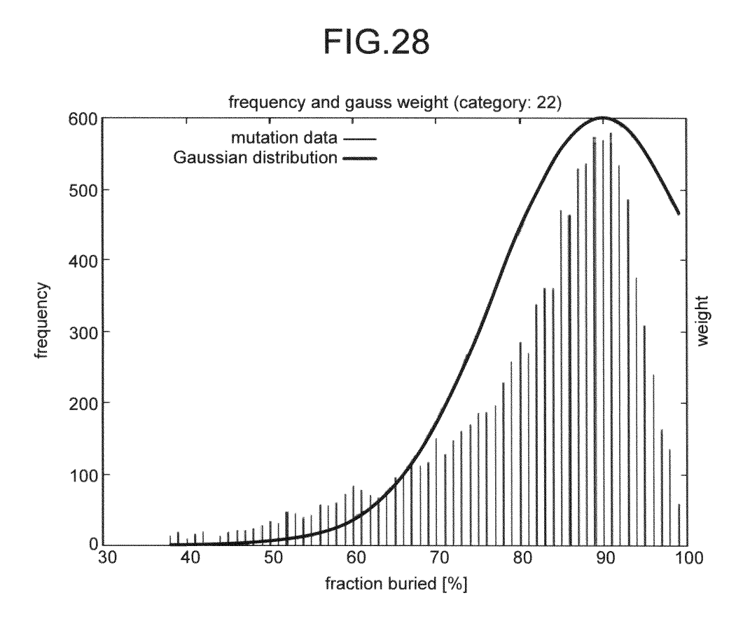

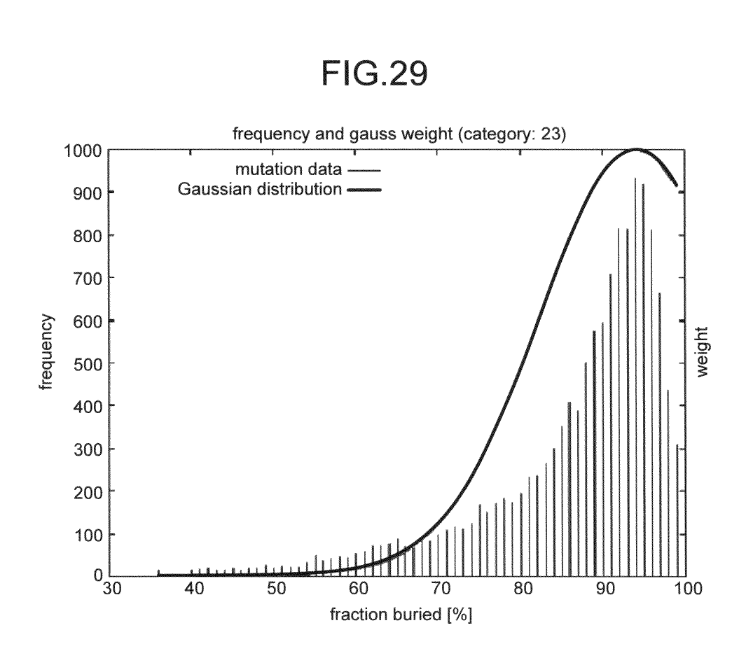

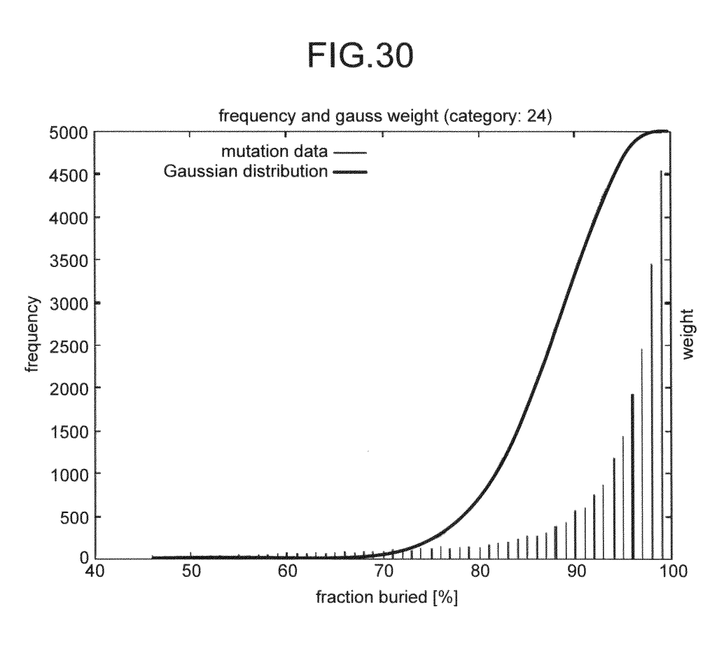

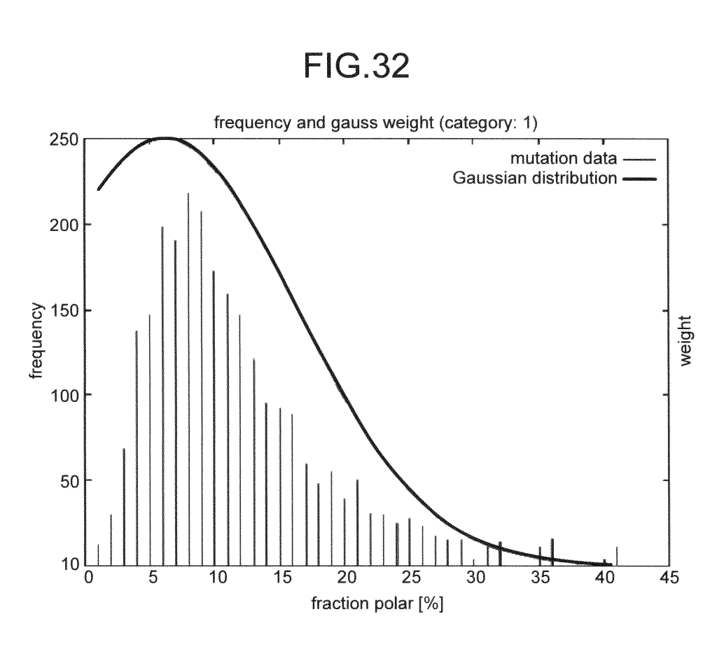

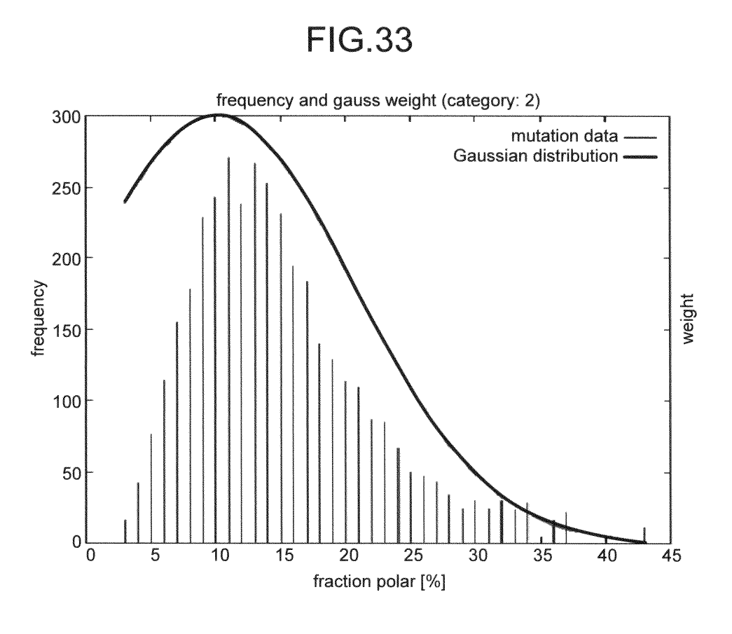

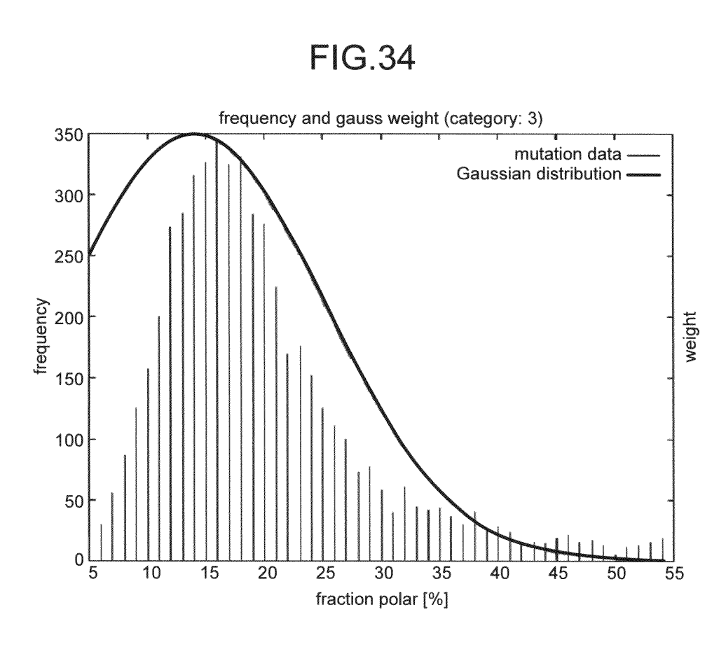

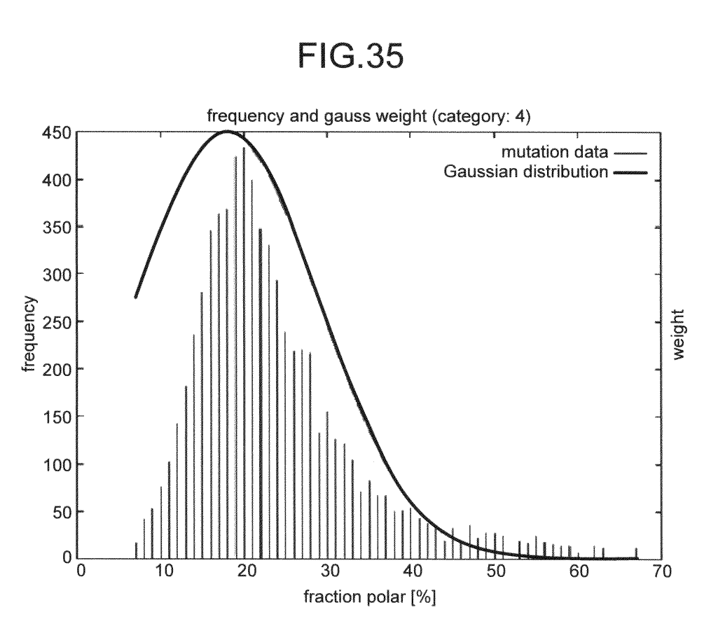

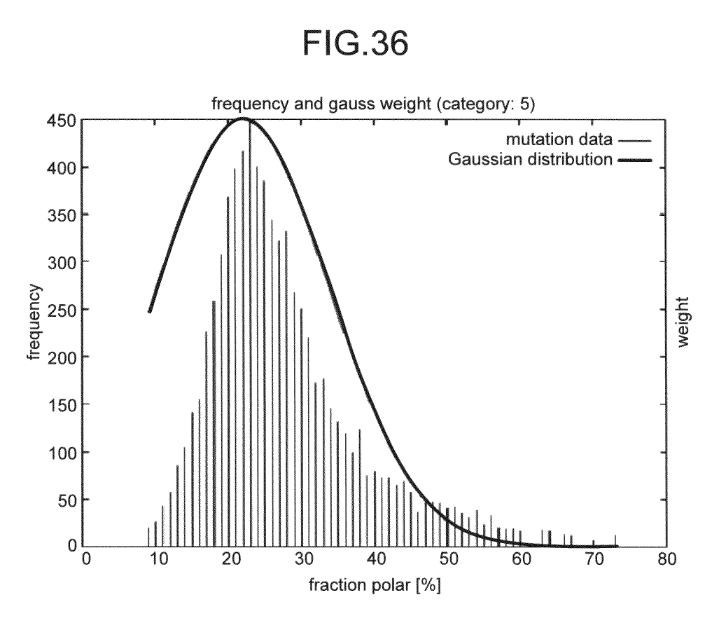

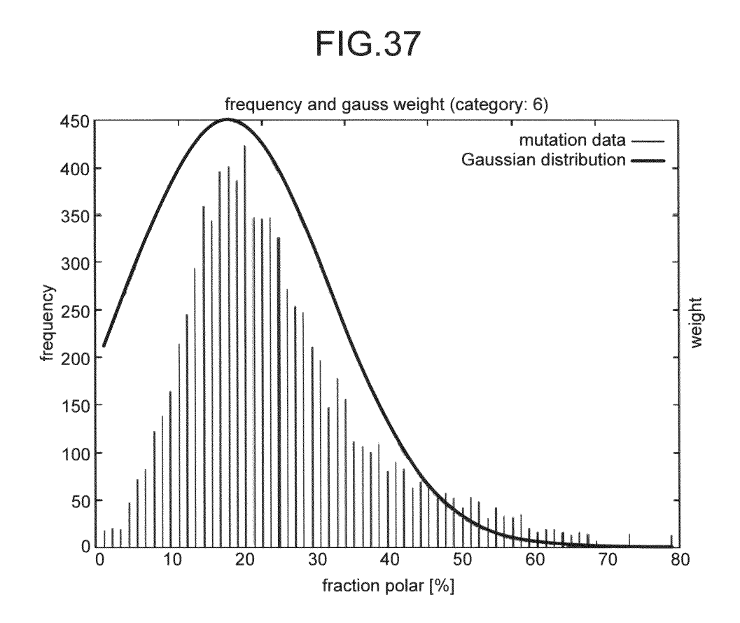

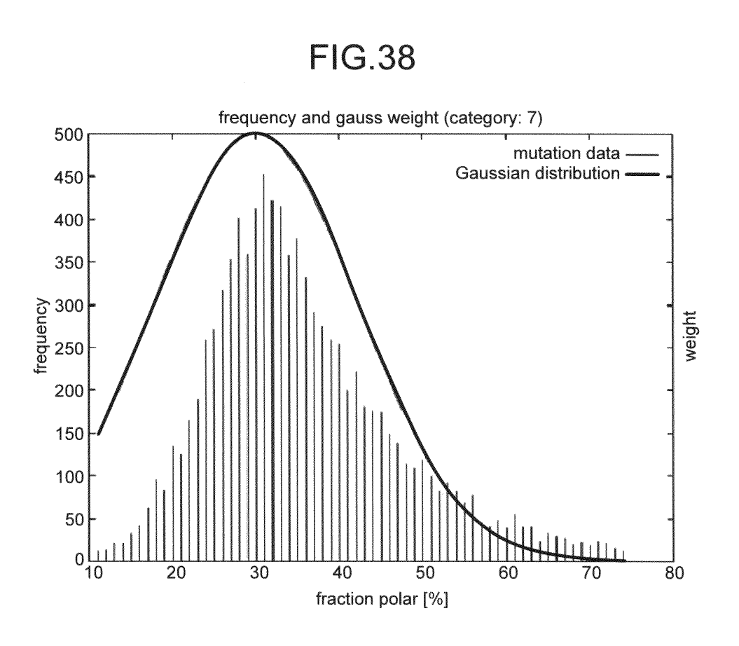

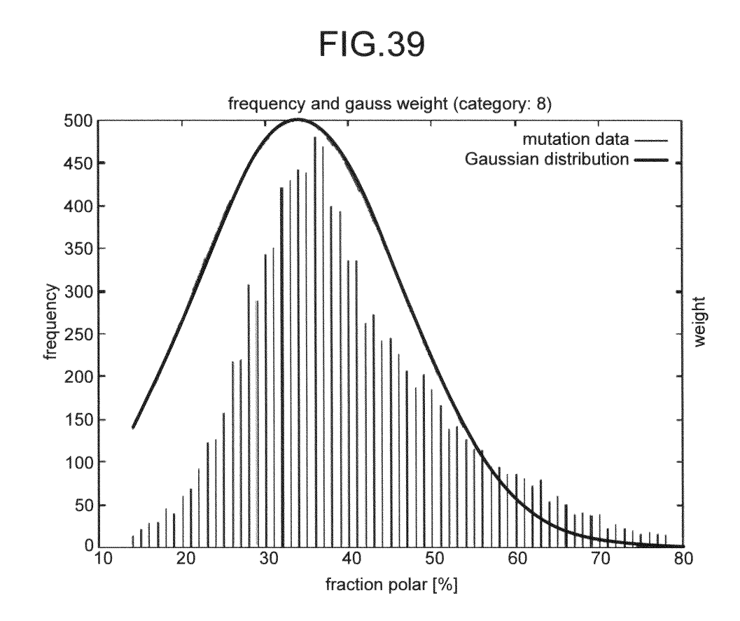

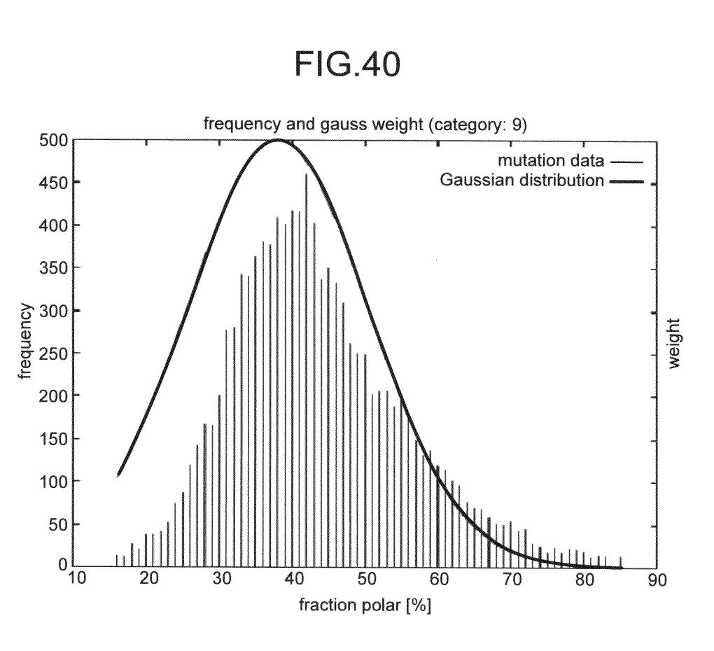

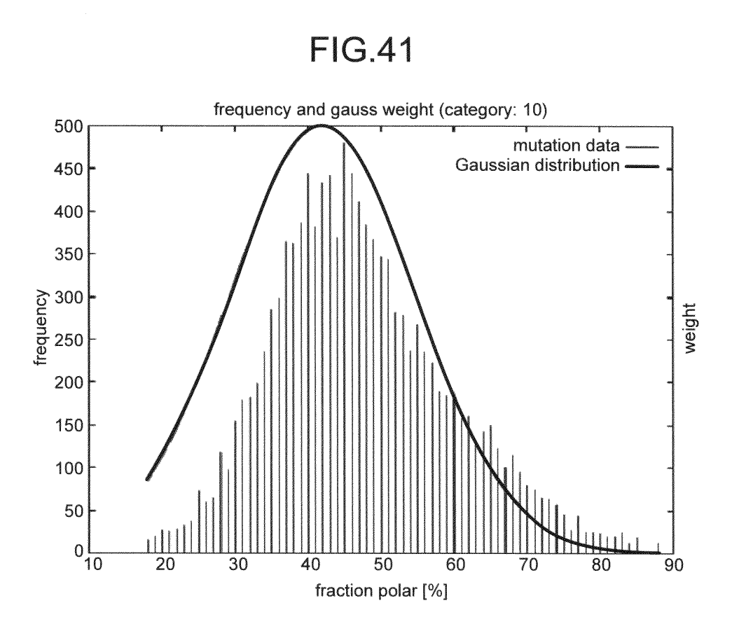

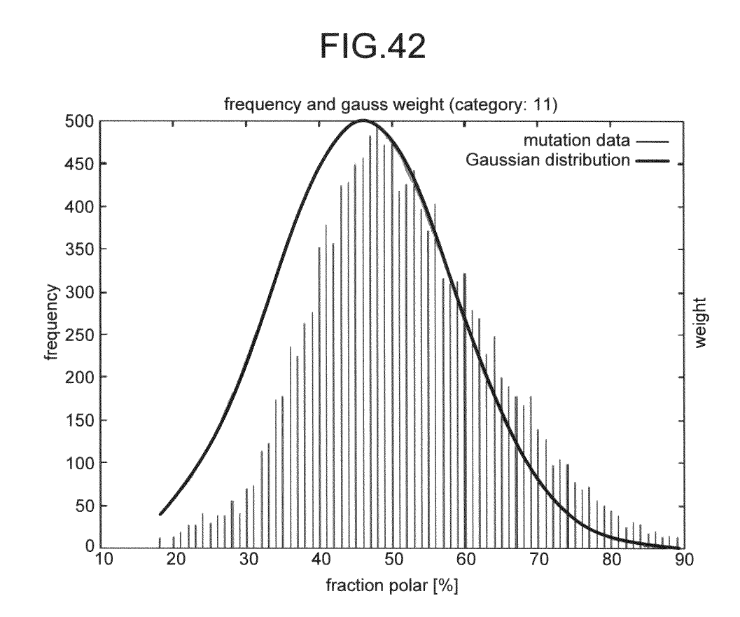

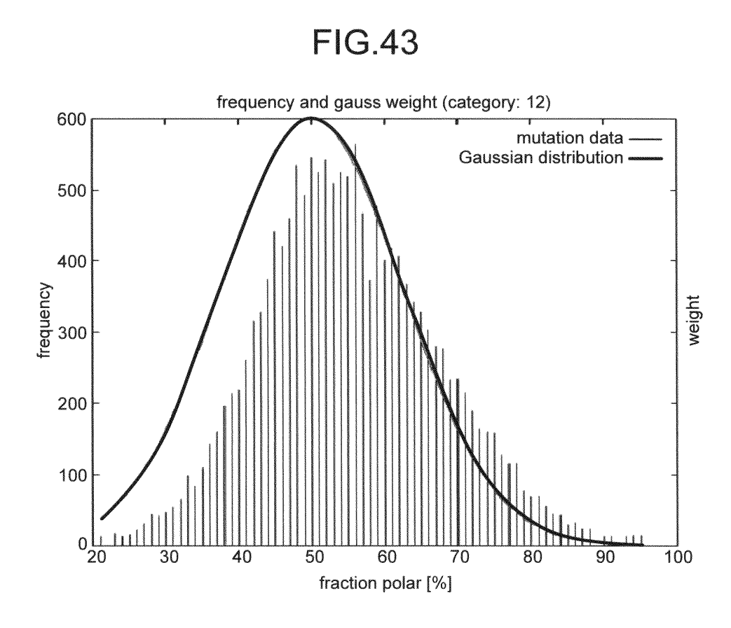

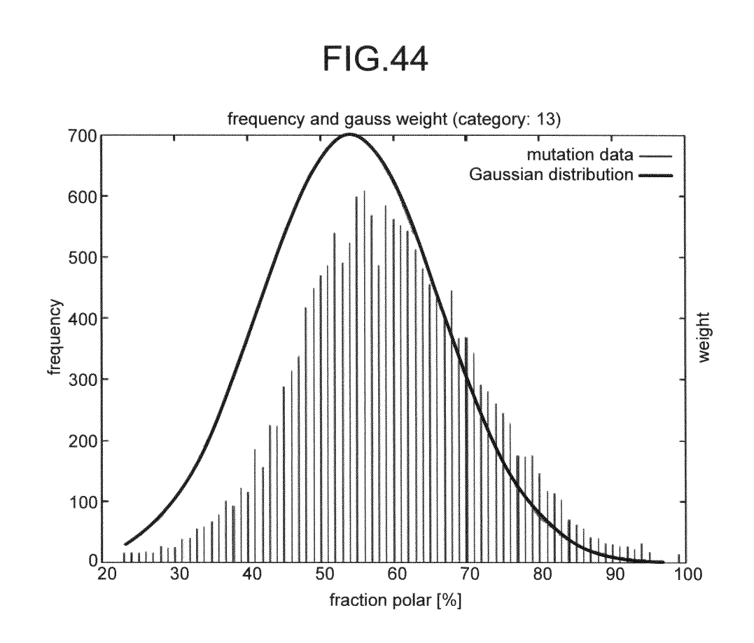

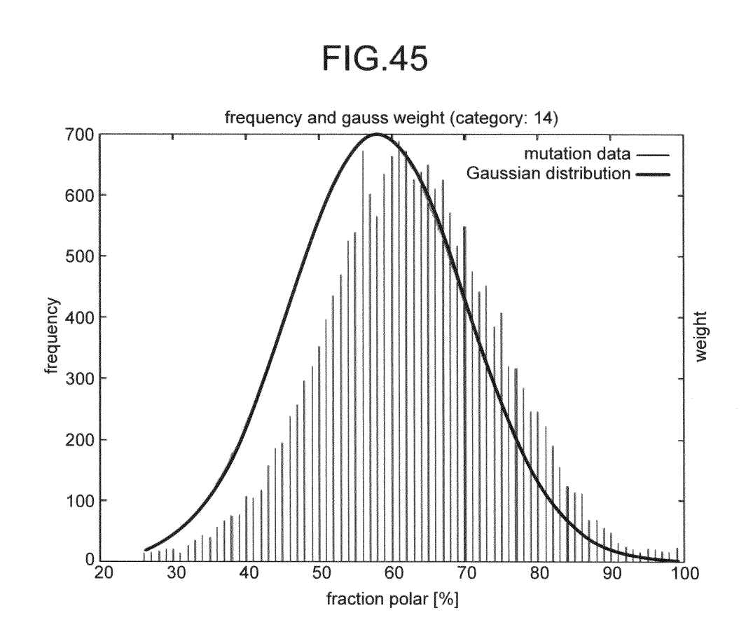

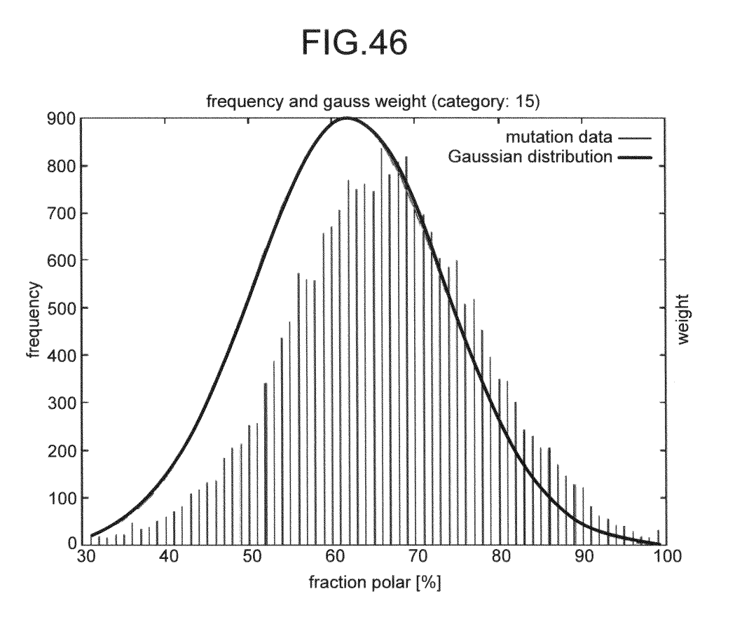

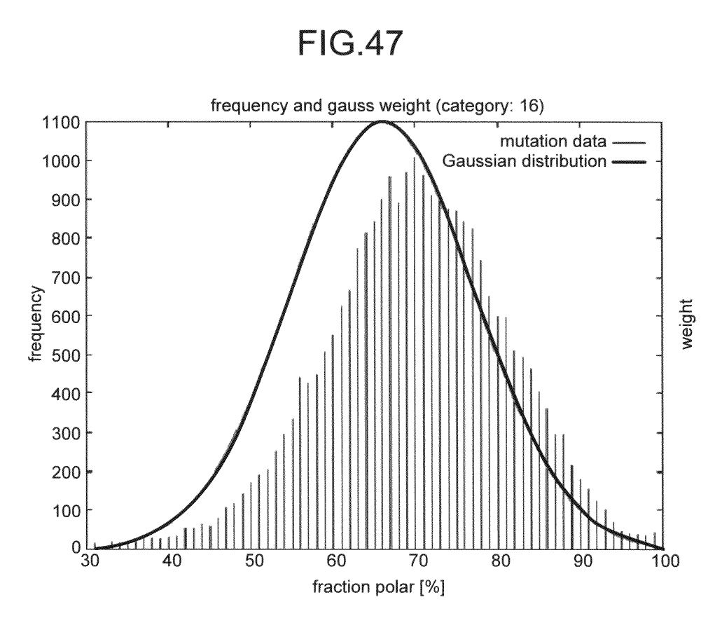

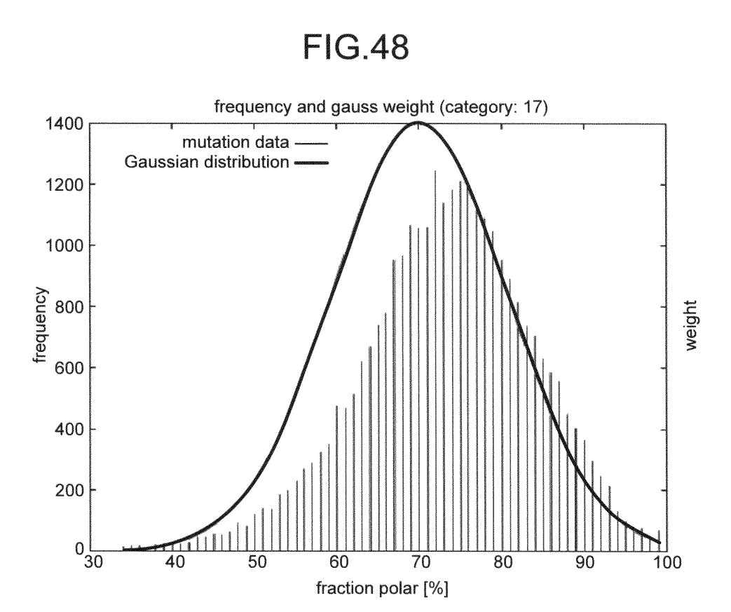

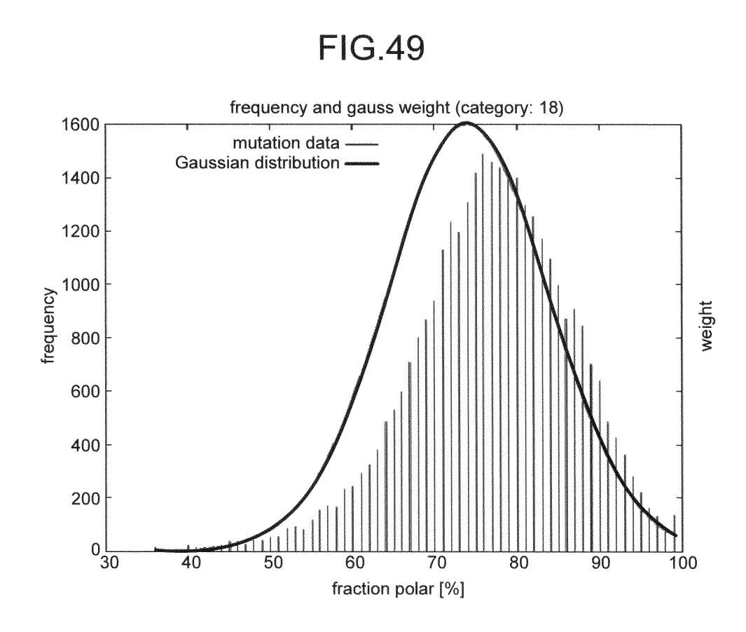

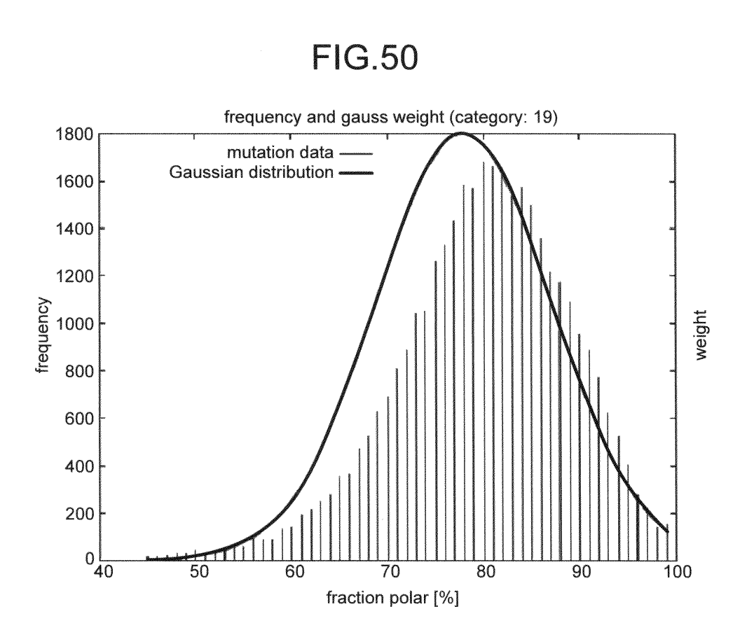

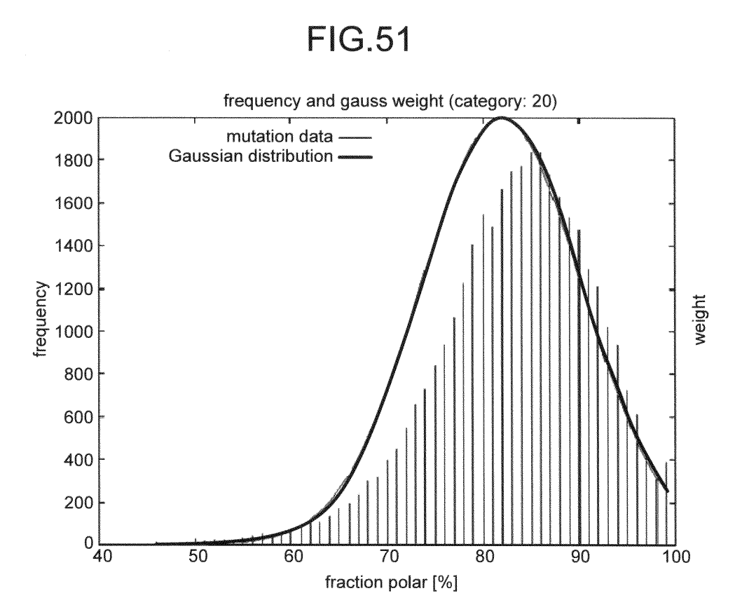

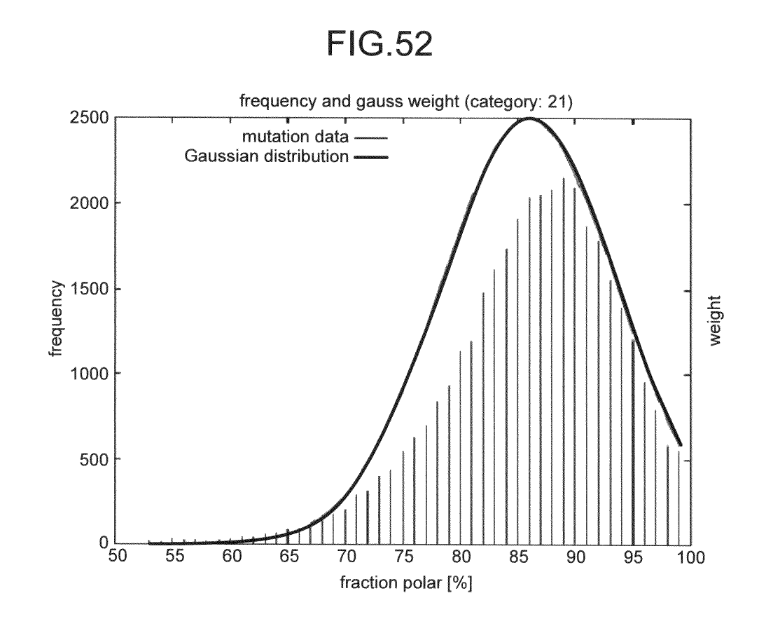

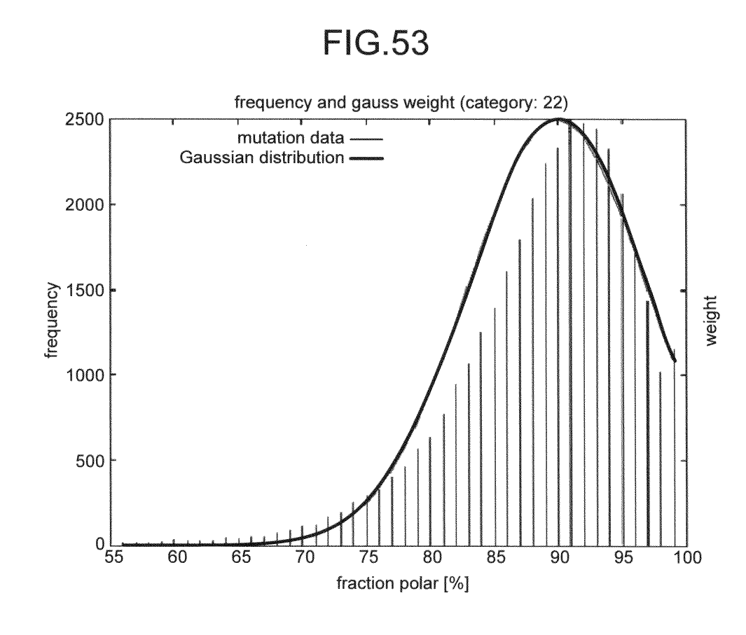

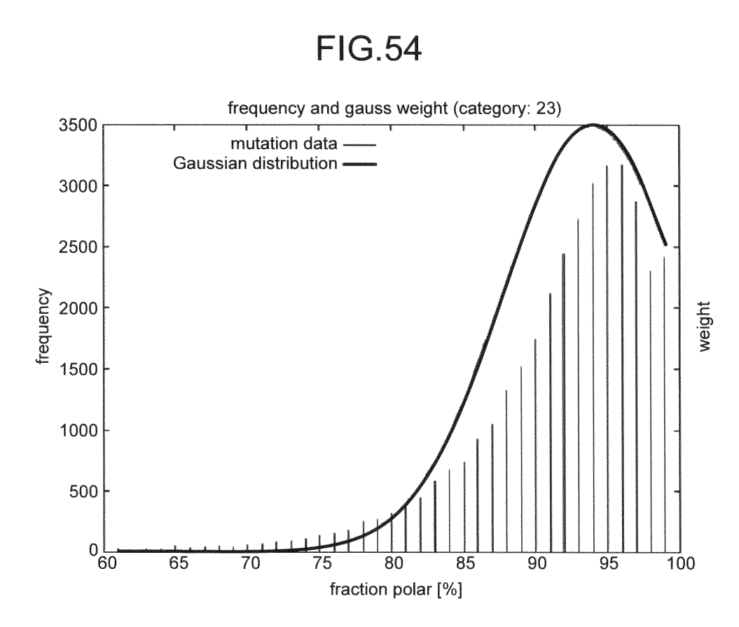

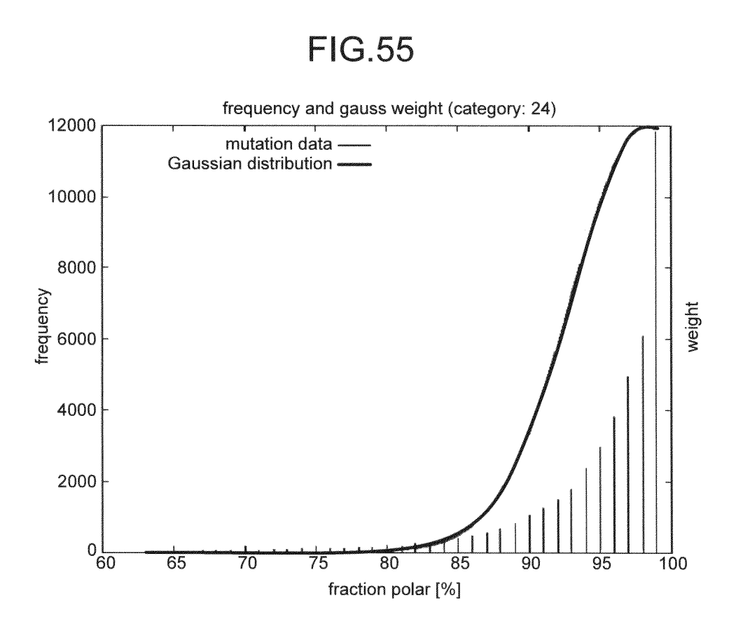

The following describes in detail one example of the processing in the system carried out in embodiment of the invention with reference to FIG. 4-63.

The environment in which the amino acid residue i is present is defined by 3 parameters, that is, the fraction of area occupied by polar atoms (fraction polar) that is the ratio of polar atoms occupying the surface of the amino acid residues, the fraction of buried area of the surface of the amino acid residues (fraction buried), and the secondary structure information (ss) formed by the amino acid residue i. Without paying attention to only the amino acid residue in question, a secondary structure formed by an amino acid residue just before or after the amino acid residue may also be taken into consideration as the secondary structure information. The fraction polar and fraction buried were considered in 100 divisions every 1%.

A PDB file on experimentally analyzed 3-dimensional structures of protein was used as file of 3-dimensional structure information of protein 106a.

In the apparatus for processing 3-dimensional structure of protein 100, a part of amino acid residues in 3-dimensional structure information of protein in the file of 3-dimensional structure information of protein 106a were substituted for the other amino acid residues by processing with the mutated 3-dimensional structure-prediction unit 102a, and the structure was optimized with homology modeling software, FAMS, developed by the present inventors.

Originally, data should be collected by experimentally mutating an amino acid sequence and examining its 3-dimensional structure. However, hundreds of thousand of mutation data are necessary to statistically calculate the value corresponding to free energy. Not all of these data can be experimentally obtained. Accordingly, FAMS (Ogata, K. and Umeyama, H. (2000). An automatic homology modeling method consisting of database searches and simulated annealing. J. Mol. Graphics Modeling 18, 258-272) which has been reliably used in construction of side chain etc. was used to rapidly predict mutation data.

Specifically, 997 amino acid sequences having 150 or less amino acid residues at a resolution of 2.0 or less (value for PDB to be excellent in coordinate accuracy), out of PDB from which amino acid sequences having 50% or more homology to one another had been removed, were subjected 100 times to random 1-residue mutation calculation. However, due to the highly speed calculation, when mutated sites are apart by 15 angstroms or more in 3-dimensional structure information of one protein (PDB), mutations in a plurality of sites are simultaneously conducted in once calculation. As a result, mutations at 504,716 sites were conducted to construct 3-dimensional structures using the homology modeling method by FAMS.

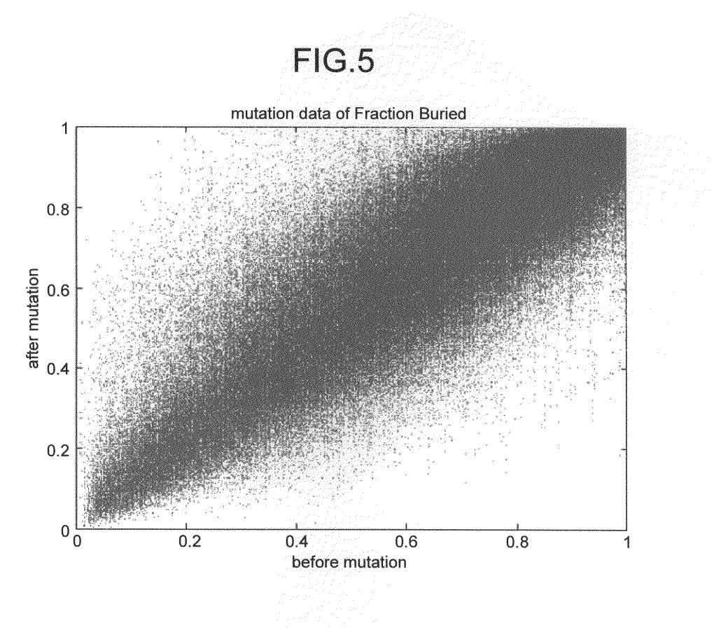

Then, from the calculated 3-dimensional structure information, how the two environments (the fraction of buried area (fraction buried) and the fraction of area occupied by polar atoms (fraction polar)) were changed before and after the mutation respectively was examined by processing with the environmental change information-collecting unit 102b. As a result, it was found that there were distributions in FIGS. 4 and 5.

FIG. 4 is a scatter plot of change of the fraction of buried area (fraction buried) after mutation in amino acid residue. In FIG. 4, the environment before the mutation is shown on the horizontal axis and the environment after the mutation on the vertical axis.

FIG. 5 is a scatter plot of change of the fraction of area occupied by polar atoms (fraction polar) after mutation in amino acid residue. In FIG. 5, the environment before the mutation is shown on the horizontal axis and the environment after the mutation on the vertical axis.

As to this data, the fraction of buried area (fraction buried) was divided into 25 sections by processing with the standard deviation-calculating unit 102c, and the standard deviation of frequency of appearance in each section of fraction buried (%) was calculated.

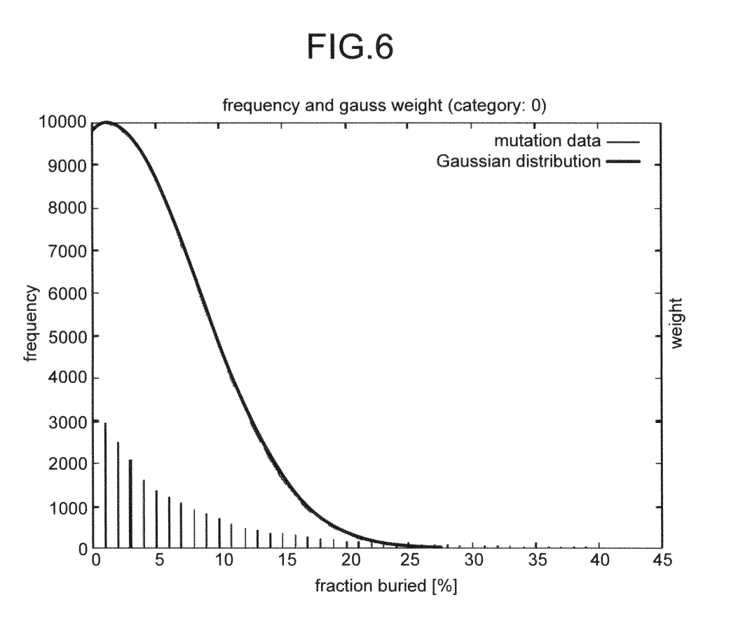

FIGS. 6-30 show frequency distribution maps (frequency) with red line in each fraction of buried area (fraction buried) after the mutation and Gaussian distribution maps with green line obtained from calculated standard deviation in each fraction buried of amino acid residue divided into 25. Because the fraction buried was divided into 25 sections, the Gaussian distribution consists of 25 graphs from category 0 to category 24 (corresponding to FIG. 6 to FIG. 30 respectively). The fraction buried (%) is shown on the horizontal axis and the frequency on the vertical axis.

For example, the graph (FIG. 6) for category: 0 indicates the distribution showing how the fraction of buried area (fraction buried) on amino acid side chain in 0 to 4% section before mutating in amino acid residue were changed after mutating in amino acid residue. The standard deviation was determined for each the 25-divided section, and the Gaussian distribution was plotted with green lines such that the extremal value becomes a mean value of fraction buried before the mutation. It can be seen that the Gaussian distribution well indicates the distribution of actual mutation data.

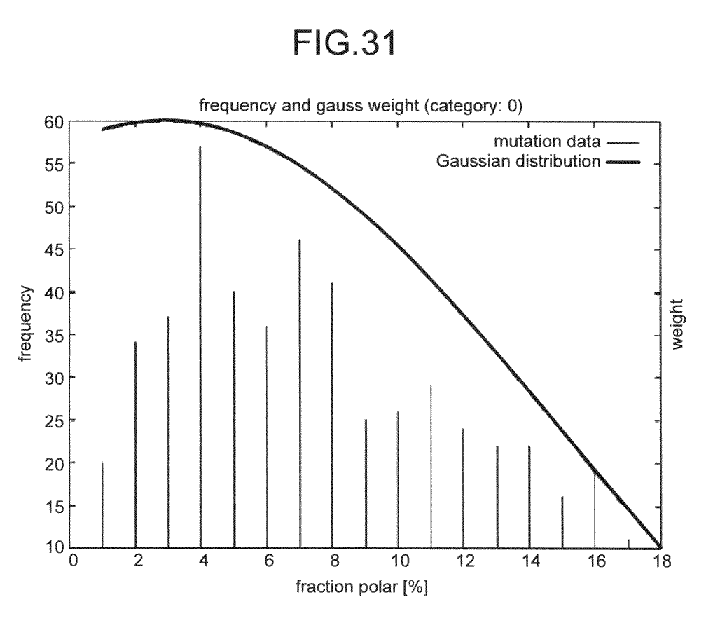

Similarly to plotting of the fraction of buried area (fraction buried), the fraction of area occupied by polar atoms (fraction polar) was also plotted. The frequency of appearance in each section of fraction polar (%) was plotted as mutation data in a histogram with red lines in each of FIGS. 31 to 55.

FIGS. 31-55 show frequency distribution maps (frequency) with red line in each fraction of area occupied by polar atoms (fraction polar) after the mutation and Gaussian distribution maps with green line obtained from calculated standard deviation in each fraction polar of amino acid residue divided into 25. Because the fraction polar was divided into 25 sections, the Gaussian distribution consists of 25 graphs from category 0 to category 24 (corresponding to FIG. 31 to FIG. 55 respectively). The fraction polar (%) is shown on the horizontal axis and the frequency on the vertical axis. The standard deviation was determined for each the 25-divided section, and the Gaussian distribution was plotted with green lines such that the extremal value becomes a mean value of fraction polar before the mutation. It can be said that similarly to the graph of fraction of buried area (fraction buried), the Gaussian distribution can indicate the frequency of appearance of fraction polar.

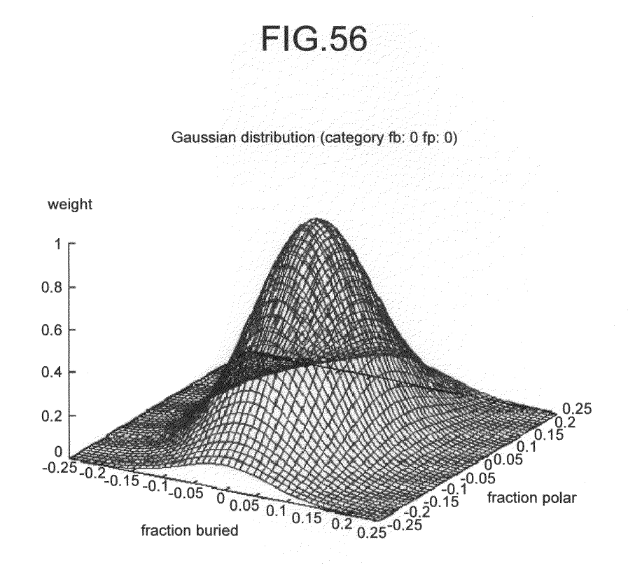

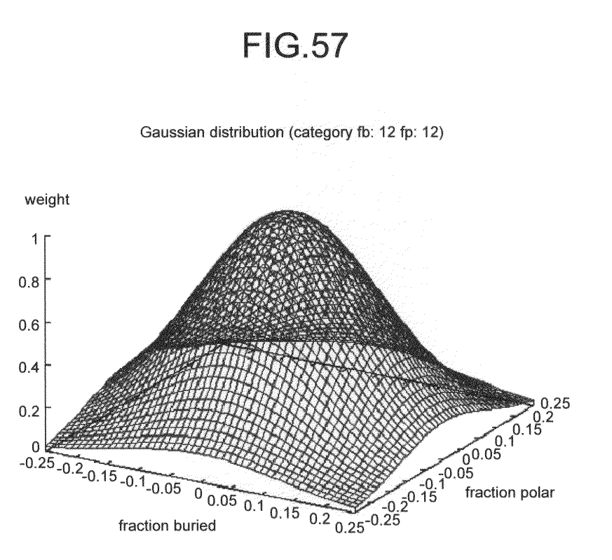

Then, the weighing indicated in Eq. (3) is graphed by processing with the score matrix-calculating unit 102d and shown in FIGS. 56 and 57. FIG. 56 is a view showing Gaussian distribution in the environment with 0 to 4% fraction of buried area (fraction buried) and 0 to 4% fraction of area occupied by polar atoms (fraction polar). That is, the Figure shows the weighed graph (category fb:0 fp:0) of Eq. (3) used in calculating P(i|j) corresponding to a shift in fraction polar and fraction buried in the environment with 0 to 4% fraction buried and 0 to 4% fraction polar. In FIG. 56, the fraction buried is shown on the X-axis, the fraction polar on the Y-axis, and the weight on the Z-axis.

FIG. 57 is a view showing Gaussian distribution in the environment with 4.8 to 5.2% fraction of buried area (fraction buried) and 4.8 to 5.2% fraction of area occupied by polar atoms (fraction polar). That is, the Figure shows the weighed graph (category fb:12 fp:12) of Eq. (3) used in calculating P(i|j) corresponding to a shift in fraction polar and fraction buried in the environment with 48 to 52% fraction buried and 48 to 52% fraction polar. The fraction buried is shown on the X-axis, the fraction polar on the Y-axis, and the weight on the Z-axis.

Then, by processing with the score matrix-calculating unit 102d, the standard deviation obtained in each section was used to calculate Eqs. (3) to (5). As a result, the score matrix of amino acid residue i for the environment (secondary structure information (ss), fraction of area occupied by polar atoms (fraction polar) and fraction of buried area (fraction buried)) was calculated.

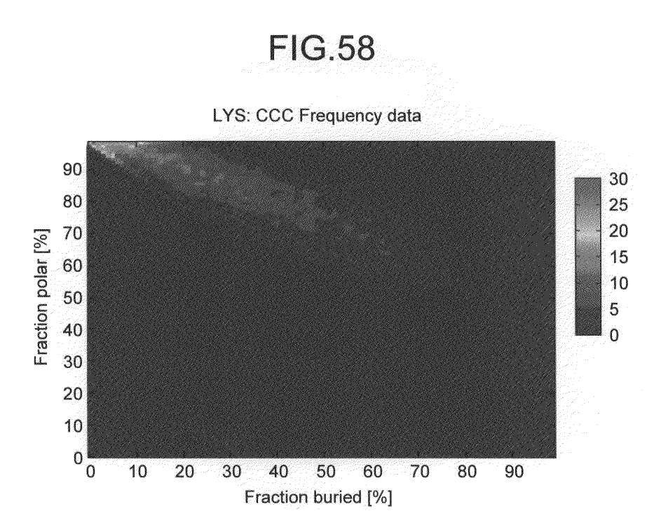

For example, FIG. 58 is a chart showing frequency (N(i|j) in Eq. (2)) distribution obtained from 3-dimensional structure information of protein analyzed by experiments on hydrophilic amino acid residue Lysine (LYS) whose secondary structure is 3 consecutive coils as CCC. That is, the frequency distribution (frequency data) calculated from a set of experimental structures where secondary structure of a hydrophilic amino acid residue Lysine is CCC (3 consecutive coils) is shown. The fraction of buried area (fraction buried) (%) is shown on the horizontal axis and the fraction of area occupied by polar atoms (fraction polar) (%) on the vertical axis.

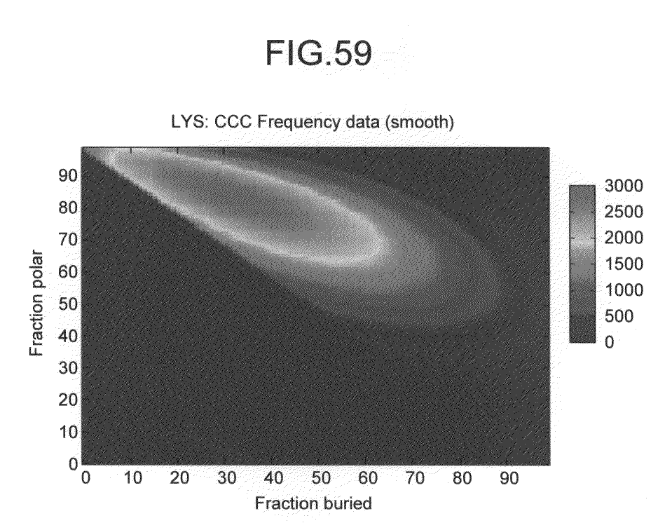

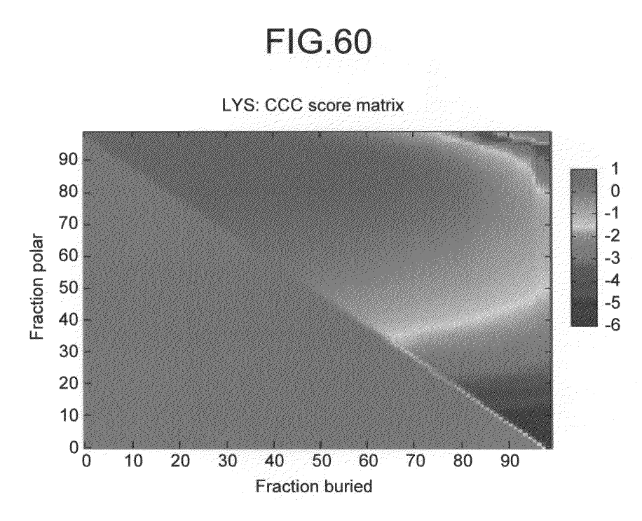

After weighing with the function in Eq. (3) by processing with the score matrix-calculating unit 102d, the corrected data by the weight are shown in FIG. 59. That is, a distribution chart (frequency data) where the frequency distribution in experimental structures where secondary structure of a hydrophilic amino acid residue Lysine is CCC (3 consecutive coils) has been smoothed by Eq. (3) is shown. The fraction of buried are (fraction buried) (%) is shown on the horizontal axis and the fraction of area occupied by polar atoms (fraction polar) (%) on the vertical axis.[0101] The score matrix calculated in Eq. (5) by processing with the score matrix-calculating unit 102d is shown in FIG. 60. FIG. 60 is a chart showing score distribution of Eq. (5) where secondary structure of a hydrophilic amino acid residue Lysine is CCC (3 consecutive coils). The fraction of buried area (fraction buried) (%) is shown on the horizontal axis and the fraction of area occupied by polar atoms (fraction polar) (%) on the vertical axis. Thus, it can be seen that experimental data on a hydrophilic residue Lysine are concentrated in the upper left of the graph. It can also be seen from FIG. 60 showing score distribution that the score of Lysine (LYS) is higher in the environment in the upper left of the graph. From this result, it can be seen that Lysine (LYS) exists more readily in the environment where the fraction buried (fraction of buried area) is low and the fraction polar (fraction of area occupied by polar atoms) is high.

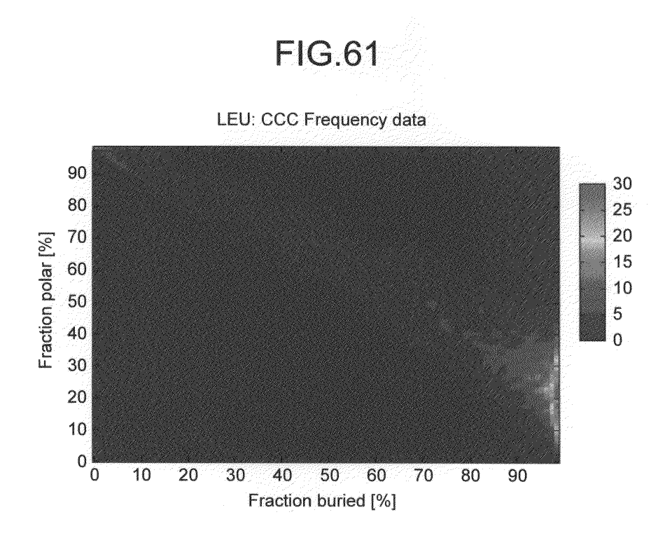

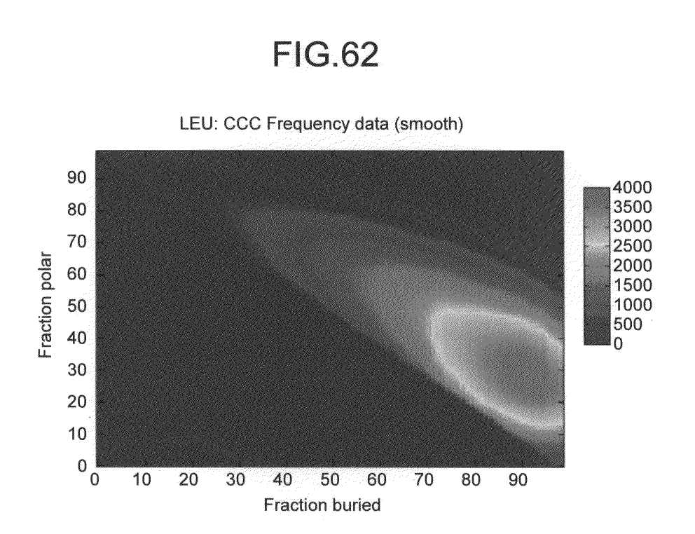

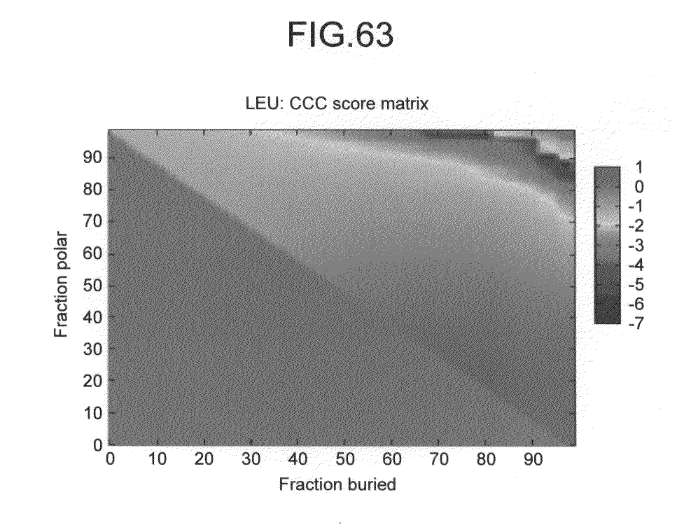

It can also be seen that an amino acid residue Leucine (LEU) that is hydrophobic opposite to Lysine tends to exist easily in the lower right environment of the graph, as shown in FIGS. 61, 62 and 63. FIG. 61 is a chart showing frequency distribution (frequency data) calculated from a set of experimental structures where secondary structure of a hydrophilic amino acid residue Leucine (LEU) is CCC (3 consecutive coils). FIG. 62 is a chart showing distribution (frequency data) where the frequency distribution in an experimental structure where secondary structure of a hydrophilic amino acid Leucine is CCC (3 consecutive coils) has been smoothed by Eq. (3). FIG. 63 is a chart showing score distribution of Eq. (5) where secondary structure of a hydrophilic amino acid residue Leucine is CCC (3 consecutive coils). The fraction of buried area (fraction buried) (%) is shown on the horizontal axis and the fraction of area occupied by polar atoms (fraction polar) (%) on the vertical axis.

By processing with the score matrix-calculating unit 102d, the results of the score matrix are output to a file.

By processing with the accuracy-evaluating unit 102e, the score matrix calculated with the score matrix-calculating unit 102d, and the file of 3-dimensional structure information of protein 106a such as 3-dimensional structure information file (PDB), as input file, are used to evaluate the accuracy of the 3-dimensional structure of protein by Eq. (6) below. It is meant that as the resulting score increases, the 3-dimensional structure of protein reflects statistically the experimental structure. According to the present invention, the score of each amino acid residue in the 3-dimensional structure of protein is also simultaneously output.

$$\begin{matrix}[ Eq . 9 ] & \\ TOTALSCORE = {\sum }_{n = 0}^{L} SCORE ( {AA}_{n} \vert {ss}_{n} , {polar}_{n} , {buried}_{n} ) & ( 6 )\end{matrix}$$

### Example 1

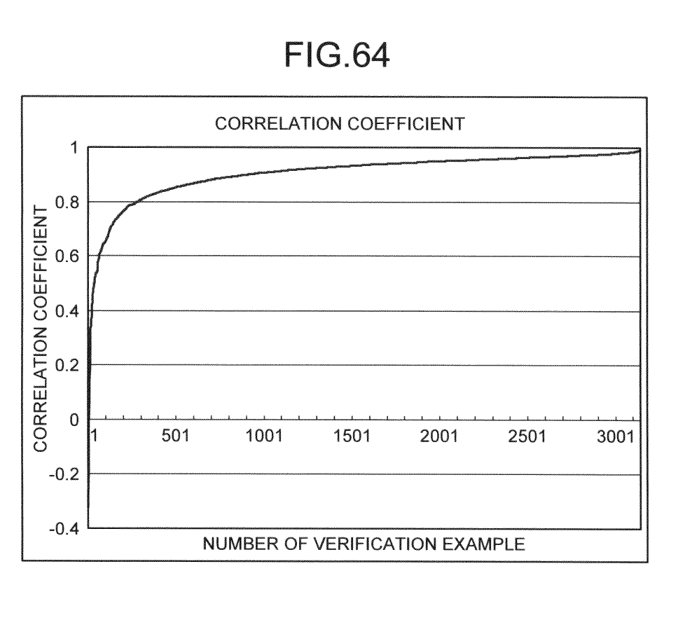

By molecular dynamics (MD) calculation, the experimental 3-dimensional structure of protein was intentionally destroyed to calculate the score in Eq. (6). The distribution of the correlation coefficient between GDT_TS score showing the accuracy of the structure by comparison with the experimental structure and Eq. (6) is shown in FIG. 64. A higher GDT_TS score is indicative of higher similarity to the experimental structure and the GDT_TS score is used as an indicator of the accuracy of structures in an international contest of 3-dimensional structure prediction of protein CASP (Critical Assessment of Techniques for Protein Structure Prediction: http://predictioncenter.gc.ucdavis.edu/).

To obtain the correlation coefficient, 50 destroyed structures were generated every PDB by MD. This verification was conducted by using structures of 3140 PDB. In FIG. 64, examples of individual verification were shown on the horizontal axis, and their correlation coefficients were plotted on the vertical axis. In examples of 2859 verification, the correlation coefficients were equal to or higher than 0.8. This means that when predicted 3-dimensional structures of protein to be unknown experimental structures are evaluated by numerical values of Eq. (6), the structures can be predicted with accuracy in many cases.

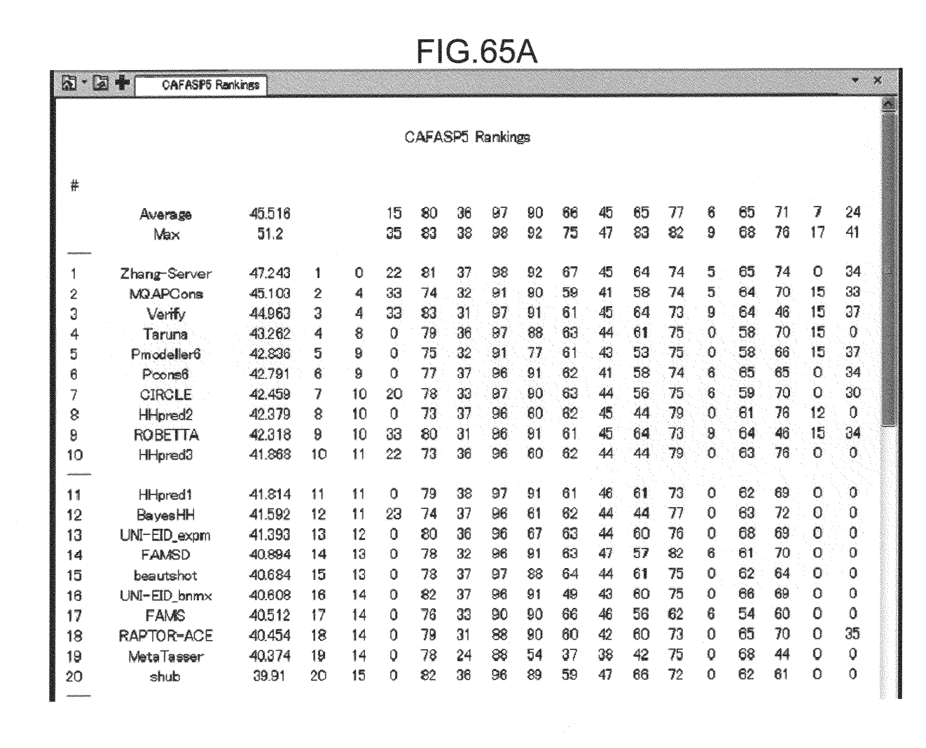

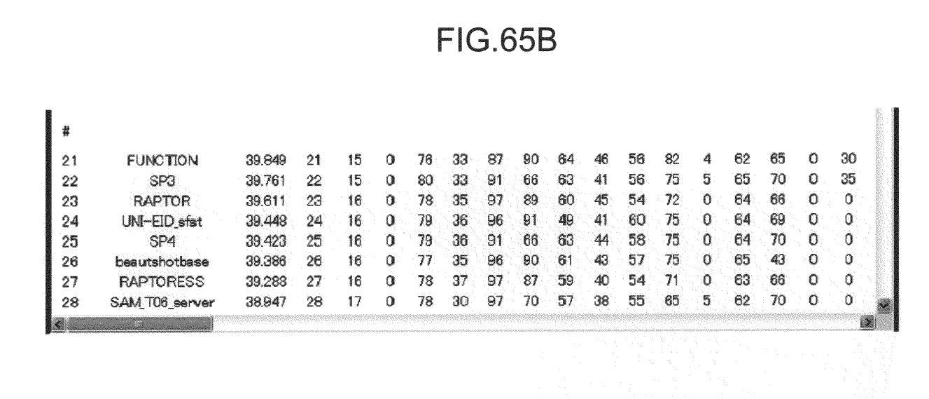

In FIGS. 65 to 72 is shown the effect of the present invention in the contest of 3-dimensional structure prediction of protein, CASP7 (Critical Assessment of Techniques for Protein Structure Prediction, http://predictioncenter.org/casp7/). The CASP is a contest of competition for accuracy of a 3-dimensional structure, predicted from its amino acid sequence, of an unknown 3-dimensional structure of protein.

In CASP7, those methods which we carried out, utilizing the present invention, are as follows:

(1) For amino acid sequences on the target on release, alignments were obtained from a plurality of alignment programs (BLAST, PSI-BLAST, PRS-BLAST, HMMER etc.). Information on alignments and predicted structures was obtained from alignment servers and modeling servers (ROBETTA, SP3, SPARKS2 and GenTHREADER) opened to the public.

(2) Homology modeling software FAMS (Ogata, K. and Umeyama, H. (2000). An automatic homology modeling method consisting of data base searches and simulated annealing. J. Mol. Graphics Modeling 18, 258-272) was used to construct predicted 3-dimensional structures of protein from the alignments obtained in (1). The predicted structures in other servers obtained in (1) were optimized with the homology modeling software FAMS.

(3) A large number of predicted structures calculated in (2) were evaluated in Eq. (7) below.

$$\begin{matrix}[ Eq . 10 ] & \\ TotalScore = \{ \begin{matrix}0.35 \times SSscore + 3 D 1 {Dscore}_{CM} & CM \\ 0.75 \times SSscore + 3 D 1 {Dscore}_{FRNF} & FR or NF\end{matrix} & ( 7 )\end{matrix}$$

Depending on the difficulty level of targets on release, 2 types of score functions were used. CM refers to targets with such a difficulty level that alignments significantly showing homology can be obtained with alignment program PSI-BLAST. It is in the CM category that the technique of homology modeling can be effectively used. FR or NF refers to targets that are more difficult than in CM. SSscore makes score of degree of coincidence between secondary structures predicted with program of secondary structure prediction PSIPRED and secondary structures of predicted 3-dimensional structures. 3D1Dscore CM is a score shown in Eq. (6). 3D1Dscore FRNF means a score calculated by Eqs. (4) and (6) using average values of (polar and average values of . . . σ_{buried} in Eq. (3).

(4) From the results of evaluation of predicted structures in (3), 5 structures out of those having the highest score in Eq. (7) were submitted to the bureau of CASP7. The server name is CIRCLE.

These results are those where models submitted to CASP 7 as predicted structures by about 60 prediction servers (all procedures are executed automatically with a computer program) participating in CASP 7 were evaluated separately by various groups. Although not officially announced by the CASP organizer, the ranking of the prediction server teams can be known.

The results of MAXSUB assessment in which the full-length of target structures were evaluated by an evaluation of method MAXSUB are shown in FIG. 65. The average of all targets in this result was 45.516, and the perfect score was 51.2. On the vertical axis, those participating in CAFASP5 (servers participating in CASP7) are listed in order of decreasing the score. The results of each target are listed on the horizontal axis. (http://fischerlab.cse.buffalo.edu/˜mtgattie/CASPResults/CA SPSummaryTable.php?sort=Rank&reverse=0)

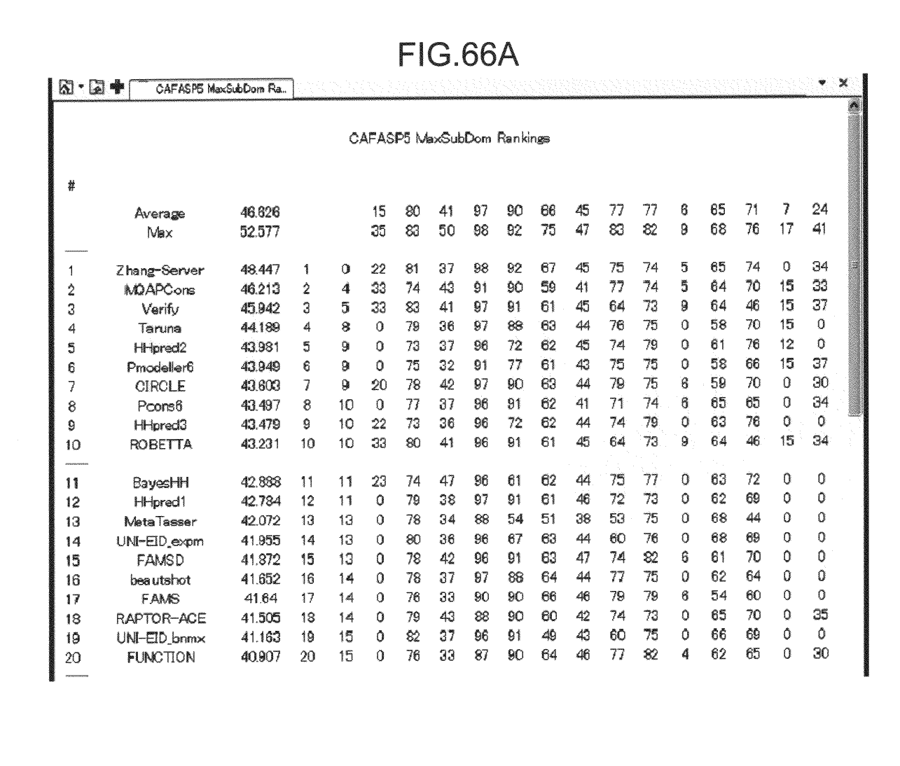

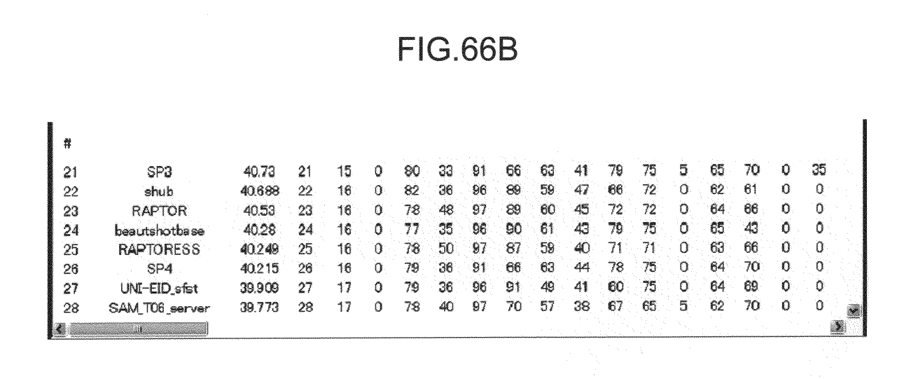

The results of evaluation in which each domain structure of a 3-dimensional structure of protein was evaluated by MAXSUB_DOM is shown in FIG. 66. The average of all targets in this result was 46.626, and the perfect score was 52.577. On the vertical axis, those participating in CAFASP5 are listed in order of decreasing the score. The results of each target are listed on the horizontal axis. (http://fischerlab.cse.buffalo.edu/˜mtgattie/CASPResults/MultipleDomainTable.php?sort=Rank&reverse=0)

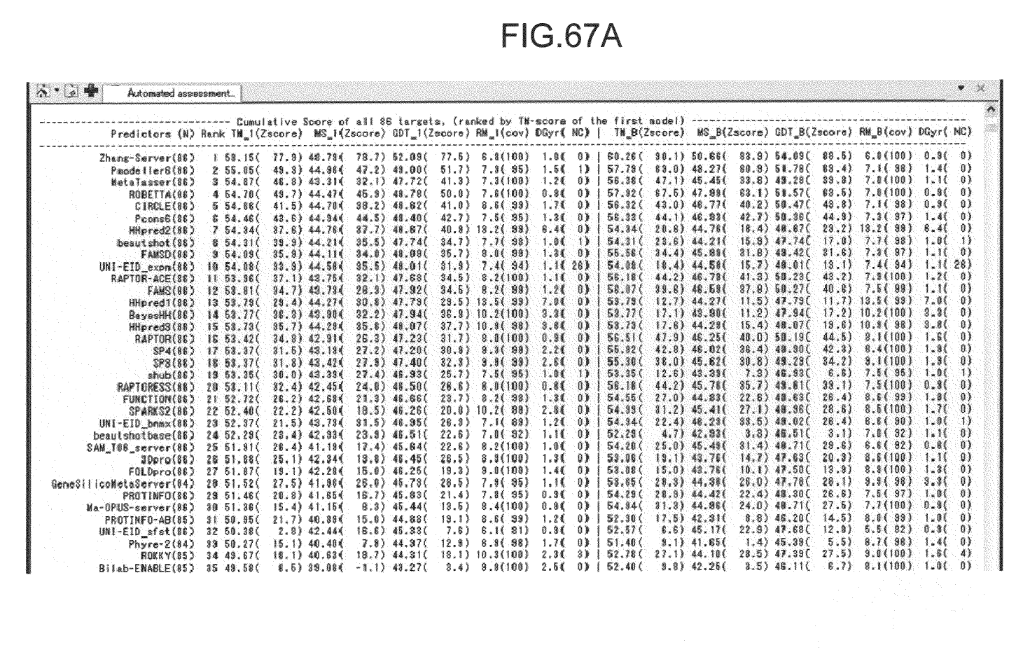

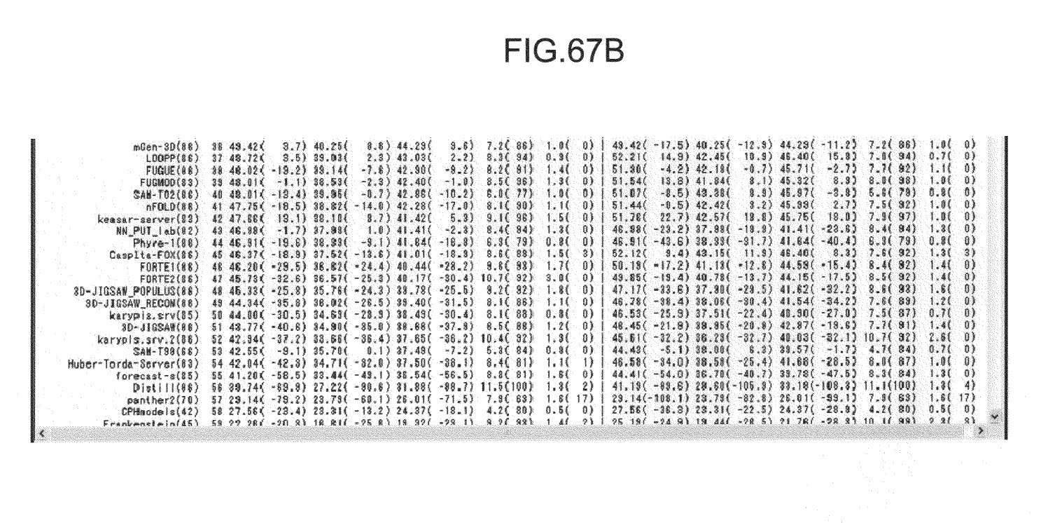

FIG. 67 shows the results of evaluation by TM-Score. (http://zhang.bioinformatics.ku.edu/casp7/). On the vertical axis, the modeling server names (Predictors) in CASP7 are listed in order of decreasing TM-score for a model submitted in the highest rank in five models. Items on the horizontal axis are as follows: N is the number of target models submitted, Rank is the ranking; and TM_1 is the TM score of the model submitted in the highest rank. TM-score<0.17 must be prediction near to random structure. TM-score=0 means a target not submitted, or the absence of overlapping between a right structure and its predicted structure.

Zscore is Z score derived from the score corresponding to each target. MS_1 is the MAXSub score of the model submitted in the highest rank. MAXSub-score is calculated based on TM-score search engine. GDT_1 is the GDT score of the model submitted in the highest rank. GDT-score is calculated based on TM-score search engine. RM_{—}1 is RMSD between the model submitted in the highest rank and the corresponding right structure. cov is the proportion (%) of amino acid residues to be modeled correctly as the prediction model is compared with the right structure. DGyr is a difference in radius of gyration between the predicted model and the right structure. That is, DGyr=|Gyr_model-Gyr_native|, where Gyr_model and Gyr_native are radius of gyrations of the predicted model and the right structure, respectively. When the radius of gyration is calculated, the same set of amino acid residues is used in the predicted model and the right structure. NC is the number of models clashed (with atoms completely clashed against one another). The clashed model was defined by a Valencia's rule (Proteins, Suppl 7:27-45, 2005). That is, the strict clashed model includes a model having 4 or more clashes (Cα-Cα distance<1.9 angstroms) or a model having 50 or more bumps (with atom bumped against one another) (Cα-Cα distance<3.6 angstroms). All of TM_B, MS_B, GDT_B, and RM_B show not only the results in the model submitted in the highest rank but also the best results in the first to fifth models submitted.

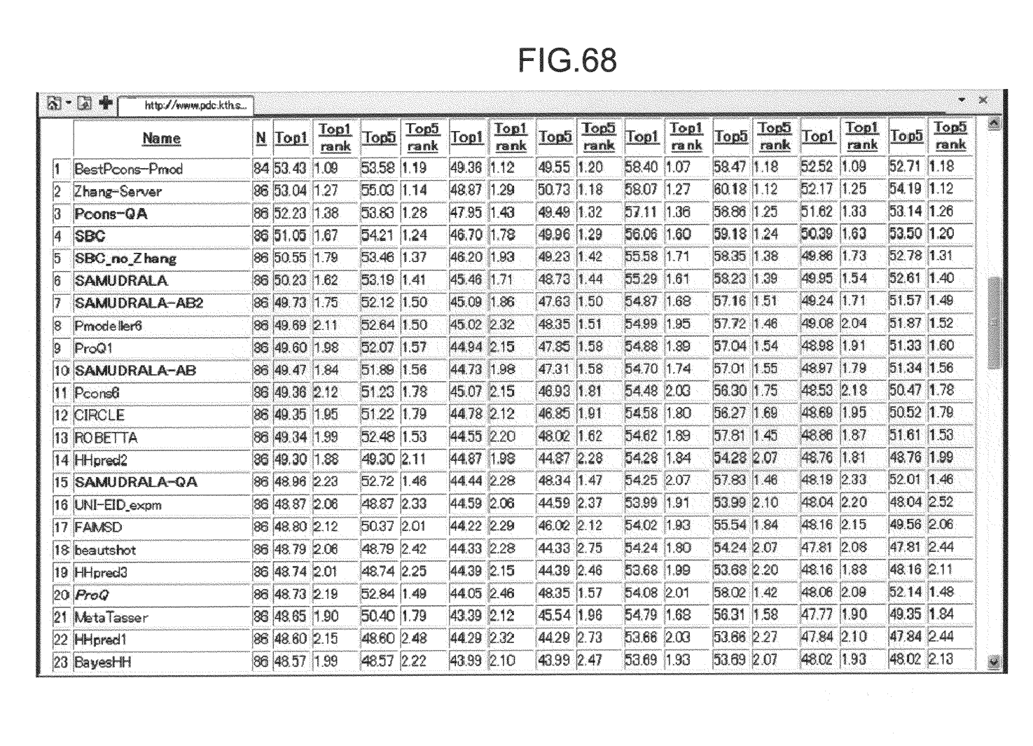

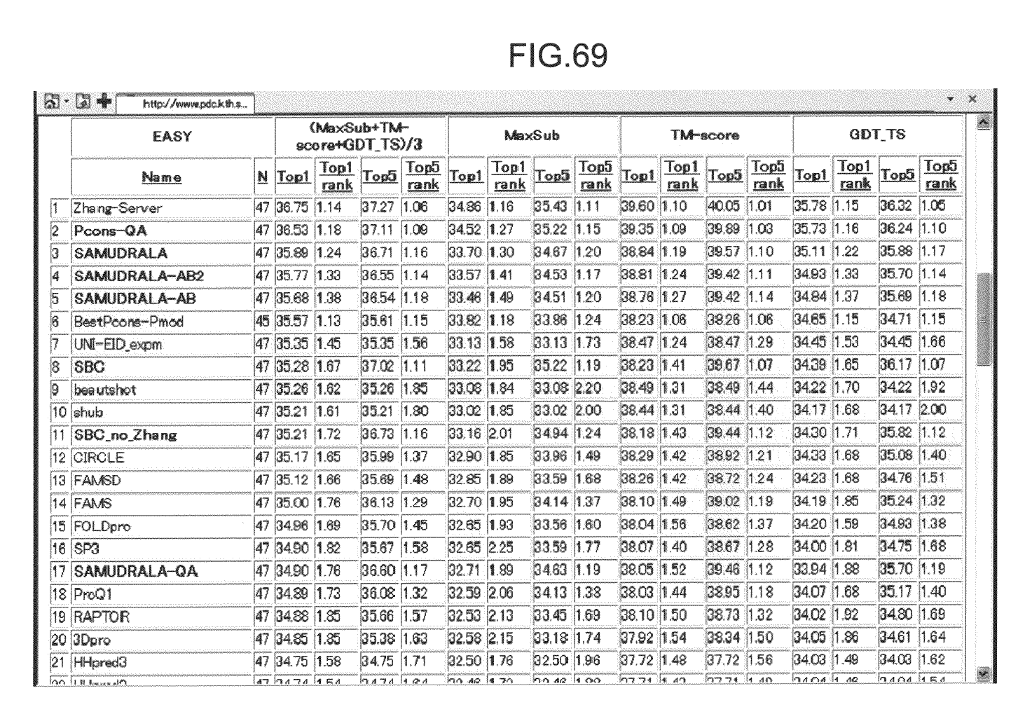

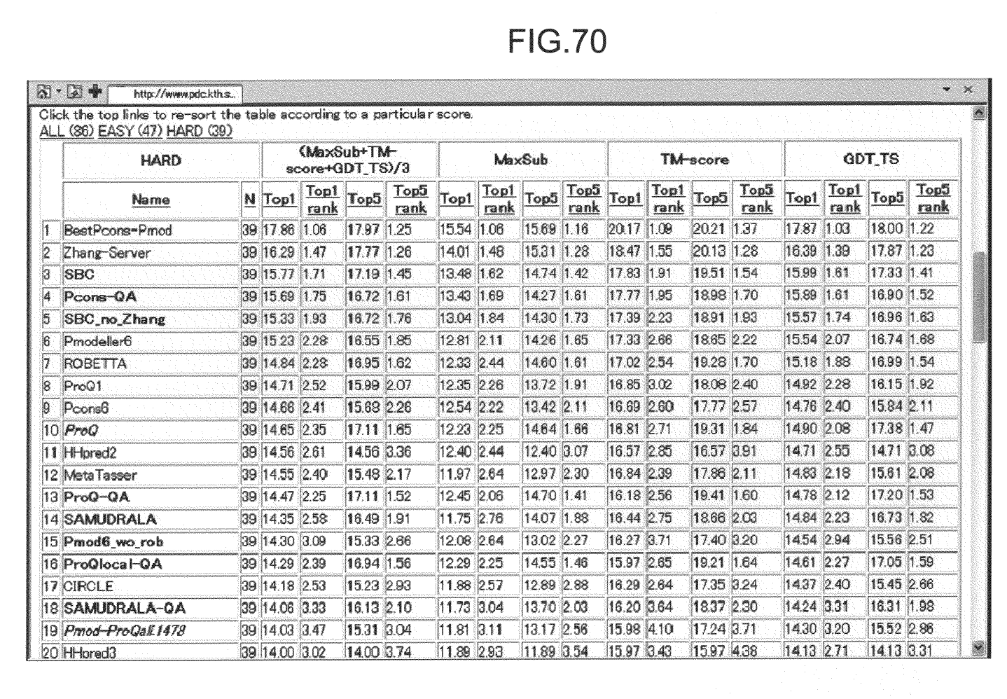

The results of all targets evaluated with the value of (MaxSub+TM-score+GDT_TS)/3 are shown in FIG. 68 (http://www.pdc.kth.se/˜bjornw/casp7/targets/results/index_all.html). In this evaluation site, the category in difficulty level of targets is divided into EASY (FIG. 69) and HARD (FIG. 70) for evaluation. In these tables, the modeling server names are shown on the vertical axis, and N (number of targets on release) and each result of 4 evaluation methods (MaxSub+TM-score+GDT_TS)/3, MaxSub, TM-score, and GDT_TS) is listed on the horizontal axis. In the evaluation methods on the horizontal axis, the following 4 results are contained: Top 1 shows the summation of scores in the model submitted in the first rank, and Top 5 shows the summation of scores in 5 models in the first to fifth ranks. Top 1 rank shows the average ranking based on the model submitted in the first rank, and Top 5 rank shows the average ranking based on 5 models in the first to fifth ranks.

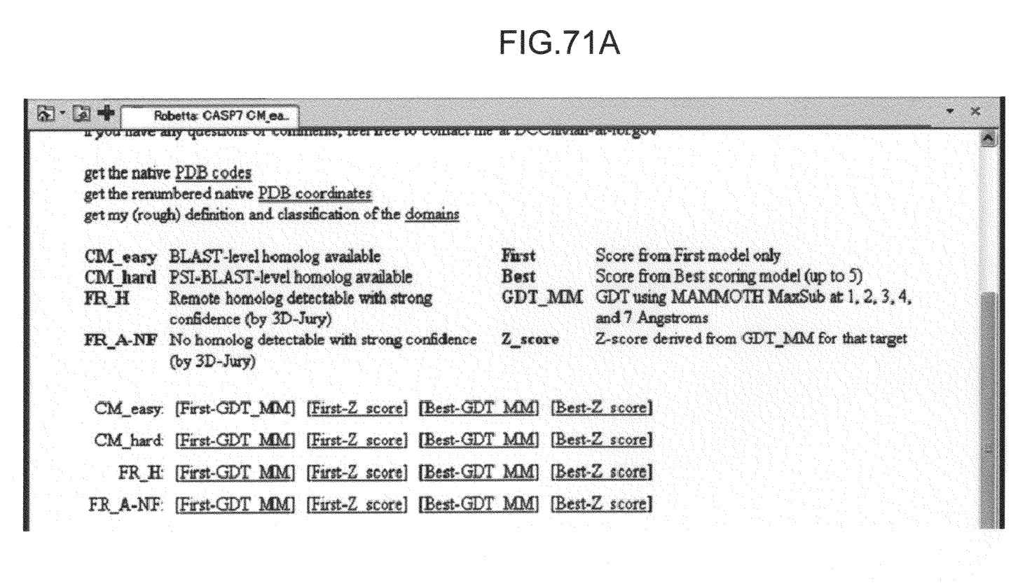

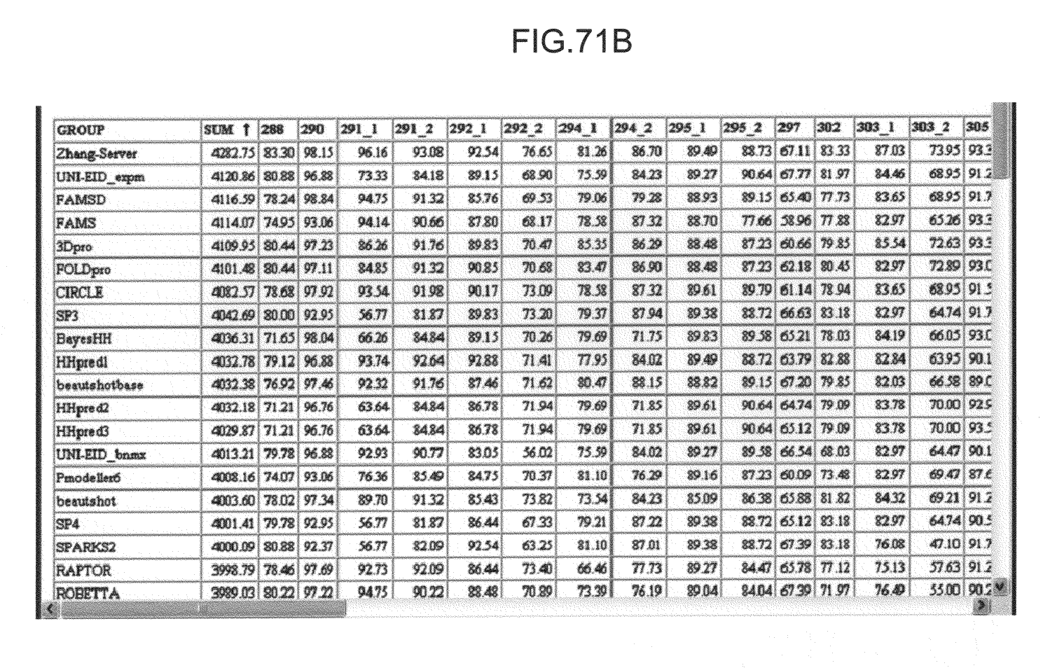

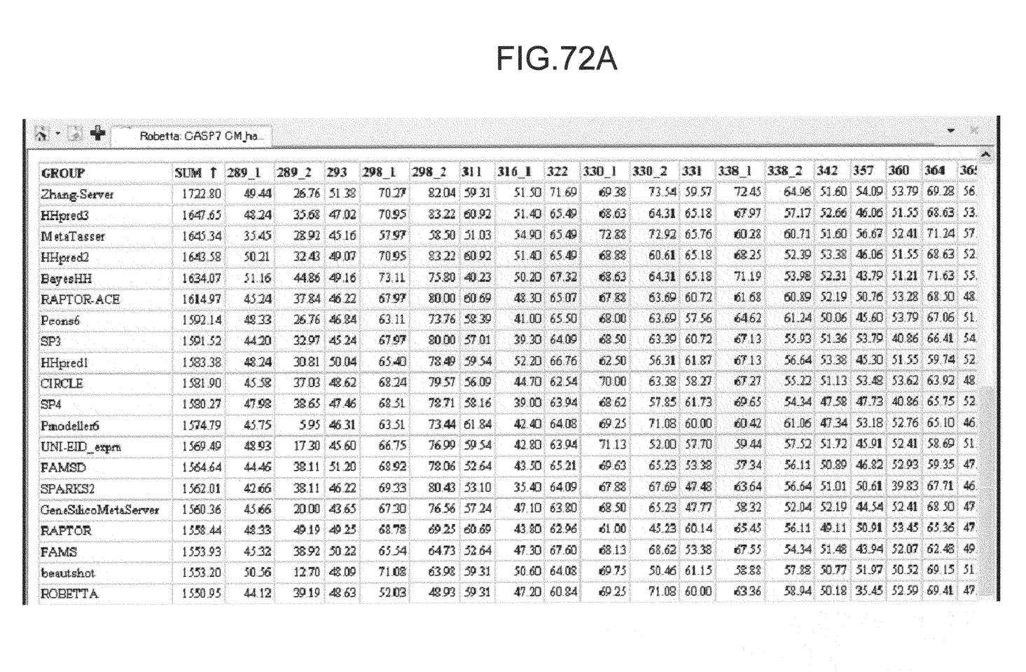

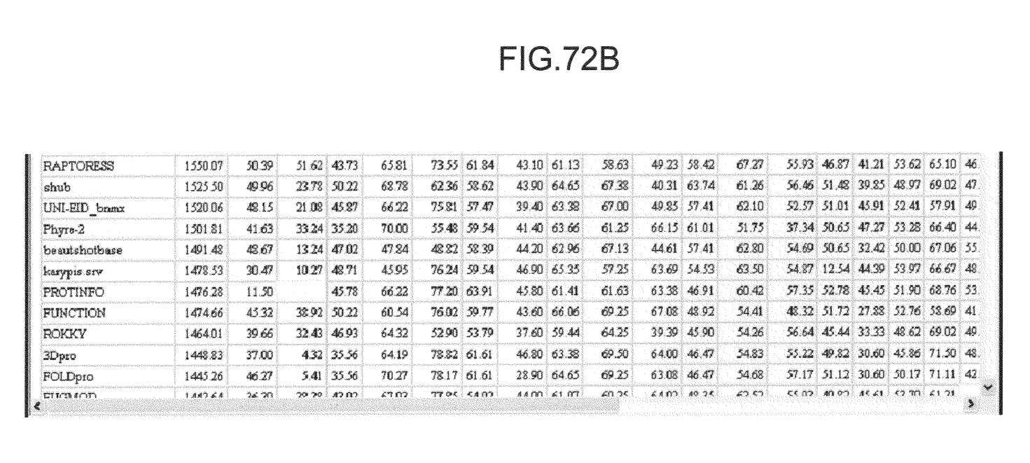

FIGS. 71 and 72 are tables showing the results of Robetta assessment (http://robetta.bakerlab.org/CASP7_eval/index.html). Evaluation is conducted with two method, the total value of GDT_MM (GDT using MAMMOTH MaxSub at 1, 2, 3, 4 and 7 angstroms) and the total value of the standardized Z-score (Z score derived from GDT_MM in each target). The results were divided into the following 4 categories: CM_easy (homology search at the BLAST level can be utilized), CM_hard (homology search at the PSI-BLAST level can be utilized), FR_H (slight homology with high reliability by 3D-Jury can be detected), and FR_A-NF (homology with high reliability by 3D-Jury cannot be detected), and these categories are in accordance with those used in previous CASP6. Division of domain is judged with human eyes, and in each domain, evaluation is conducted. By so doing, it is possible to prevent that the evaluated value significantly changes by changing configuration of domain. Accordingly, there is a possibility for more accurate evaluation to be carried out than in other evaluation sites with automatic evaluation. FIG. 71 shows the results of First-GDT_MM (only the model submitted in the first rank) of CM_easy target. The modeling server names are shown in the left, and the total score and the score for each target number are shown on the horizontal axis. FIG. 72 shows the results of First-GDT_MM of CM_hard target.

The fact that the method of the present invention is novel is evident from the lack of similar literatures, and the higher rank of our team than other teams participating in CASP7 indicates that 3-dimensional structures of protein are accurately evaluated, and our study methods and computer programs contribute significantly to evaluation of protein structures. The fact that our method of evaluating 3-dimensional structures of protein is good enables selection of best 3-dimensional structures from among those formed based on alignments obtained by various methods, to realize industrial utility with which 3-dimensional structures of protein are accurately constructed.

### Example 2

Three people of the inventors (Mayuko Takeda-Shiaka, Kazuhiko Kanou, Hideaki Umeyama) published a research paper (Nobuhiko Okada, Yorie Oi, Mayuko Takeda-Shiaka, Kazuhiko Kanou, Hideaki Umeyama, Takeshi Haneda, Tsuyoshi Miki, Sachiko Hosoya and Hirofumi Danbara, Identification of amino acid residues of Salmonella SlyA that are critical for transcriptional regulation. Microbiology (England), 2007, 153, 548-560.). The following outlines the research paper. Three people of the inventors demonstrated modeling a Salmonella SlyA dimer-DNA complex in the research paper.

It is estimated that Salmonella SlyA gene is a transcription factor essential for Salmonella to survive with resistance to chemical substances, organic solvents, oxidative stress, and virulent foreign factors. As 3-dimensional structures of this gene, a dimer of two proteins and a complex of this dimer protein bound to a DNA were constructed by homology modeling. The protein elucidated in an experiment used in homology modeling is a protein whose PDB code is 1S3J. The homology in sequence between this reference protein and the objective modeled protein was 19% estimated to be a usually difficult level. Using complex model of the dimer and the DNA, amino acid residues which were estimated to influence transcriptional functions by visual check, were substituted for Alanine residue, and as a result, experimental results in which the dimer structure and the dimer/DNA complex structure are valid were obtained.

The fact that the dimer structure is valid is shown in FIG. 5. (b) in the literature. The fact that the dimer/DNA complex structure is valid is shown in FIG. 3. (b) in the literature.

For substitution of amino acid residue determined by visually checking a 3-dimensional structure obtained by homology modeling as described above, it was attempted at previously predicting a result of substitution of amino acid residue by applying the score matrix of amino acid residue determined by Eq. (5). That is, for a specific amino acid residue, a score before substitution of amino acid residue is calculated from Eq. (5). A score after substitution of amino acid residue is calculated by changing the term indicative of the type of amino acid residue in Eq. (5). By comparing the score before substitution of amino acid residue with the resulting score after substitution of amino acid residue, whether substitution of the amino acid residue is possible to occur is predicted.

The prediction and explanation of a result after substitution of amino acid residue of Salmonella transcriptional regulator SlyA dimmer by applying the score matrix of amino acid residues shown in claim 1 etc. are claim 6 etc. The prediction and explanation of a result after substitution of SlyA amino acid residue of Salmonella transcriptional regulator SlyA dimmer/DNA complex by applying the score matrix of amino acid residues shown in claim 1 etc. are claim 6 etc. The prediction and explanation are valid, and as a result, the present invention can be used with novelty, inventiveness and industrial usefulness for the event in which the structural stability of the protein is involved. Claim 6 etc. can be used in converting the interaction among proteins into industrially useful interaction and to change the efficiency of an enzyme reaction to be useful in industry.

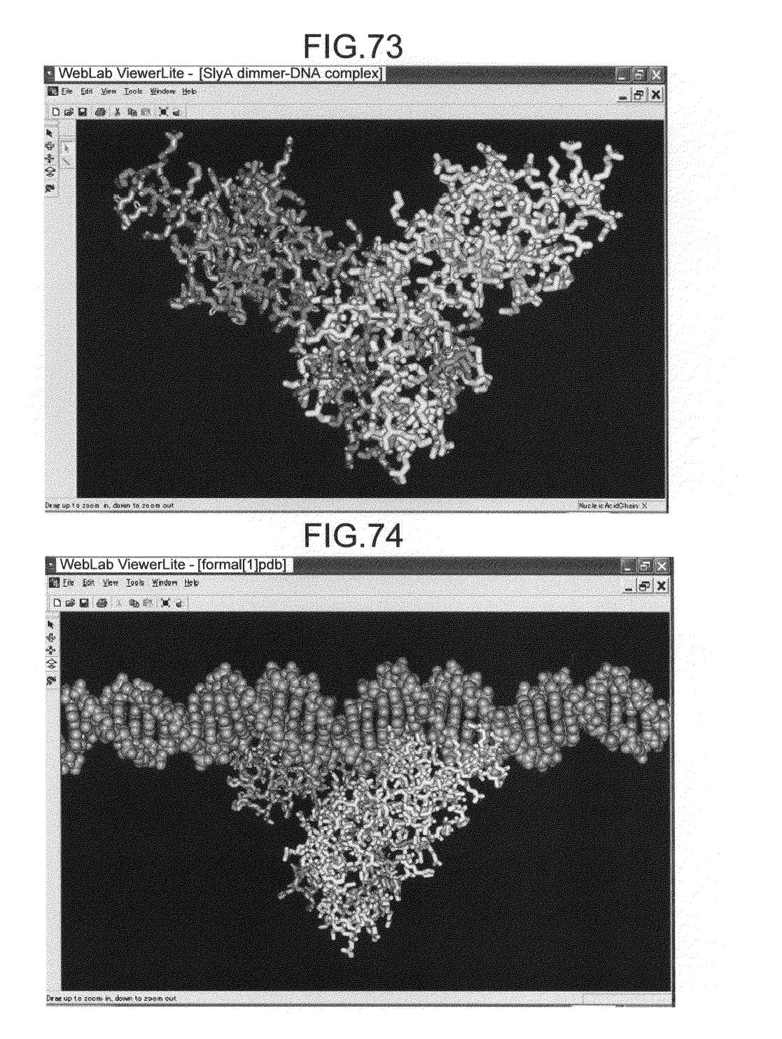

FIG. 73 shows a representation view of claim 6 etc. FIG. 73 is a view showing protein-protein interaction of a transcriptional regulator SlyA dimer. The proteins of the SlyA dimer are shown by a white stick model and a gray ball-and-stick model. These proteins are called molecules A and B respectively.

Examples of claim 6 etc. are shown below.

Table 1 below is a table in which an increase or decrease (plus, stability increase; minus, instability increase) in a score matrix of amino acid residue in claim 1 etc., is compared to a change (minus, instability indicator; plus, stability indicator) in experimental values by substitution of amino acid residues in a protein within the 6-angstrom from a border between protein molecules A and B for Alanine residue for claim 3 etc.

In L1/A A, L1 indicates a Leucine 1 residue based on numbering from the N-terminal amino acid residue of the protein, /A indicates protein molecule A, and the latter A indicates that a Leucine residue in molecule A is substituted for an Alanine residue.

The second column shows an increase or decrease (plus, stability increase; minus, instability increase) in the score matrix of amino acid residue in claim 1; the third column shows the proportion (plus, good conservativeness of the residue in a specified number from the N-terminal residue; minus, poor conservativeness) at which the residue is conserved in a protein similar in sequence to SlyA; and the fourth column shows a change in an experimental value by substitution of amino acid residue of the protein for Alanine residue (minus is indicative of a decrease in transcriptional activity as biological activity; plus is indicative of an increase in the biological activity; ---- is indicative of lacking for experimental data).

For example, in the example of

### L126/A A −0.358 2 −84,

when L126 in the protein molecule A is replaced by A (Alanine residue), the score matrix of amino acid residue in claim 1 etc. shows instability increases in the protein; the third column shows that a protein similar in sequence can naturally exist; and the fourth column shows a decrease in transcriptional activity as biological activity. The score matrix of amino acid residue in claim 1 etc. explains experimental values.

In the example of

### I114/A A +0.100 1 16,

the score matrix of amino acid residue in claim 1 etc. shows stability increases in the protein; the third column shows that a protein similar in sequence can naturally exist; and the fourth column shows an increase in transcriptional activity as biological activity. The score matrix of amino acid residue in claim 1 etc. explains experimental values.

Similar examples are also shown in:

### L129/A A −0.183 0 −3,

### I130/A A −0.019 −4 −4,

### L133/A A −0.194 −3 −5,

### L9/B A −0.134 −3 −24,

### L126/B A −0.325 2 −84, and

### L129/B A −0.126 0 −3.

On the other hand, there are some examples wherein although the transcriptional activity is increased, the score matrix of amino acid residue in claim 1 etc. shows instability increases in the protein. The score matrix of amino acid residue in claim 1 etc. does not explain experimental values. It is highly possible that this case relates to phenomena such as structural change in the protein.

Examples are also shown in:

### L9/A A +0.048 −3 −24,

### L19/A A +0.838 1 −12,

### I114/B A −0.060 1 16,

### I130/B A +0.029 −4 −4, and

### L133/B A +0.003 −3−5.

In the 8 examples described above, the score matrix of amino acid residue in claim 1 etc. explains experimental values. In 5 examples, however, the score matrix of amino acid residue in claim 1 etc. does not explain experimental values. This is to predict transcriptional activity as biological activity with 62% accuracy when the amino acid residues are substituted for A (Alanine residue). When it is considered that there has been no method of showing experimental guidelines by such an easy method, one step is forwarded, and it is also industrially worth utilizing the method. The examples where the fourth column is ---- are those giving experimental guidelines. The substitution explained this time is limited to substitution for A (Alanine residue), which however can naturally serve as an experimental guideline for substitution for other amino acid residues.

[Table 1]

Table in which an increase or decrease (plus, stability increase; minus, instability increase) in the score of a specific amino acid residue calculated by Eq. (5) in claim 4 etc., is compared to a change (minus, instability indicator; plus, stability indicator) in experimental values by substitution of amino acid residues in the protein within the 6-angstrom from a border between protein molecules A and B for Alanine residue for claim 6 etc.

TABLE 1

| | | | CHANGE IN |
|---|---|---|---|
| SUBSTITUTION | | | EXPERIMENTAL |
| OF AMINO | INCREASE | RATIO OF | VALUE BY |
| ACID IN | OR | WHICH | SUBSTITUTION |
| A OR B CHAIN | DECREASE | AMINO ACID | OF AMINO ACID |
| FOR ALANINE | IN SCORE | RESIDUE ARE | FOR ALANINE |
| RESIDUE | MATRIX | CONSERVED | RESIDUE |
| L1/A A | 0.000 | −3 | — |
| E2/A A | 0.078 | −3 | — |
| P4/A A | 0.964 | 0 | — |
| L5/A A | −0.209 | −2 | — |
| G6/A A | 0.438 | 2 | — |
| S7/A A | 0.184 | 0 | — |
| D8/A A | 1.457 | −1 | — |
| L9/A A | 0.048 | −3 | −24 |
| R11/A A | −0.518 | −1 | — |
| V13/A A | 0.488 | 4 | — |
| R14/A A | 0.091 | −3 | — |
| I15/A A | 0.823 | −1 | — |
| W16/A A | −0.212 | −4 | — |
| R17/A A | −0.019 | −3 | — |
| L19/A A | 0.838 | 1 | −12 |
| D21/A A | −0.63 | −3 | — |
| Q31/A A | −0.588 | −1 | — |
| W34/A A | −0.224 | 2 | — |
| V35/A A | 0.471 | 0 | — |
| H38/A A | 0.065 | 0 | — |
| N39/A A | 0.569 | 0 | — |
| Q42/A A | −0.793 | −3 | — |
| E104/A A | −0.581 | −1 | — |
| I107/A A | 0.034 | 2 | — |
| H108/A A | −0.196 | 1 | — |
| T110/A A | 0.845 | −1 | — |
| R111/A A | 2.445 | −2 | — |
| G112/A A | 1.4 | 3 | — |
| E113/A A | −1.164 | 0 | — |
| I114/A A | 0.1 | 1 | 16 |
| L115/A A | −0.224 | −4 | — |
| G117/A A | −0.581 | −1 | — |
| I118/A A | −0.651 | −3 | — |
| S119/A A | −2.084 | 0 | — |
| S120/A A | 0.114 | 1 | — |
| E121/A A | −0.558 | 2 | — |
| E122/A A | 0.834 | −2 | — |
| I123/A A | 0.148 | −2 | — |
| E124/A A | −0.875 | 1 | — |
| L125/A A | −0.138 | 2 | — |
| L126/A A | −0.358 | 2 | −84 |
| I127/A A | 0.007 | 0 | — |
| K128/A A | −0.662 | −1 | — |
| L129/A A | −0.183 | 0 | −3 |
| I130/A A | −0.019 | −4 | −4 |
| K132/A A | −0.823 | 1 | — |
| L133/A A | −0.194 | −3 | −5 |
| E134/A A | 0.197 | 1 | — |
| H135/A A | 0.218 | 2 | — |
| N136/A A | −0.112 | 1 | — |
| I137/A A | −0.046 | 1 | — |
| M138/A A | 0.192 | 1 | — |
| L1/B A | −0.465 | −3 | — |
| E2/B A | −1.153 | −3 | — |
| S3/B A | 0.314 | 0 | — |
| P4/B A | 0.934 | 0 | — |
| L5/B A | −0.315 | −2 | — |
| G6/B A | 1.537 | 2 | — |
| S7/B A | 0.207 | 0 | — |
| D8/B A | 1.016 | −1 | — |
| L9/B A | −0.134 | −3 | — |
| R11/B A | −0.856 | −1 | — |
| V13/B A | 0.38 | 4 | — |
| R14/B A | −0.891 | −3 | — |
| I15/B A | 0.583 | −1 | — |
| W16/B A | −0.312 | −4 | — |
| R17/B A | −1.029 | −3 | — |
| V35/B A | 0.517 | 0 | — |
| H108/B A | −0.142 | 1 | — |
| R111/B A | −0.163 | −2 | — |
| G112/B A | 1.435 | 3 | — |
| E113/B A | −0.944 | 0 | — |
| I114/B A | −0.06 | 1 | 16 |
| L115/B A | −0.099 | −4 | — |
| G117/B A | 1.689 | −1 | — |
| I118/B A | −0.651 | −3 | — |
| S119/B A | −2.005 | 0 | — |
| S120/B A | 0.029 | 1 | — |
| E121/B A | −0.34 | 2 | — |
| E122/B A | 1.481 | −2 | — |
| I123/B A | −0.013 | −2 | — |
| E124/B A | −0.791 | 1 | — |
| L125/B A | −0.282 | 2 | — |
| L126/B A | −0.325 | 2 | −84 |
| I127/B A | −0.173 | 0 | — |
| K128/B A | −0.706 | −1 | — |
| L129/B A | −0.126 | 0 | −3 |
| I130/B A | 0.029 | −4 | −4 |
| K132/B A | −0.825 | 1 | — |
| L133/B A | 0.003 | −3 | −5 |
| E134/B A | −0.463 | 1 | — |
| H135/B A | 0.739 | 2 | — |
| N136/B A | −0.523 | 1 | — |
| I137/B A | 0 | 1 | — |

FIG. 74 shows a representation view for claim 6 etc. FIG. 74 is a view showing interaction structure between a protein-protein complex of the transcriptional regulator SlyA dimer and DNA as a large ligand for the transcriptional regulator SlyA dimer. The proteins in the SlyA dimer are shown by a white stick model and a gray ball-and-stick model. The DNA is illustrated by a gray CPK model.

Examples of claim 6 etc. are shown below. Table 2 below is a table in which an increase or decrease (plus, stability increase; minus, instability increase) in a score of a specific amino acid residue calculated from Eq. (5), is compared to a change (minus, instability indicator; plus, stability indicator) in experimental values by substitution of amino acid residues in the protein within the 6-angstrom from a border between the protein molecule (protein molecules A and B) and a DNA as a large ligand molecule for Alanine residue for claim 6.

As shown below, a Proline residue in the protein molecule A is regarded important for structural preservation, and by substitution of the amino acid residue for an Alanine residue, the score matrix of a specific amino acid residue calculated in Eq. (5) is plus to increase the stability, but the transcriptional activity seems to decrease.

### P61/A A +1.088 2 −43

By substituting a Serine residue in the protein molecule B below for an Alanine, the score matrix of amino acid residue in claim 1 is plus to increase the stability, but the transcriptional activity seems to decrease. This means that the structural change may be important.

### S62/B A +0.147 −1 −99

The following shows that when D68 in the protein molecule A is substituted for A (Alanine residue), the score matrix of the specific amino acid residue calculated from Eq. (5) shows to increase instability in the protein, the third column shows that a protein similar in sequence does not naturally exist, and the fourth column shows a decrease in transcriptional activity as biological activity. The score matrix of a specific amino acid residue calculated from Eq. (5) explains experimental values.

### D68/A A −0.364 −3 −51

The following shows that when Q69 in the protein molecule B is substituted for A (Alanine residue), the score matrix of amino acid residue shows to increase instability in the protein, the third column shows that a protein similar in sequence does not naturally exist, and the fourth column shows a decrease in transcriptional activity as biological activity. The score matrix of a specific amino acid residue in claim 1 explains experimental values.

### Q69/B A −0.568 −3 −7

The following shows that when R85 in the protein molecule B is substituted for A (Alanine residue), the score matrix of amino acid residue shows to increase instability in the protein, the third column shows that a protein similar in sequence does not naturally exist, and the fourth column shows a decrease in transcriptional activity as biological activity. The score matrix of a specific amino acid residue in claim 1 explains experimental values.

### R85/B A −0.405 −3 −13

The following shows that when R85 in the protein molecule A is substituted for A (Alanine residue), the score matrix of amino acid residue shows to increase instability in the protein, the third column shows that a protein similar in sequence does not naturally exist, and the fourth column shows a decrease in transcriptional activity as biological activity. The score matrix of a specific amino acid residue in claim 1 etc. explains experimental values.

### R85/A A −0.463 −3 −13

In the forgoing description, the score matrix of amino acid residue cannot explain experimental values in the former 2 examples but can explain those in the latter 4 examples. The score matrix of amino acid residue in claim 1 etc. can explain experimental values by 67%. This means that when a amino acid residue is substituted for A (Alanine residues), the biological activity as transcriptional activity is predicted with 67% accuracy. When it is considered that there has been no method of showing experimental guidelines by such an easy method as yet, one step is forwarded, and it is also industrially worth utilizing the method. The examples where the fourth column is ---- are those giving experimental guidelines. Here explained to be limited to substitution of one amino acid residue for A (Alanine residue), which however can naturally serve as an experimental guideline for substitution of that for other amino acid residues.

Table 2: Table in which an increase or decrease (plus, stability increase; minus, instability increase) in the score matrix of amino acid residue in claim 4 etc., is compared to a change (minus, instability indicator; plus, stability indicator) in experimental values by substitution of amino acid residues in the protein within the 6-angstrom from a border between the protein molecule (protein molecules A and B) and a DNA as a large ligand molecule for Alanine residue for claim 7 etc.

TABLE 2

| | | | CHANGE IN |
|---|---|---|---|
| SUBSTITUTION | | RATIO | EXPERIMENTAL |
| OF AMINO | INCREASE | OF WHICH | VALUE BY |
| ACID IN A | OR | AMINO ACID | SUBSTITUTION |
| OR B CHAIN | DECREASE | RESIDUE | OF AMINO |
| FOR ALANINE | IN SCORE | ARE | ACID FOR |
| RESIDUE | MATRIX | CONSERVED | ALANINE RESIDUE |
| L12/A A | −0.04 | 1 | — |
| V13/A A | 0.488 | 4 | — |
| R14/A A | 0.091 | −3 | — |
| I15/A A | 0.823 | −1 | — |
| W16/A A | −0.212 | −4 | — |
| R17/A A | −0.019 | −3 | — |
| A18/A A | 80.838 | 3 | — |
| L19/A A | 0.838 | 1 | — |
| I20/A A | 0.038 | 2 | — |
| D21/B A | −0.509 | −3 | — |
| K25/B A | −1.009 | 3 | — |
| L29/B A | −0.557 | −3 | — |
| T30/B A | −2.188 | −1 | — |
| Q31/B A | −0.04 | −1 | — |
| T32/B A | 0.046 | 5 | — |
| H33/B A | 0.105 | −1 | — |
| I58/B A | −0.239 | −3 | — |
| E59/B A | −1.211 | −3 | — |
| Q60/A A | −0.645 | 1 | — |
| P61/B A | 1.276 | 2 | −43 |
| P61/A A | 1.088 | 2 | −43 |
| S62/B A | 0.147 | −1 | −99 |
| D68/A A | −0.364 | −3 | −51 |
| Q69/B A | −0.568 | −3 | −7 |
| R78/A A | −1.716 | −3 | — |
| C81/B A | −0.789 | −3 | — |
| C81/A A | −1.012 | −3 | — |
| S83/B A | −0.491 | 1 | — |
| D84/A A | −1.201 | −4 | — |
| D84/B A | −1.208 | −4 | — |
| R85/B A | −0.405 | −3 | −13 |
| R85/A A | −0.463 | −3 | −13 |
| R89/A A | −1.952 | −1 | −7 |
| I90/A A | −1.016 | −3 | — |

### Example 3

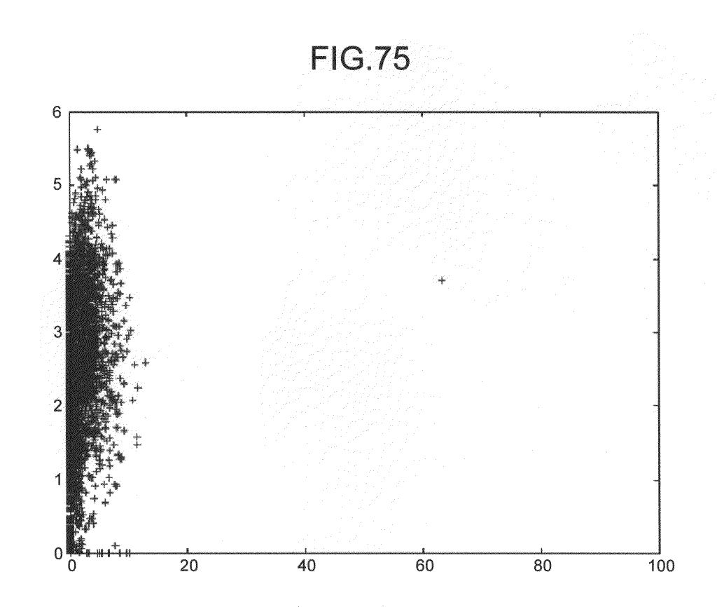

Examples for claim 7 etc. are shown below. A profile showing the tendency to mutate into another amino acid residue for an experimental structure of a protein whose PDB ID is 1MB4 was prepared in the method described in claim 1 etc. Using this profile, profiles similar to those calculated from previously calculated 4621 3-dimensional structures of protein were searched by a profile-profile alignment method. The results are shown in FIG. 75. Points shown in red indicate alignments obtained by the profile-profile alignment method. Homology (%) of amino acid residues in the resulting alignments is shown on the horizontal axis in the graph, and scores obtained by the profile-profile alignment method are shown on the vertical axis.

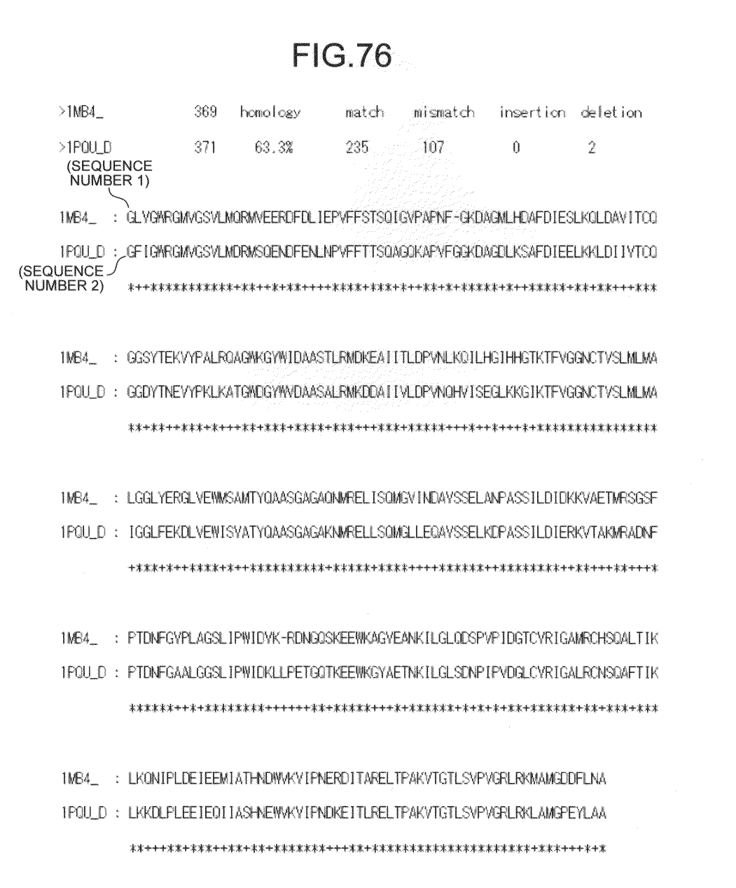

Information on alignments plotted in the vicinity of 60% homology (sequence numbers: 1 and 2) is shown in FIG. 76. Proteins similar to not only amino acid sequences but also structural property could be searched using the profile information in this manner. Further accurate searching can be effected by searching using the profile considering the tendency of genetic mutation in amino acid residues formed from amino acid sequences.

### Example 4

Hereinafter, an example in claim 8 is shown. Using a molecular dynamics calculation (MD) program, an experimentally analyzed 3-dimensional structure of protein (PDB) was gradually physically destroyed to generate 50 structures which were then subjected to energy minimization calculation. Using these data in one system, this MD calculation was conducted for 2859 PDB with 50% or less homology in amino acid sequence at a resolution of 2.0 Angstrom or less, which are not single-chain proteins or membrane proteins, to prepare 142950 3-dimensional structures of proteins. This data set was subjected to the metropolis Monte Carlo method to optimize the coefficient of each amino acid residue described in Eq. 8 in claim 8. The maximum value of each coefficient was set at 2.0 and the minimum value at 0.0. The objective function in the metropolis Monte Carlo method is a correlation coefficient between GDT_TS score and 3D1D score in individual systems.

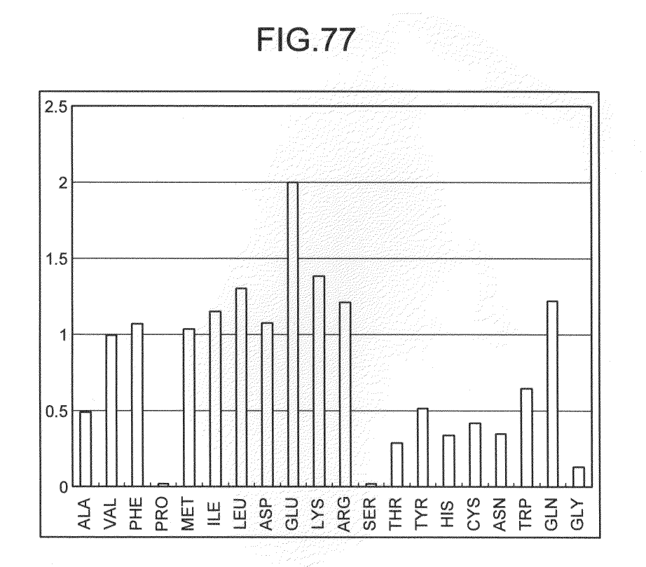

This optimization was carried out 10 times, and as a result, the average coefficient for each amino acid was obtained. The optimized coefficient is as shown in FIG. 77. The coefficients for PRO, SER, and GLY amino acid residues are small. This means that even if the environment around these amino acids tends to be more strongly present than the environment in PDB database, but do not exert a significant influence on 3-dimensional structure of protein. Particularly, PRO forms a ring consisting of its side chain and main chain and is different in properties from other amino acid residues. GLY is characterized by being composed of only a main-chain structure. This amino acid residue has such significantly different properties from other amino acid residues, and thus their coefficient may be lowered.

Using the coefficient optimized in correlation coefficient in FIG. 77, targets released in the contest of 3-dimensional structure prediction of protein CASP7 (Critical Assessment of Techniques for Protein Structure Prediction, http://predictioncenter.org/casp7/) were used for verifying. All structures submitted by the server team in CASP7 were optimized for arrangement of side-chain with homology modeling software FAMS. For the structures, the summations of GDT_TS scores of 3-dimensional structures of protein by the following two methods are calculated:

(1) those having the highest scores in Equations. in claim 8 etc. where the coefficient of each amino acid is set to 1.0.
(2) those having the highest scores in Equations. in claim 8 etc. where the coefficient of each amino acid residue is set to the value in FIG. 75 above. As a result, the result in (1) was 5018.67, and the result in (2) was 5080.7, and the accuracy of structural evaluation was improved. That is, it is meant that by optimizing the coefficient for each amino acid residue, the accuracy of structural prediction can be further improved.

### Other Embodiments

Although the inventions have been described with respect to embodiments for a complete and clear disclosure, but are to be construed as embodying all modifications and alternative constructions that may occur to one skilled in the art which fairly fall within the basic teaching herein set forth.

For example, the apparatus for processing 3-dimensional structure of protein 100 can be configured to perform processes in response to request from a client terminal, which is a separate unit, and return the processing results to the client terminal.

The automatic processes explained in the present embodiment can be, entirely or partially, carried out manually. Similarly, the manual processes explained in the present embodiment can be, entirely or partially, carried out automatically by a known method.

The process procedures, the control procedures, specific names, information including registration data for each process and various parameters such as search conditions and so on, display example, and composition of database, mentioned in the above description and drawings can be changed as required unless otherwise specified.

The constituent elements of the apparatus for processing 3-dimensional structure of protein 100 in the drawings are merely conceptual functionally and may be not necessarily physically to be constituted of the elements shown in the illustrations.

For example, the processing functions performed by each department or each device of the apparatus for processing protein 3-dimensional structure 100, especially the each processing function performed by the control unit 102, can be entirely or partially realized by CPU (Central Processing Unit) and a computer program executed by the CPU or by a hardware using wired logic. The computer program, recorded on a recording medium to be described later, can be mechanically read by the apparatus for processing 3-dimensional structure of protein 100 in case of necessity.

In other words, the storage unit 106 such as read-only memory (ROM) or hard disk (HD) stores the computer program that can work in coordination with OS (Operating System) to issue commands to the CPU and cause the CPU to perform various processes. The computer program, which forms a control unit 102, is first loaded to the random access memory (RAM) and executed in collaboration with the CPU. Alternatively, the computer program can be stored in any application program server connected to the apparatus for processing 3-dimensional structure of protein 100 via the network 300, and can be fully or partially downloaded in case of necessity.

The computer-readable recording medium on which the computer program can be stored may be “portable physical medium” such as flexible disk, magneto optic (MO) disk, ROM, erasable programmable ROM (EPROM), electrically erasable programmable ROM (EEPROM), compact disk-read-only memory (CD-ROM), digital versatile disk (DVD), “fixed physical medium” such as ROM, RAM, and HD that are had within the computer system, or “communication medium” for storing the program in a short term such as communication channels or carrier waves that transmit the computer program through the network 300 such as local area network (LAN), wide area network (WAN), and the Internet.

“Computer program” refers to a data processing method written in arbitrary computer language and descriptive method, and it is no matter whatever format is the program, that is, source codes, binary codes, and so on. The “computer program” can be not only a single program but also a dispersed form as a plurality of modules or libraries, or can perform the various functions in collaboration with a different program such as the OS. Any known configuration in the each device according to the embodiment can be used for reading the recording medium. Similarly, any known process procedure for reading or installing the computer program can be used.

The various files stored in the storage unit 106 (such as the file of 3-dimensional structure information of protein 106a, the file of environmental change information 106b, and the file of standard deviation information 106c) is storage means in a memory device such as RAM, ROM, and a fixed disk device such as HD, flexible disk, and optical disk, and stores therein various processes, various programs, tables, files, or databases, which are used to offered to Web sites, or files for Web pages.

The apparatus for processing 3-dimensional structure of protein 100 can also be operated by executing software (that includes computer program, data, etc.) that implements the method according to the present invention in information processing devices including information processing terminals such as known personal computer, workstation, etc., which are connected with peripheral devices such as printer, monitor, or image scanner.[0165]

The embodiment of distribution and integration of the apparatus for processing 3-dimensional structure of protein 100 are not limited to those illustrated in the figures. The device as a whole or in parts can be functionally or physically distributed or integrated in an arbitrary unit according to various loads. For examples, each database can consist of independent device of database, and part of processing can be executed using CGI (Common Gateway Interface).

The network 300 has function of mutually connecting the apparatus for processing 3-dimensional structure of protein 100 with the external device 200, and may at least include internet, intranet, LAN (wired/wireless), VAN, personal computer communication network, public telephone network (analog/digital), private circuit network (analog/digital), cable TV network, mobile phone switching network/mobile packet-switching data network by IMT2000, GSM, PDC/PDC-P, or the like, radio paging network, local wireless network such as, PHS network, satellite communication network such as CS, BS, and ISDB, and the like. The system can transmit and receive various data through arbitrary network without regard to wired or wireless.

### INDUSTRIAL APPLICABILITY

As described above, the apparatus for processing 3-dimensional structure of protein, the method of processing 3-dimensional structure of protein and the program according to the present invention can extensively be used in various fields in industry, particularly in the fields of pharmaceutical, medical and life science industries and are extremely useful.

1. An apparatus for processing 3-dimensional structure of protein, comprising a control unit and a storage unit, which calculates a score matrix that is physical quantity indicating whether amino acid residues in a 3-dimensional structure of protein are energetically stable in a specific environment, wherein
the storage unit stores 3-dimensional structure information of protein that defines 3-dimensional structure coordinates of a protein composed of a plurality of the amino acid residues, and
the control unit includes:
a mutated 3-dimensional structure-predicting unit that predicts 3-dimensional structure information of protein after an arbitrary amino acid residue A in the 3-dimensional structure information of protein stored in the storage unit is mutated into another amino acid residue a,
an environmental change information-collecting unit that from the 3-dimensional structure information of protein after a mutation predicted by the mutated 3-dimensional structure-predicting unit, collects the amino acid residue A, the amino acid residue a, environment information P, and environment information p, which are related to each other, as information on environmental change, when the environment information P around the amino acid residue A before the mutation changes to the environment information p around the amino acid residue a after the mutation, thereby storing environmental change information in the storage unit,
a standard deviation-calculating unit that while assuming that a plurality of pieces of the environment information p after the mutation relative to the environment information P in the environmental change information collected by the environmental change information-collecting unit follow normal distribution, calculates standard deviation σ(P) for the environment information P and relates the environment information P to the standard deviation v(P) to store the environment information and the standard deviation σ(P) in the storage unit, and
a score matrix-calculating unit that when a number (N(i|j)) of amino acid residues i present in a specific environment information j are obtained as calculation of the score matrix, corrects the N(i|j) to calculate the score matrix using a weighting parameter considering standard deviation v(J) for environment information J after the mutation corresponding to the environment information j stored by the standard deviation-calculating unit, and considering the standard deviation and an absolute value in difference between the environment information other than the environment information j and the environment information j.

2. The apparatus for processing 3-dimensional structure of protein according to claim 1, wherein
the environment information is defined by the fraction of area occupied by polar atoms (fraction polar) that is the ratio of polar atoms occupying the surface of the amino acid residues, the fraction of buried area of the surface of the amino acid residues (fraction buried), and secondary structure information.

3. The apparatus for processing 3-dimensional structure of protein according to claim 2,
wherein the score matrix-calculating unit uses the following equation as the weighting parameter:
$$\begin{matrix}[ Eq . 1 ] & \\ w ( polar , buried , p , b ) = exp ( \frac{- {p}^{2}}{2 \times {σ}_{polar}^{2}} ) \times exp ( \frac{- {b}^{2}}{2 \times {σ}_{buried}^{2}} ) & \end{matrix}$$
wherein w(polar, buried, p, b) is the weighting parameter wherein the fraction of area occupied by polar atoms (fraction polar) is shifted by p and the fraction of buried area (fraction buried) is shifted by b in the environment information defined by 3 parameters consisting of fraction polar (polar), fraction buried (buried), and secondary structure information (ss); p is the absolute value in difference between the fraction polar before and after the mutation; b is the absolute value in difference between the fraction buried before and after the mutation; (polar is the standard deviation in the fraction polar obtained from information on the amino acid residues after the mutation; and σ_{buried} is the standard deviation in the fraction buried obtained from information the amino acid residues after the mutation.

4. The apparatus for processing 3-dimensional structure of protein according to claim 3, wherein
the score matrix-calculating unit calculates, as the score matrix, SCORE(AA|ss, polar, buried) by using the following equation:
$$\begin{matrix}[ Eq . 2 ] & \\ \begin{matrix}P ( AA \vert ss , polar , buried ) = \frac{{\sum }_{m , n} w ( polar , buried , m , n ) N ( AA \vert ss , polar + m , buried + n )}{{\sum }_{aa} {\sum }_{m , n} w ( polar , buried , m , n ) N ( aa \vert ss , polar + m , buried + n )} \\ SCORE ( AA \vert ss , polar , buried ) = log ( \frac{P ( AA \vert ss , polar , buried )}{P ( AA )} )\end{matrix} & \end{matrix}$$
wherein P(AA|ss, polar, buried) is the ratio of amino acid residue AA present in the environment information consisting of the secondary structure information (ss), the fraction of area occupied by polar atoms (fraction polar), and the fraction of buried area (fraction buried).

5. The apparatus for processing 3-dimensional structure of protein according to claim 1, further including:
an accuracy-evaluating unit that calculates the score matrix for each of amino acid residues, and thereof obtains the summation, thereby evaluating the accuracy of the 3-dimensional structure information of protein.

6. The apparatus for processing 3-dimensional structure of protein according to claim 1, wherein
the 3-dimensional structure information of protein includes 3-dimensional structure information on a complex of ligand and a protein with which the ligand interacts or a complex of ligand and a protein into which the ligand has been inserted with a docking program, and
amino acid residues around the ligand are changed thereby calculating the score matrix, to search for the state of mutation in amino acid residue where the highest score matrix is calculated.

7. The apparatus for processing 3-dimensional structure of protein according to claim 1, wherein
the environmental change information on the amino acid residues is used, and the score matrix is used, to search for 3-dimensional structures of protein similar to one another in folding state by dynamic programming (DP).

8. The apparatus for processing 3-dimensional structure of protein according to claim 1, wherein
the score matrix-calculating unit calculates, 3D1Dscoreij shown in the following equation using, as correction term k(i), the strength of influence of the amino acid residue i on folding structure of protein as the score matrix:
$$\begin{matrix}[ Eq . 3 ] & \\ 3 D 1 D score ij = k ( i ) \cdot ln ( \frac{P ( i \vert j )}{Pi} ) \\ P ( i \vert j ) = \frac{N ( i \vert j )}{{\sum }_{a = 1}^{20} N ( a \vert j )} \\ Pi = \frac{N ( i )}{{\sum }_{a = 1}^{20} N ( a )} & \end{matrix}$$
wherein P(i|j) is the frequency of appearance of the amino acid residue i in the environment information j; Pi is the ratio of the amino acid residue i present regardless of the environment; N(i|j) is the number of the amino acid residue i observed in the environment information j; and N(i) is the number of the amino acid residue i observed.

9. The apparatus for processing 3-dimensional structure of protein according to claim 1, wherein
the numerical values calculated by the score matrix for amino acid residues around a specific amino acid residue of a protein is summed up to evaluate the modification of functions of the protein and the degree of contribution of the specific amino acid residue to functions of the protein.

10. A method of processing a 3-dimensional structure of protein executed by an apparatus for processing 3-dimensional structure of protein including:
a control unit and a storage unit, which calculates a score matrix that is physical quantity indicating whether amino acid residues in a 3-dimensional structure of protein are energetically stable in a specific environment, wherein
the storage unit includes:
3-dimensional structure information of protein that defines 3-dimensional structure coordinates of a protein composed of a plurality of the amino acid residues, and
the method comprises:
a mutated 3-dimensional structure-predicting step of predicting 3-dimensional structure information of protein after an arbitrary amino acid residue A in the 3-dimensional structure information of protein stored in the storage unit is mutated into another amino acid residue a;
an environmental change information-collecting step of collecting the amino acid residue A, the amino acid residue a, environment information P, and environment information p, which are related to each other, as information on environmental change, when the environment information P around the amino acid residue A before a mutation changes to the environment information p around the amino acid residue a after the mutation, thereby storing environmental change information in the storage unit from the 3-dimensional structure information of protein after the mutation predicted at the mutated 3-dimensional structure-predicting step;
a standard deviation-calculating step of calculating standard deviation σ(P) for the environment information P and relates the environment information P to the standard deviation σ(P) to store the environment information and the standard deviation σ(P) in the storage unit while assuming that a plurality of pieces of the environment information p after the mutation relative to the environment information P in the environmental change information collected at the environmental change information-collecting step follow normal distribution; and
a score matrix-calculating step of correcting the N(i|j) to calculate the score matrix using a weighting parameter considering standard deviation σ(J) for environment information J after the mutation corresponding to environment information j stored at the standard deviation-calculating step, and considering the standard deviation and an absolute value in difference between the environment information other than the environment information j and the environment information j when the number (N(i|j)) of amino acid residues i present in the specific environment information j are obtained as calculation of the score matrix,
wherein the steps are executed by the control unit.

11. The method of processing a 3-dimensional structure of protein according to claim 10, wherein
the environment information is defined by the fraction of area occupied by polar atoms (fraction polar) that is the ratio of polar atoms occupying the surface of the amino acid residues, the fraction of buried area of the surface of the amino acid residues (fraction buried), and secondary structure information.

12. The method of processing a 3-dimensional structure of protein according to claim 11,
wherein the score matrix-calculating step uses the following equation as the weighting parameter:
$$\begin{matrix}[ Eq . 4 ] & \\ w ( polar , buried , p , b ) = exp ( \frac{- {p}^{2}}{2 \times {σ}_{polar}^{2}} ) \times exp ( \frac{- {b}^{2}}{2 \times {σ}_{buried}^{2}} ) & \end{matrix}$$
wherein w(polar, buried, p, b) is the weighting parameter wherein the fraction of area occupied by polar atoms (fraction polar) is shifted by p and the fraction of buried area (fraction buried) is shifted by b in the environment information defined by 3 parameters consisting of fraction polar (polar), fraction buried (buried), and secondary structure information (ss); p is the absolute value in difference between the fraction polar before and after the mutation; b is the absolute value in difference between the fraction buried before and after the mutation; σₚₒₗₐᵣ is the standard deviation in the fraction polar obtained from information on the amino acid residues after the mutation; and σ_{buried} is the standard deviation in the fraction buried obtained from information the amino acid residues after the mutation.

13. The method of processing a 3-dimensional structure of protein according to claim 12, wherein
the score matrix-calculating step includes calculating, as the score matrix, SCORE(AA|ss, polar, buried) by using the following equation:
$$\begin{matrix}[ Eq . 5 ] & \\ \begin{matrix}P ( AA \vert ss , polar , buried ) = \frac{{\sum }_{m , n} w ( polar , buried , m , n ) N ( AA \vert ss , polar + m , buried + n )}{{\sum }_{aa} {\sum }_{m , n} w ( polar , buried , m , n ) N ( aa \vert ss , polar + m , buried + n )} \\ SCORE ( AA \vert ss , polar , buried ) = log ( \frac{P ( AA \vert ss , polar , buried )}{P ( AA )} )\end{matrix} & \end{matrix}$$
wherein P(AA|ss, polar, buried) is the ratio of amino acid residue AA present in the environment information consisting of the secondary structure information (ss), the fraction of area occupied by polar atoms (fraction polar), and the fraction of buried area (fraction buried).

14. The method of processing a 3-dimensional structure of protein according to claim 10, further comprising:
an accuracy-evaluating step of calculating the score matrix for each of amino acid residues, and thereof obtains the summation, thereby evaluating the accuracy of the 3-dimensional structure information of protein.

15. The method of processing a 3-dimensional structure of protein according to claim 10, wherein
the 3-dimensional structure information of protein includes 3-dimensional structure information on a complex of ligand and a protein with which the ligand interacts or a complex of ligand and a protein into which the ligand has been inserted with a docking program, and
amino acid residues around the ligand are changed thereby calculating the score matrix, to search for the state of mutation in amino acid residue where the highest score matrix is calculated.

16. The method of processing a 3-dimensional structure of protein according to claim 10, wherein
the environmental change information on the amino acid residues is used, and the score matrix is used, to search for 3-dimensional structures of protein similar to one another in folding state by dynamic programming (DP).

17. The method of processing a 3-dimensional structure of protein according to claim 10, wherein
3D1Dscoreij shown in the following equation using, as correction term k(i), the strength of influence of the amino acid residue i on folding structure of protein is calculated as the score matrix at the score matrix-calculating step:
$$\begin{matrix}[ Eq . 6 ] & \\ 3 D 1 D score ij = k ( i ) \cdot ln ( \frac{P ( i \vert j )}{Pi} ) \\ P ( i \vert j ) = \frac{N ( i \vert j )}{{\sum }_{a = 1}^{20} N ( a \vert j )} \\ Pi = \frac{N ( i )}{{\sum }_{a = 1}^{20} N ( a )} & \end{matrix}$$
wherein P(i|j) is the frequency of appearance of the amino acid residue i in the environment information j; Pi is the ratio of the amino acid residue i present regardless of the environment; N(i|j) is the number of the amino acid residue i observed in the environment information j; and N(i) is the number of the amino acid residue i observed.

18. The method of processing a 3-dimensional structure of protein according to claim 10, wherein
the numerical values calculated by the score matrix for amino acid residues around a specific amino acid residue of a protein is summed up to evaluate the modification of functions of the protein and the degree of contribution of the specific amino acid residue to functions of the protein.

19. A computer program product having a computer readable medium including programmed instructions for executing an method of processing 3-dimensional structure of protein by a computer including:
a control unit and a storage unit, which calculates a score matrix that is physical quantity indicating whether amino acid residues in a 3-dimensional structure of protein are energetically stable in a specific environment, wherein
the storage unit includes:
3-dimensional structure information of protein that defines 3-dimensional structure coordinates of a protein composed of a plurality of the amino acid residues, and
the instructions, when executed by the control unit, cause the computer to perform:
a mutated 3-dimensional structure-predicting step of predicting 3-dimensional structure information of protein after an arbitrary amino acid residue A in the 3-dimensional structure information of protein stored in the storage unit is mutated into another amino acid residue a;
an environmental change information-collecting step of collecting the amino acid residue A, the amino acid residue a, environment information P, and environment information p, which are related to each other, as information on environmental change, when the environment information P around the amino acid residue A before a mutation changes to the environment information p around the amino acid residue a after the mutation, thereby storing environmental change information in the storage unit from the 3-dimensional structure information of protein after the mutation predicted at the mutated 3-dimensional structure-predicting step;
a standard deviation-calculating step of calculating standard deviation σ(P) for the environment information P and relates the environment information P to the standard deviation σ(P) to store the environment information and the standard deviation σ(P) in the storage unit while assuming that a plurality of pieces of the environment information p after the mutation relative to the environment information P in the environmental change information collected at the environmental change information-collecting step follow normal distribution; and
a score matrix-calculating step of correcting the N(i|j) to calculate the score matrix using a weighting parameter considering standard deviation σ(J) for environment information J after the mutation corresponding to environment information j stored at the standard deviation-calculating step, and considering the standard deviation and an absolute value in difference between the environment information other than the environment information j and the environment information j when the number (N(i|j)) of amino acid residues i present in the specific environment information j are obtained as calculation of the score matrix,
wherein the steps are executed by the control unit.

20. The computer program product according to claim 19, wherein
the environment information is defined by the fraction of area occupied by polar atoms (fraction polar) that is the ratio of polar atoms occupying the surface of the amino acid residues, the fraction of buried area of the surface of the amino acid residues (fraction buried), and secondary structure information.

21. The computer program product according to claim 20,
wherein the score matrix-calculating step uses the following equation as the weighting parameter:
$$\begin{matrix}[ Eq . 7 ] & \\ w ( polar , buried , p , b ) = exp ( \frac{- {p}^{2}}{2 \times {σ}_{polar}^{2}} ) \times exp ( \frac{- {b}^{2}}{2 \times {σ}_{buried}^{2}} ) & \end{matrix}$$
wherein w(polar, buried, p, b) is the weighting parameter wherein the fraction of area occupied by polar atoms (fraction polar) is shifted by p and the fraction of buried area (fraction buried) is shifted by b in the environment information defined by 3 parameters consisting of fraction polar (polar), fraction buried (buried), and secondary structure information (ss); p is the absolute value in difference between the fraction polar before and after the mutation; b is the absolute value in difference between the fraction buried before and after the mutation; σₚₒₗₐᵣ is the standard deviation in the fraction polar obtained from information on the amino acid residues after the mutation; and σ_{buried} is the standard deviation in the fraction buried obtained from information the amino acid residues after the mutation.

22. The computer program product according to claim 21, wherein
the score matrix-calculating step includes calculating, as the score matrix, SCORE(AA|ss, polar, buried) by using the following equation:
$$\begin{matrix}[ Eq . 8 ] & \\ \begin{matrix}P ( AA \vert ss , polar , buried ) = \frac{{\sum }_{m , n} w ( polar , buried , m , n ) N ( AA \vert ss , polar + m , buried + n )}{{\sum }_{aa} {\sum }_{m , n} w ( polar , buried , m , n ) N ( aa \vert ss , polar + m , buried + n )} \\ SCORE ( AA \vert ss , polar , buried ) = log ( \frac{P ( AA \vert ss , polar , buried )}{P ( AA )} )\end{matrix} & \end{matrix}$$
wherein P(AA|ss, polar, buried) is the ratio of amino acid residue AA present in the environment information consisting of the secondary structure information (ss), the fraction of area occupied by polar atoms (fraction polar), and the fraction of buried area (fraction buried).

23. The computer program product according to claim 19, further including:
an accuracy-evaluating step of calculating the score matrix for each of amino acid residues, and thereof obtains the summation, thereby evaluating the accuracy of the 3-dimensional structure information of protein.

24. The computer program product according to claim 19, wherein
the 3-dimensional structure information of protein includes 3-dimensional structure information on a complex of ligand and a protein with which the ligand interacts or a complex of ligand and a protein into which the ligand has been inserted with a docking program, and
amino acid residues around the ligand are changed thereby calculating the score matrix, to search for the state of mutation in amino acid residue where the highest score matrix is calculated.

25. The computer program product according to claim 19, wherein
the environmental change information on the amino acid residues is used, and the score matrix is used, to search for 3-dimensional structures of protein similar to one another in folding state by dynamic programming (DP).

26. The computer program product according to claim 19, wherein
3D1Dscore ij shown in the following equation using, as correction term k(i), the strength of influence of the amino acid residue i on folding structure of protein is calculated as the score matrix at the score matrix-calculating step:
$$\begin{matrix}[ Eq . 9 ] & \\ 3 D 1 D score ij = k ( i ) \cdot ln ( \frac{P ( i \vert j )}{Pi} ) \\ P ( i \vert j ) = \frac{N ( i \vert j )}{{\sum }_{a = 1}^{20} N ( a \vert j )} \\ Pi = \frac{N ( i )}{{\sum }_{a = 1}^{20} N ( a )} & \end{matrix}$$
wherein P(i|j) is the frequency of appearance of the amino acid residue i in the environment information j; Pi is the ratio of the amino acid residue i present regardless of the environment; N(i|j) is the number of the amino acid residue observed in the environment information j; and N(i) is the number of the amino acid residue i observed.

27. The computer program product according to claim 19, wherein
the numerical values calculated by the score matrix for amino acid residues around a specific amino acid residue of a protein is summed up to evaluate the modification of functions of the protein and the degree of contribution of the specific amino acid residue to functions of the protein.
